(19) United States
(12) Patent Application Publication
(10) Pub. No.: US 2019/0225521 A1
(43) Pub. Date: Jul. 25, 2019

(54) SYSTEMS, APPARATUS, AND/OR METHODS FOR PROVIDING LIQUID TREATMENT COMPRISING AT LEAST ONE OF DISINFECTION, FILTRATION AND/OR PURIFICATION

(71) Applicant: Stephan Heath, Littleton, CO (US)

(72) Inventor: Stephan Heath, Littleton, CO (US)

(21) Appl. No.: 16/256,863

(22) Filed: Jan. 24, 2019

Related U.S. Application Data
(60) Provisional application No. 62/621,540, filed on Jan. 24, 2018.

(51) Int. Cl. C02F 9/00

(52) U.S. Cl. CPC C02F 9/00; C02F 1/487

(57) ABSTRACT

Systems, apparatus, and methods for liquid treatment are provided including one or more of disinfection, filtration, and/or purification of the liquid using at least one electromagnetic field (EMF) including two or more specific and/or varying frequencies and pulses, the ENIFs optionally applied to the fluid using one or more of alternating current electricity, counter rotating magnetic fields, and/or oscillating electrical fields of alternating polarity, in order to provide treated liquids for different uses, such as, but not limited to water treatment for drinking or other purposes. Such systems, apparatus, and/or methods for treatment of a liquid optionally include providing systems, apparatus, and methods that are configured for treating water with one or more electromagnetic fields (EMFs) of two or more specific frequencies and pulses, to provide EMF treated liquid.

### FIELD

The present subject matter relates to one or more of systems, apparatuses, and/or methods for liquid treatment including one or more of disinfection, filtration, and/or purification of the liquid using electromagnetic fields (EMFs), in order to provide treated liquids for different uses, such as, but not limited to, water treatment for drinking or other purposes.

### BACKGROUND

The presence of pharmaceutical compounds in our waterways and drinking water has gained national attention among lawmakers, regulators, and the priblic. Prescription dings can enter water through manufacturing waste, human or animal excretion, runoff from animal feeding operations, leaching from municipal landfills, or improper disposal. Recent governmental studies found numerous water uses, instances of pharmaceutical compounds or other by-products found in drinking water. Pharmaceuticals in drinking water sources have raised significant concerns for their persistent input including antibiotics, anti-convulsants, mood stabilizers and sex hormones have been found in the drinking water supply of at least 41 million Americans, an Associated Press investigation shows. The presence of so many prescription drugs and over-the-counter medicines in our drinking water is heightening concerns among scientists regarding their long-term consequences and potential human health risks.

Bottled water has become a bit of a trend—specific brands with unique shapes that tell the world a little something about you. While your bottle of water might make you appear to be a purveyor of optimal hydration, it is also a red flag that you may be exposing your body to an onslaught of chemicals. In a study by German researchers, nearly 25,000 chemicals were found lurking in a single bottle of water. Many of these chemicals mimic the effects of potent pharmaceuticals inside your body, which can cause cancerous tumors, birth defects, cardiovascular disorders, metabolic disorders, and as mentioned earlier, other developmental disorders. Therefore, there is a need for providing new systems, apparatus, and methods of liquid or water disinfection, filtration and/or purification systems that includes removing pharmaceutical ingredients, compounds. chemicals, synthetic compounds, toxins, pollutants and other undesirable impurities or contaminations in drinking water, bottled water, alcoholic beverages, non-alcoholic beverages or other beverages and one or more types of treated liquid or water for drinking or other purposes.

### SUMMARY

Alternative optional embodiments of the present subject matter relate to systems, apparatus, and/or methods for liquid treatment including one or more of disinfection, filtratioh and/or purification of the liquid using at least one electromagnetic field (EMF) having two or more specific and/or varying frequencies and pulses, the EMFs optionally applied to the fluid using one or more of alternating current electricity, counter rotating magnetic fields, and/or oscillating electrical fields of alternating polarity, in order to provide treated liquids for different uses, such as, but not limited to water treatment for drinking or other purposes. Such systems, apparatus, and/or methods for treatment of a liquid optionally include providing systems, apparatus, and methods that are configured for treating water with one or more electromagnetic fields (EMFs) of two or more specific frequencies and pulses, to provide EMF treated liquid.

The two or more frequencies optionally are selected from 1, 2, 3. 4, 5, 6, 7. 8. 9, 10, 11, 12, 13, 14, or any range or value therein or between, optionally including two or more frequencies such as, but not limited to, 20, 63, 70, 72.99, 100, 101, 112, 120, 144, 146, 147, 153, 164, 174, 205, 234, 258, 282, 285, 289, 317, 330, 327, 330, 333, 327, 358, 369, 378, 396, 413, 417, 453, 465, 471, 512. 522, 526, 528, 539, 542, 548, 556, 582, 612, 618, 623, 624, 632, 634, 635, 639, 642, 662, 693, 726, 728, 741, 773, 774, 776, 787, 798, 799, 800, 802, 804, 822, 825, 826, 827, 832, 835, 847, 852, 852.44, 855, 856, 867, 934, 936, 951, 957, 963, 974.15, 991, 1000, 1130, 1054, 1055, 1074, 1185, 1242, 1244, 1260, 1296, 1317, 1320, 1333, 1372, 1428, 1522, 1529, 1530, 1550, 1552, 1584, 1604, 1630, 1703, 1712, 1722, 1730, 1741, 1746, 1823, 1833, 1852, 1867, 1902, 1993, 2664, 3330, 3142, 3152, 3996, 4152, 5412, 7847, 7849, 9990, 9999, or other frequency and pulses, or one or more harmonics thereof, applying a counter rotating magnetic (CRM) field or an oscillating electrical (OE) field to the EMF treated liquid to provide an EMF and CRMF/OEF treated liquid; collecting the EMF and CRMF/OEF treated liquid or water, wherein the treating step removes or inactivates one or more of a pharmaceutical active or inactive ingredient or compound, a toxic or contaminant compound, chemical, or molecule, a pollutant, a waterborne contaminant, Aluminum, Ammonia, Arsenic, Barium, Cadmium, Chloramine, Chromium, Copper, Dioxins, Fluoride, Chlorine, PCBs, HCP, Dacthal, MTBE, Dichlorodiphenyltrichloroethane (DDT), Perfluorinated Compound (PFC), bacteria & Viruses, Lead, Nitrates/Nitrites, Mercury, Perchlorate, Radium, Selenium, Silver, Uranium, an impurity, a bacteria, parasites, a pathogen, a virus, microbes, E coli, organic material, a fluoride containing compound, chlorine or by-products, carbon monoxide, arsenic, aluminum, disinfectant by-product (DBPs), a prescription drug, an over the counter drug (OTC), a non-prescription drug, antibiotic, a pain reliever, a pain medication, a heart drug, a mind drug, a sex drug, antidepressant, contraceptive, other pharmaceutical or drug, a veterinary drug, animal by-product, animal feces, human waste, a lead compound, a heavy metal, metal ion contamination, a toxic metal, a personal care product chemical, other medication, caffeine, a nicotine chemical, a radioactive compound, a cancer-causing, compound composition, or by-product, a hormone, disinfectant by-product (DBPs), a fertilizer, pesticide, feed additive, or herbicide component, by-product, or decomposition product, a metal salt, or a liquid or water contaminant or other pollutant: and providing the collected EMF and CRMF/OEF treated liquid that is acceptable for end use of the a generator or system of generators of high frequency currents using copper or metal rings, electrodes or frequency generators that produces at least one of EMF CRMF/OEF treated water containing liquid.

Providing ENV and CRMF/OEF treated liquid optionally provides one or more of liquid or water disinfection, filtration, and purification systems, that can optionally include removing one or more undesirable contaminants, chemicals, pharmaceuticals, toxins, pollutants, impurities, pharmaceuticals or metabolites, and/or other undesirable impurities or contaminations in drinking or purified or treated or processed liquid or water using varying electromagnetic fields of specific varying field (EMF) frequencies alternating current electricity, counter rotating magnetic fields, and/or oscillating; electrical fields, for providing drinking or treated liquid or water for drinking or other purposes.

The method, system, or apparatus optionally includes wherein liquid treatment comprises:

(a) treating the liquid with one or more electromagnetic fields (EMFs) to provide EMF treated liquid, wherein the one or more EMFs comprise two or more EMF frequencies selected from, but not limited to, 20, 63, 70, 72, 99, 101, 142 Hz 144, 146, 147, 153, 164, 174, 205, 234, 258, 282, 285, 289, 317, 330, 327, 330, 333, 327, 358, 369, 378, 396, 413, 417, 453, 465, 471, 512, 522, 526, 528, 539, 542, 548, 556, 582, 612, 618, 623, 624, 632, 634, 635, 639, 642, 662, 693, 726, 728, 741, 773, 774, 776, 787, 798, 799, 800, 802, 804, 822, 825, 826, 827, 832, 835, 847, 852, 852.44, 855, 856, 867, 934, 936, 951, 957, 963, 974.15, 991, 1000, 1130, 1054, 1055, 1074, 1185, 1242, 1244, 1260, 1296, 1317, 1320, 1333, 1372, 1428, 1522, 1529, 1530, 1550, 1552, 1584, 1604, 1630, 1703, 1712, 1722, 1730, 1741, 1746, 1823, 1833, 1852, 1867, 1902, 1993, 2664, 3330, 3142, 3152, 3996, 4152, 5412, 7847, 7849, 9990, 9999, or other frequency and pulses, or one or more harmonics thereof:

(b) applying a counter rotating magnetic field (CRMF) or an oscillating electrical field (OEF) to h EMF treated liquid to provide EMF and CRMF/OFF treated liquid;

collecting the EMF and CRMF/OEF treated liquid;

wherein the treating step (a) and/or the applying step (b) removes or inactivates one or more impurities, contaminants, chemicals, pharmaceuticals, toxins, pathogens, pollutants, carcinogens, heavy metals, or radioactive materials.

Optionally the method includes wherein the one or more impurities, contaminants, chemicals, pharmaceuticals, toxins, pathogens, pollutants, carcinogens, heavy metals, or radioactive materials is/are selected from the group of a pharmaceutical undesirable impurities or contaminations active or inactive ingredient or compound, a toxic or contaminant compound, chemical, or molecule, a pollutant, a waterborne contaminant, Aluminum, Ammonia, Arsenic, Barium, Cadmium, Chloramine, Chromium, Copper, Dioxins, Fluoride, Chlorine, PCBs, HCB, Dacthal, MTBE, Dichlorodiphenyltrichloroethane (DDT), Perfluorinated Compound (PFC), bacteria & Viruses, Lead, Nitrates/Nitrites, Mercury, Perchlorate, Radium, Selenium, Silver, Uranium, an impurity, a bacteria, parasites, a pathogen, a virus, microbes, E coli, organic material, a fluoride containing compound, chlorine or by-products, carbon monoxide, arsenic, aluminum, disinfectant by-product (DBPs), a prescription drug, an over the counter drug (OTC), a non-prescription drug, antibiotic, a pain reliever, a pain medication, a heart drug, a mind drug, a sex drug. antidepressant, contraceptive, other pharmaceutical or drug, a vetetinaty drug, animal by-product, animal feces, human waste, a heavy metal, metal ion contamination, a toxic metal, a personal care product chemical, other medication, caffeine, a nicotine chemical, a radioactive compound, a cancer-causing compound composition, or by-product, a hormone, disinfectant by-product (DBPs), a fertilizer, pesticide, feed additive, or herbicide component, by-product, or decomposition product, a metal salt, or a water contaminant or other pollutant.

Optionally the method includes further treating the liquid, the EMF liquid or the EMF and CRMF/OEF treated liquid with one or more of activated carbon filtration, ozonation, granular media treatment, microfiltration, ultrafiltration, ultraviolet exposure, nanofiltration, reverse osmosis, and desalination.

Optionally the method includes wherein the treating step (a) and/or the applying step (b) comprises the use of a generator or system of generators of high frequency currents using copper or metal rings, electrodes or frequency generators to generate the two or more EMF frequencies andlor the counter rotating magnetic field (CRMF) or the oscillating electrical field (OEF).

Optionally the method includes wherein the copper or metal rings, electrodes or frequency generators are provided as two or more copper or metal rings, electrodes or frequency generators with substantially the same radius, wherein the two copper or metal rings, electrodes or frequency generators intersect with each other such that the center of each disk is adjacent to a perimeter portion of the other copper or metal rings, electrodes or frequency generators.

Optionally the method includes wherein the copper or metal rings, electrodes or frequency generators vibrate at said at least two electromagnetic frequencies corresponding to the length, or a fraction or multiple of the length, of at least a portion of the copper or metal rings, electrodes or frequency generators.

Optionally the method includes wherein a primary coil of the copper or metal rings, electrodes or frequency generators creates at least one of the counter rotating magnetic field (CRMF) and oscillating electrical field (OEF) alternating in polarity, that vibrate at said two or more ENE frequencies that are resonant with a secondaiy frequency at which a secondary coil of the copper or metal rings, electrodes or frequency generators vibrate that balances the force of gravity within a magnetic field produced by the copper or metal rings, electrodes or frequency generators.

Optionally the method includes wherein the liquid comprises water; and wherein the method provides:

one or more of contaminant removal and impurity removal; and

one or more of disinfection, filtration, and purification.

Optionally the method includes wherein the EMF and CRMF/OEF treated liquid substantially comprises at least two of disinfected, filtered and treated water; and wherein the liquid for treatment is selected from: water for drinking water uses, water for water supply uses, sewage or human waste, water for wastewater uses, water for recycling uses, water for groundwater uses, water for lead compound contaminated water or wastewater uses, water for pharmaceutical manufacturing wastewater uses, water for purified. water uses, water for medical treatment wastewater uses, water for industrial manufacturing and processing wastewater uses, water for marine wastewater uses, water for commercial manufacturing and processing wastewater uses, water for agricultural irrigation and processing uses, water for ionization uses, water for drinking water, bottled water or other beverage uses, water for pharmaceutical uses, water for medical uses, water for municipal water supply uses, water for manufacturing or processing of consumer packaging uses, water for food processing uses, water for packaged beverages uses, water for growing livestock uses, water for mining wastewater uses, water for electric power generation wastewater uses, cooling systems water uses, water for thermoelectric power generation and system uses, water for recreational uses, water for oil and gas inining and processing wastewater uses, water for ballast uses, water for desalination uses, water for aquaculture uses, water for plant growth or water for other water uses.

Optionally the method includes further treating the liquid, the EMF treated liquid, and/or the EMF and CRMF/OEF treated liquid, with ultraviolet (UV) light to provide UV, EMF and CRMF/OEF treated water.

One or more embodiments of the present subject matter can optionally include providing one or more purification systems electromagnetic fields of specific varying field (EMF) frequencies alternating current electricity, counter rotating magnetic fields, and/or oscillating electrical fields, for providing drinking or treated liquid or water for drinking or other purposes of specific varying field (EMF) frequencies alternating current electricity, counter rotating magnetic fields, and/or oscillating electrical fields, for providing drinking or treated liquid or water for drinking or other purposes varying field (EMF) frequencies undesirable impurities or contaminations types of an EMF and CRMF/OEF treated liquid or water for a liquid or water comprising liquid more acceptable for an end use, such as optionally for one, two, three, four, five, six, seven, eight, nine, ten, or more of:

(i) for domestic liquid or water uses, sewage wastewater uses, recycled liquid or water uses, groundwater uses, lead compound wastewater removal, medical and pharmacological liquid or water uses, pruified liquid or water uses, industrial liquid or water uses, marine wastewater uses, commercial liquid or water uses, manufacturing liquid or water uses, agricultural liquid or water uses, demineralization system, liquid or water ionizer uses, consumer packaged goods liquid or water uses, food processing liquid or water uses, packaged beverages and drinking liquid or water uses, livestock liquid or water uses, farm animal liquid or water uses, mining wastewater uses, public supply liquid or water and sanitation liquid or water uses, thermoelectric power liquid or water uses, recreational liquid or water uses, irrigation liquid or water uses, municipal tap liquid or water uses, environmental liquid or water uses, oil wastewater and gas wastewater for refining petroleum liquid or water uses, ballast wastewater liquid or water uses, reverse osmosis and/or desalination of salt liquid or water pretreatment uses for human consumption or irrigation liquid or water uses, wastewater plant liquid or water uses, pressurized liquid or water uses, aquaculture liquid or water uses, plant and animal liquid or water uses, stimulating plant liquid or water uses, or liquid or water pretreatment uses; and/or

(ii) for contaminant removal in liquid, drinking water, bottled water or other beverages, energizing liquid or water molecules, improving one or more liquid or water conditions, changing the molecular structure of drinking liquid or water, improving the color, taste and odor of drinking liquid or water;

(iii) for rinsing and washing during surgeries and wound cleaning, mixing treated liquid or water with IV solutions and pharmaceutical products;

(iv) for contaminant, chemical, pharmaceutical removal in liquid, drinking water or bottled water;

(v) for contaminant removal in milk, soft drinks, juice and wine, alcoholic or non-alcoholic beverages or other liquid or beverages;

(vi) for residential and commercial liquid or water uses, such as drinking, food preparation, bathing, washing clothes and dishes, flushing toilets, and watering lawns and gardens, preparing food, coffee and tea. bathing, washing clothes and dishes, brushing your teeth, watering the yard and garden, watering plants, making beer and washing the dog or cat,

(vii) for fabricating, processing, washing, diluting, cooling, or transporting a product, incorporating liquid or water into a product or for sanitation needs within the manufacturing facility or commodities such as food, paper, chemicals, synthetic compounds, refined refining petroleum, or primary metals;

(viii) for processing, cleaning, transportation, dilution, and cooling, of liquid or water in manufacturing facilities. Major liquid or water-using industries include steel, chemical, paper, and refining petroleum. Industries often reuse the same liquid or water over and over for more than one purpose;

(ix) for the extraction of naturally occurring minerals; solids, such as coal and ores; liquids, such as crude refining petroleum; and gases, such as natural gas, such as quarrying, milling (such as crushing, screening, washing, and floatation), and other operations as part of mining activity

(x) for commercial liquid or water uses and one or more types of treated liquid or water for drinking or other purposes that can optionally be used by merchants, retailers, recreational, golf courses, restaurants, hotels, schools, institutions, swimming pools, businesses and other commercial industry uses, such as fresh liquid or water for motels, hotels, restaurants, office buildings, other commercial facilities, and civilian and military institutions;

(xi) for fabricating, processing, washing, diluting, cooling, or transporting a product, chemical products, food, and paper products, food, paper and other chemical uses and one or more types of treated liquid or water for drinking or other purposes;

(xii) for agricultural liquid or water uses and one or more types of treated liquid or water for drinking or other purposes;

(xiii) for demineralization liquid or water uses and one or more types of treated liquid or water for drinking or other purposes:

(xiv) for consumer packaged goods liquid or water uses and one or more types of treated liquid or water for drinking or other purposes;

(xv) for food processing liquid or water uses and one or more types of treated liquid or water for drinking or other purposes:

(xvi) for packaged beverages and drinking iquid or water uses and one or more types of treated liquid or water for drinking or other purposes;

(xvii) for stock animals, feed lots, dairies, fish farms, and other non-farm needs. Water is needed for the production of red meat, poultry, eggs, milk, and wool, horses, rabbits, and pets. Livestock water use only includes fresh water;

(xviii) for the production of food vegetation and other agricultural liquid or water uses and one or more types of treated liquid or water for drinking or other purposes;

(xix) for one or more health benefits and purifying water for public supply water uses and one or more types of treated liquid or water for drinking or other purposes that can optionally include water that is withdrawn by public and private water suppliers, such as county and municipal water works, and delivered to users for domestic, commercial, and industrial purposes,

(xx) for thermoelectric power water uses, the production of electric power generated with heat, where the source of the heat may be from fossil fuels, nuclear fission, or geothermal, or a turbine using steam power,

(xxi) for recreational water uses and one or more types of treated liquid or water for drinking or other purposes;

(xxii) for water artificially applied to farm, orchard, pasture, and horticultural crops, as well as water used to irrigate pastures, for frost and freeze protection, chemical application, crop cooling, harvesting, and for the leaching of salts from the crop root zone;

(xxiii) for non-agricultural activities including self-supplied water to irrigate public and private golf courses, parks, nurseries, turf farms, cemeteries, and other landscape irrigation uses;

(xxiv) for oil and gas wastewater for refining petroleum liquid or water uses and one or more types of treated liquid or water for drinking or other purposes;

(xxv) for ballast wastewater liquid or water uses and one or more types of treated liquid or water for drinking or other purposes;

(xxvi) for reverse osmosis and/or desalination of salt water pretreatment liquid or water uses for human consumption or irrigation water uses or other water pretreatment uses or wastewater uses through using reverse osmosis water filtration method that can optionally include removing some amount of salt and other minerals from saline water that makes drinking water and one or more types of treated liquid or water for drinking or other purposes;

(xxvii) for wastewater plant liquid or water uses from large-scale industries such as refineries, petrochemical, chemical plants, manufacturing plants and natural gas processing plants commonly contain gross amounts of oil, emulsified fuels and suspended solids that will separate the oil and suspended solids from their wastewater effluents:

(xxviii) for pressurized liquid or water uses and one or more types of treated liquid or water for drinking or other purposes;

(xxix) for aquaculture liquid or water uses and one or more types of treated liquid or water for drinking or other purposes;

(xxx) for one or more health benefits and purifying liquid or water for the body's detoxification system for optimum health, and the one process that relies most heavily on an excess intake of clean water;

(xxxi) for digestion, temperature control, joint lubrication and skin hydration;

(xxxii) for “Wastewater” which is water that has been used in a manner or subject to a condition in which the water has acquired a load of contaminants and/or waste products that render the water incapable of at least certain desired practical uses without being subject to reclamation;

(xxxiii) for “Water reuse” which is a beneficial use of a treated wastewater;

(xxxiv) for “Wastewater reclamation” which is a treatment of a wastewater to a degree to which the water can be reused, yielding “reclaimed” water;

(xxxv) for “Direct reuse” which is a direct use of a reclaimed wastewater, such as for agricultural and landscape irrigation, use in industry, or use in a dual water system;

(xxxvi) for “Indirect reuse” which is the mixing, dilution, or dispersion of a reclaimed wastewater into a body of “receiving” water or into a groundwater supply prior to reuse;

(xxxvii) for “Potable water reuse” which is the use of a highly treated reclaimed water to provide or augment a supply of drinking water;

(xxxix) for “Direct potable reuse” which is the introduction of highly treated, high-quality reclaimed water directly into a drinking-water distribution system.

(xl) for “Indirect potable reuse” which is the mixing of reclaimed water with an existing water resource (e.g., surface resource or a groundwater resource) before the water from the resource is delivered to a drinking-water treatment system. The mixing can occur in a river, lake, or reservoir, or by injection into an aquifer, for example;

(xli) for “Seawater” (abbreviated “SW”) which is saline water from the sea or from any source of brackish water;

(xlii) for “Feed water” which is water, such as seawater, input to a treatment process such as a desalination process;

(xliii) for “Make-up water” which is pretreated and diluted seawater used to augment a desalination loop with salt lost due to diffusion from a concentrate to the seawater or from a concentrate to the treated wastewater during a forward-osmosis process, (xliv) for “Seawater pretreatment” which is a treatment of seawater destined for use as make-up water, wherein the pretreatment includes, but is not limited to, one or more of coagulation, filtration, ion-exchange, disinfection, and any other membrane process, in the stated order or any other order;

(xlv) for “Treated Wastewater” (abbreviated “Treated WW”) which is reclaimed wastewater that has been subjected to a secondary or tertiary wastewater-treatment process;

(xlvi) for “Concentrated Treated Wastewater” (abbreviated “Concentrated Treated WW”) which is a treated wastewater after water has been extracted from it, such as by an forward-osmosis process; thus, concentrated treated wastewater typically has a higher concentration of solutes and/or other non-water waste products than treated wastewater;

(xlvii) for “Impaired Water” which is any water that does not meet potable water quality standards

(xlviii) for “Concentrate” which is a byproduct of a water purification processes having a higher concentration of a solute or other material than the feed water, such as a brine by-product produced by a desalination process;

(xlix) for “Draw solution” which is a solution having a relatively high osmotic potential that can be used to extract water from a solution having a relatively low osmotic potential In certain ethbodiments, the draw solution may be formed by dissolving an osmotic agent in the draw solution;

(l) for “Receiving stream” which is a stream that receives water by a water purification or extinction process. For example, in forward-osmosis, the draw solution is a receiving stream that receives water from a feed stream of water having a lower osmotic potential than the receiving stream;

(li) for “Product Water” which is potable water produced by a system as described herein; and

(lii) for in addition, the terms “upstream” and “downstream” which are used herein to denote, as applicable, the position of a particular component, in a hydraulic sense, relative to another component. For example, a component located upstream of a second component is located so as to be contacted by a hydraulic stream (flowing in a conduit for example) before the second component is contacted by the hydraulic stream. Conversely, a component located downstream of a second component is located so as to be contacted by a hydraulic stream after the second component is contacted by the hydraulic stream.

The liquid or water disinfection, filtration and purification systems or processing method or apparatus can optionally include using an EM field alternating in polarity, either permanently or periodically, and magnetically charged copper or metal rings, electrodes or frequency generators in the shape of the vesica piscis, which creates a vortex of magnetic energy, that is the intersection of two or more copper or metal rings, electrodes or frequency generators with the same radius, intersecting in such a way that the center of each disk lies on the perimeter of the other. The positively charged end of the metal strand can optionally include the use of silver-soldered to the negatively charged end, bringing the copper wire to a neutral state, The copper ring creates a vortex of magnetic energy, a wavelength of invisible light that shines out both sides. The copper or metal rings, electrodes or frequency generators will vibrate at a high frequency based upon the length of a coiled copper wire. The copper or metal rings, electrodes or frequency generators are two pieces of twisted wires that are plated with precious metals. First, the copper is coated with a layer of silver and then a layer of 24 karat gold. This process is repeated with a layer of silver and a layer of 24 karat gold for a total of nine layers. The primary and secondary circuits are tuned so they resonate at the same resonant frequency. This allows them to exchange energy, so the oscillating current alternates back and forth between the primary and secondary copper ring. The primary coil of the copper or metal rings, electrodes or frequency generators shall create an electrical circuit that includes using electromagnetic fields of specific varying field (EMF) frequencies alternating current electricity in combination with ultraviolet (UV) light, one or more filtration systems and counter rotating magnetic field generator and oscillating electrical field alternating in polarity, either permanently or periodically, that will vibrate the energy field at a high frequency compatible with the resonant frequency at which the secondary copper ring wants to vibrate that will balance the force of gravity to a pointe of neutralization within the magnetic fields. The frequencies and pulses pass through the copper coils to charge the water or treated liquid externally. This charge changes the behavior of the water molecule or treated liquid and disrupts the hydrogen bonds shared between molecules causing the separation of pharmaceutical ingredients, compounds, chemicals, synthetic compounds, toxins, pollutants and other undesirable impurities or contaminations in drinking water, bottled water, alcoholic beverages, non-alcoholic beverages or other beverages and one or more types of treated liquid or water for drinking or other purposes.

The liquid or water disinfection, filtration and purification systems or methods can optionally include removing one or more pharmaceutical ingredients, compounds, chemicals, synthetic compounds, toxins, pollutants and other undesirable impurities or bacteria, contaminations, waterborne contaminant, bacteria, parasites, pathogens, inorganic compounds, organic material and macroscopic pollutants and other chemicals, synthetic compounds, fluoride compounds, chlorine or by-products, lead compound, carbon monoxide, arsenic, nitrates, personal care products, caffeine, a nicotine chemical, toxic metal salts, hormones, pesticides and other harmful contaminants in recycled liquid or water uses that will allow recycling and reusing of treated wastewater for beneficial purposes such as agricultural and landscape irrigation, industrial processes, toilet flushing, and replenishing a ground liquid or water basin.

One or more embodiments of the present subject matter can optionally include using EMFID biometric sensors for detection of one or more pharmaceutical ingredients, compounds, chemicals, synthetic compounds, toxins, pollutants and other undesirable impurities or bacteria, contaminations, waterborne contaminant, bacteria, parasites, pathogens, inorganic compounds, organic material and macroscopic pollutants and other chemicals, synthetic compounds, fluoride compounds, chlorine or by-products, lead compound, carbon monoxide, arsenic, nitrates, personal care products, caffeine, a nicotine chemical, toxic metal salts, hormones, pesticides and other harmful contaminants in drinking water, bottled water, alcoholic beverages, non-alcoholic beverages or other beverages and cells in the human body. This subject matter can optionally include using EMFID biometric sensors for detection of disease-causing resonances in diseased tissues generated by pathogens in diseased tissues can be detected when acidic pH levels in the body become too high.

A apparatus, method, or system hereof can optionally be provided for one or more liquid or water disinfection, filtration and purification systems, the method comprising treating the liquid or water with electromagnetic fields of specific varying field (EMF) frequencies in combination with ultraviolet (UV) light, one or more filtration systems and counter rotating magnetic field generator and oscillating electrical field alternating in polarity, either permanently or periodically, wherein the frequencies are selected from two or more frequencies such as, but not limited to, 20, 63, 70, 72, 99, 101, 142 Hz 144, 146, 147, 153, 164, 174, 205, 234, 258, 282, 285, 289, 317, 330, 327, 330, 333, 327, 358, 369, 378, 396, 413, 417, 453, 465, 471, 512, 522, 526, 528, 539, 542, 548, 556, 582, 612, 618, 623, 624, 632, 634, 635, 639, 642, 662, 693, 726, 728, 741, 773, 774, 776, 787, 798, 799, 800, 802, 804, 822, 825, 826, 827, 832, 835, 847, 852, 852.44, 855, 856, 867, 934, 936, 951, 957, 963, 974.15, 991, 1000, 1130, 1054, 1055, 1074, 1185, 1242, 1244, 1260, 1296, 1317, 1320, 1333, 1372, 1428, 1522, 1529, 1530, 1550, 1552, 1584, 1604, 1630, 1703, 17112, 1722, 1730, 1741, 1746, 1823, 1833, 1852, 1867, 1902, 1993, 2664, 3330, 3142, 3152, 3996, 4152, 5412, 7847, 7849, 9990, 9999, or other frequency and pulses, or one or more harmonics thereof.

The present subject matter can optionally further provide using electromagnetic frequency (EMF) frequencies for liquid or water treatment and/or identification or communication devices. EMF can include one or more of different aspects or combinations of frequencies and pulses, amplitudes, and/or wavelengths. Non-limiting examples can optionally include Radio waves; Infrared; Visible light, Ultraviolet; and X-rays, including, but not limited to: Radio waves: ELF to EHF: Extremely Low Frequency (ELF:3 Hz/100 Mm); Super Low Frequency (SULF: 30 Hz/10 Mm); Ultra LF (ULF: 300 Hz/1 Mm); Very Low Frequency (VLF: 3 kHz/100 km), Low Frequency (LF: 30 kHz/10 km); Medium Frequency (MF: 300 kHz/1 km); High Frequency (HF: 3 MHz/100 km); Very High Frequency (VHF: 30MHz/10m); Ultra High Frequency (UHF: 300MHz/1 m); (microwaves can include) Super High Frequency (SHF: 3 GHz/1 dm); Extremely High Frequency (EHF:30 GHz/1 cm); Terahertz radiation (100-10,000 GHz/3cm-1 mm); Infrared Radiation (IR): Far Infrared Radiation (300 GHz/1 mm); Mid IR (3 THz/100 microM); and Near IR: (30 Hz/10 microM); (Visible Light is 400-700 nm), between IF and UV; Ultraviolet light: Near UV (300 THz/l microM), Extreme UV (3 pHz/100 nm); Soft X-rays (30 pHz/10 nm) to (3EHz/100 pm), Low Frequency (LF); High Frequency (HF); and Ultra High Frequency (UHF).

The present subject matter can optionally further include where one or more of the EMF frequencies are generated using a metal or copper coil, such as, but not limited to, a copper, silver, stainless steel, gold, zinc, alloy, or the like, coil which is provided or configured to generate one or more of the recited enif frequencies and/or optimized for one or more aspects of the present subject matter, optionally including one or more of systems, apparatus, and methods for liquid treatment comprising one or more of disinfection, filtration, and/or purification of the liquid using electromagnetic fields (EMFs), in order to provide treated liquids for different uses, such as, but not limited to water treatment for drinking or other purposes, as described herein or as known in the art. Such coils can optionally include wherein the coils transmit, generate, adjust or otherwise provide one or more EMF frequencies as listed herein that provide suitable water or liquid treatment, optionally including one or more harmonics or subharmortics. The EMF frequencies optionally embodiments embodiments is generated, activated, and/or amplified by any known source of frequency from acoustic to light, with one or more of acoustic and/or laser light preferred, and transmits the one or more EMF frequencies, optionally as a transitional or other type of scalar wave which can be in the form of analog or digital wave forms, including where digital signals or waveforms can optionally be converted to analog signal, or waveforms.

The metal coil can be in any suitable shape or form, including rolled, twisted, spun, and the like, and preferably is optimized for water or liquid treatment as described herein and/or as known in the art. Such coils can be formed or include forms or shapes as cross sectional or other areas, such as round, oblong, oval, square, rectangular, flattened or hammered, or further treated. It is optionally preferred that the coils optionally have lengths and diameters that maximize the EMIT frequencies effects and/or results for treatments according to the present subject matter as described herein or as known in the att. Further research indicates that folding the initial twisted length and twisting again, (double twist) amplifies the effects further. Further, hammering this double twist yields another significant increase in effect. The effects of the optional use of scalar waves or fields produced by the tensor created by the various embodiments call be unexpected over those of alternative fields or waves generated by the resulting EMF frequencies as to water or liquid or treatment according to the present subject matter. This unexpected effects can include for both scalar and other waves or fields, one or more of a stronger, coherent field, frequency modulated in wavelengths and amplitudes which are compatible with, and supportive of, normalizing processes in living tissue. In optional embodiments, the lengths of employed can be significant. Multiples and sub-multiples, pi and phi ratios can optionally be employed to maintain the appropriate frequencies for physical compatibilities with living tissue and for maximizing the liquid treatment desired.

The present subject matter can optionally further include wherein a mobile or computing device, or wireless device, is optionally selected from the group of a smart phone, a tablet device, a cell phone, a mobile internet device, a netbook, a notebook, a personal digital assistant, an internet phone, a holographic device, a holographic phone, a cable internet device, a satellite internet device, an internet television, a DSL internet device, and a portable internet access device or computer.

The present subject matter can optionally further include wherein access is subject to identity verification.

### BRIEF DESCRIPTION OF THE DRAWINGS

The description herein makes reference to the accompanying drawings wherein like reference numerals refer to like parts throughout the several views, and wherein:

FIG. 1 is a schematic hydraulic diagram of a water-treatment system according to a first exemplary embodiment.

FIG. 2 is a schematic hydraulic diagram of a water-treatment system according to a second exemplary embodiment.

FIG. 3 is a side perspective view of a harmonizer assembly with an inner harmonizer having a sacred cubit measurement, and an outer harmonizer having a lost cubit measurement.

### DETAILED DESCRIPTION

The present subject matter relates to one or more of methods, apparatus, non-transitory computer readable storage medium, computer systems, networks, andlor systems to provide one or more liquid or water disinfection, filtration and purification systems for providing one or more liquid or water disinfection, filtration and purification systems that will make liquid or drinking liquid or water and one or more types of treated liquid or water for drinking or other purposes that can optionally include contaminant ⁻removal, energizing liquid or water molecules, improving one or more liquid or water conditions, changing the molecular structure of drinking water, improving the color, taste and odor of drinking water and providing a method of liquid or water disinfection, filtration and purification systems that can optionally include removing one or more pharmaceutical ingredients, compounds, chemicals, synthetic compounds, toxins, pollutants and other undesirable impurities or bacteria, contaminations, waterborne contaminant, bacteria, parasites, pathogens, inorganic compounds, organic material and macroscopic pollutants and other chemicals, synthetic compounds, fluoride compounds, chlorine or by-products, lead compound, carbon monoxide, arsenic, nitrates, personal care products, caffeine, a nicotine chemical, toxic metal salts, hormones, pesticides and other harmful contaminants in drinking water, bottled water, alcoholic beverages, non-alcoholic beverages or other beverages and one or more types of treated liquid or water for drinking or other purposes.

The present subject matter relates to methods, apparatus, non-transitory computer readable storage medium, computer systems, networks, and/or systems to provide one or more liquid or water disinfection, filtration and purification systems for providing one or more liquid or water disinfection, filtration and purification systems that will make liquid or drinking liquid or water and one or more types of treated liquid or water for drinking or other purposes that can optionally include removing bacteria, parasites, viruses, molds, pathogens, inorganic compounds, organic material and macroscopic pollutants, chemicals, synthetic compounds, toxins, pollutants and other undesirable impurities or contaminations via a liquid or water disinfection, filtration and purification systems using electromagnetic fields of specific varying field (EMF) frequencies alternating current electricity in combination with ultraviolet (UV) light, one or more filtration systems and counter rotating magnetic field generator and oscillating electrical field alternating in polarity, either permanently or periodically, within a liquid or water source to be purified that will make liquid or drinking water and one or more types of treated liquid or water for drinking or other purposes.

The present subject matter relates to methods, apparatus, non-transitory computer readable storage medium, computer systems, networks, and/or systems to provide one or more liquid or water disinfection, filtration and purification systems for providing one or more liquid or water disinfection, filtration and purification systems that will make liquid or drinking liquid or water and one or more types of treated liquid or water for drinking or other purposes that can optionally include providing one or more liquid or water disinfection, filtration and purification systems that can optionally include removing one or more pharmaceutical ingredients, compounds, chemicals, synthetic compounds, toxins, pollutants and other undesirable impurities or bacteria, contaminations, waterborne contaminant, bacteria, parasites, pathogens, inorganic compounds, organic material and macroscopic pollutants and other chemicals, synthetic compounds, fluoride compounds, chlorine or by-products, lead compound, carbon monoxide, arsenic, nitrates, personal care products, caffeine, a nicotine chemical, toxic metal salts, hormones, pesticides and other harmful contaminants in drinking water, bottled water, alcoholic beverages, non-alcoholic beverages or other beverages and one or more types of treated liquid or water for drinking or other purposes and other water uses that can optionally include domestic liquid or water uses, bottled liquid or water uses, municipal tap liquid or water uses, sewage wastewater uses, recycled liquid or water uses, groundwater uses, lead compound wastewater removal, medical and pharmacological water uses, industrial water uses, hydroelectricity water uses, marine wastewater uses, commercial liquid or water uses, manufacturing liquid or water uses, agricultural liquid or water uses, demineralization system, water ionizer uses, consumer packaged goods water uses, food processing liquid or water uses, packaged beverages and drinking liquid or water uses, livestock liquid or water uses, farm animal liquid or water uses, mining wastewater uses, public supply water and sanitation liquid or water uses, thermoelectric power water uses, recreational water uses, irrigation water uses, municipal tap water uses. environmental water uses, oil wastewater and gas wastewater for refining petroleum liquid or water uses, ballast wastewater liquid or water uses, reverse osmosis and/or desalination of salt water pretreatment uses for human consumption or irrigation water uses, wastewater plant water uses, pressurized liquid or water uses, aquaculture water uses, plant and animal liquid or water uses, stimulating plant liquid or water uses, or other water pretreatment uses or wastewater uses.

The present subject matter can optionally further include where one or more of the EMF frequencies are generated using a metal or copper coil, such as, but not limited to, a copper, silver, stainless steel, gold, zinc, alloy, or the like, coil which is provided or configured to generate one or more of the recited emf frequencies and/or optimized for one or more aspects of the present subject matter, optionally including one or more of systems, apparatus, and methods for liquid treatment including one or more of disinfection, filtration, and/or purification of the liquid using electromagnetic fields (EMFs), in order to provide treated liquids for different uses, such as, but not limited to water treatment for drinking or other purposes, as described herein or as known in the art. Such coils can optionally include wherein the coils transmit, generate, adjust or otherwise provide one or more EMF frequencies as listed herein that provide suitable water or liquid treatment, optionally including one or more harmonics or subharmonics. The EMF frequencies optionally embodiments is generated, activated, and/or amplified by any known source of frequency from acoustic to light, with one or more of acoustic and/or laser light preferred, and transmits the one or more EMF frequencies, optionally as a transitional or other type of scalar wave which can be in the form of analog or digital wave forms, including where digital signals or waveforms can optionally be converted to analog signal, or waveforms.

The metal coil can be in any suitable shape or form, including rolled, twisted, spun, and the like, and preferably is optimized for water or liquid treatment as described herein and/or as known in the art. Such coils can be formed or include forms or shapes as cross sectional or other areas, such as round, oblong, oval, square, rectangular, flattened or hammered, or further treated. It is optionally preferred that the coils optionally have lengths and diameters that maximize the EMF frequencies effects and/or results for treatments according to the present subject matter as described herein or as known in the ad. Further research indicates that folding the initial twisted length and twisting again, (double twist) amplifies the effects further. Further, hammering this double twist yields another significant increase in effect, The effects of the optional use of scalar waves or fields produced by the tensor created by the various embodiments can be unexpected over those of alternative fields or waves generated by the resulting EMF frequencies as to water or liquid or treatment according to the present subject matter. This unexpected effects can include for both scalar and other waves Cr fields, one or more of a stronger, coherent field, frequency modulated in wavelengths and amplitudes which are compatible with, and supportive of, normalizing processes in living tissue. In optional embodiments, the lengths of employed can be significant, Multiples and sub-multiples, pi and phi ratios can optionally be employed to maintain the appropriate frequencies for physical compatibilities with living tissue and for maximizing the liquid treatment desired.

The present subject matter can optionally further include wherein a mobile or computing device, or wireless device, is optionally selected front the group of a smart phone, a tablet device, a cell phone, a mobile interact device, a netbook, a notebook, a personal digital assistant, an interact phone, a holographic device, a holographic phone, a cable interact device, a satellite internet device, an interact television, a DSL internet device, and a portable interact access device or computer.

DEFINITIONS:

Absorption of Electromagnetic Radiation by Water depends on the state of the water. The absorption in the gas phase occurs in three regions of the spectrum. Rotational transitions are responsible for absorption in the microwave and far-infrared, vibrational transitions in the mid-infrared and near-infrared. Vibrational bands have rotational fine structure. Electronic transitions occur in the vacuum ultraviolet regions. Liquid water has no rotational spectrum but does absorb in the microwave region. Ice has a spectrum similar to liquid water. The water molecule, in the gaseous state, has three types of transition that can give rise to absorption of electromagnetic radiation:, Rotational transitions, in which the molecule gains a quantum of rotational energy. Atmospheric water vapor at ambient temperature and pressure gives rise to absorption in the far-infrared region of the spectrum, from about 200 cm⁻¹ (50 μm) to longer wavelengths towards the microwave region. Vibrational transitions, in which a molecule gains a quantum of vibrational energy. The fundamental transitions give rise to absorption in the mid-infrared in the regions around 1650 cm⁻¹ (μband, 6 μm) and 3500 cm⁻¹ (X-band, 2.9 μm). Electronic transitions, in which a molecule is promoted to an excited electronic state. The lowest energy transition of this type is in the vacuum ultraviolet region. In reality, vibrations of molecules in the gaseous state are accompanied by rotational transitions, giving rise to a vibration-rotation spectrum. Furthermore, vibrational overtones and combination bands occur in the near-infrared region. The HITRAN spectroscopy database lists more than 37,000 spectral lines for gaseous H₂¹⁶O, ranging from the microwave region to the visible spectrum. In liquid water the rotational transitions are effectively quenched, but absorption bands are affected by hydrogen bonding. In crystalline ice the vibrational spectrum is also affected by hydrogen bonding and there are lattice vibrations causing absorption in the far-infrared. Electronic transitions of gaseous molecules will show both vibrational and rotational fine structure.

Activated Carbon Filtration, Carbon has been used as an adsorbent for centuries. Early uses of carbon were reported for water filtration and for sugar solution purification systems. Activated carbons ability that can optionally include removing a large variety of compounds front contaminated waters has led to its increased use in the last thirty years. Recent changes in water discharge standards regarding toxic pollutants have placed additional emphasis on this technology. Adsorption is a natural process by which molecules of a dissolved compound collect on and adhere to the surface of an adsorbent solid, Adsorption occurs when the attractive forces at the carbon surface overcome the attractive forces of the liquid. Granular activated carbon is a particularly good adsorbent medium due to its high surface area to volume ratio. One gram of a typical commercial activated carbon will have a surface area equivalent to 1,000 square meters. This high surface area permits the accumulation of a large number of contaminant molecules. The specific capacity of a granular activated carbon to adsorb organic compounds is related to: molecular surface attraction, the total surface area available per unit weight of carbon, and the concentration of contaminants in the wastewater stream. The basic instrument for evaluating activated carbon use is the adsorption isotherm. The isotherm represents an empirical relationship between the amount of contaminant adsorbed per unit weight of carbon and its equilibrium water concentration.

Alternating in Polarity (AC) is the flow of electric charge periodically reverses direction. In direct current (DC, also de). the flow of electric charge is only in one direction. The abbreviations AC and DC are often used to mean simply alternating and direct, as when they modify current or voltage. AC is the form in which electric power is delivered to businesses and residences. The usual waveform of an AC power circuit is a sine wave. In certain applications, different waveforms are used, such as triangular or square waves. Audio and radio signals carried on electrical wires are also examples of alternating in polarity, either permanently or periodically. In these applications, an important goal is often the recovery of information encoded (or modulated) onto the AC signal.

A Partial List of Frequencies in Hz

One or more of the following frequencies call be used in one or more steps, methods, apparatus, device, and/or component of one or more optional embodiments of the present subject matter. Bacteria₁₃lactis_nosode—512, 526, 798, 951, 5412 Bacterial_capstiles HC—20786.10, 17923.34, 1034.88, 892.35 Bacterial_infections_general (if bacterial infection is chronic and the type is accurately diagnosed and neither frequencies nor antibiotics are effective long tem), also use Parasites general and roundworms sets. Also see General antiseptic and specific types.)—20, 465, 866, 664, 690, 727, 787, 832, 800, 880, 1550, 784 Bacterium_coli (a type of E. coli normally found in the intestines, water, milk, and soil that is the most frequent cause of urinary-tract infections and a common cause of wound infection)—642, 358, 539 Bacterium_coli_commune_combination—282, 333, 413, 957, 1320, 1722 Bacteroides_fragilis (use with Parasites ascaris set)—633, 634, 635, 636, 637 Bacteroides _fragilis HC—16180.80, 16230.58, 808.07, 805.59 Balantidium_coli_HC (cysts. B. coli is the largest ciliated protozoon found in humans and can cause a severe colitis with ulcerations)—22902.05, 1140.23 Candida (also see Parasite general, roundworm, and ascaris if these don't work long term. Some think that chronic candida cannot be cured unless toxic metal accumulation is reduced or eliminated by using a metals cleanse 464*)—3176, 2644, 1403, 1151, 943, 886, 877, 866, 762, 742, 661, 465, 464, 450, 414, 412, 386, 381, 254.2, 120, 95, 64, 20 Candida_1-10000, 5000, 3176, 2489, 1395, 1276, 1160, 1044, 928, 877, 812, 728, 696, 580, 465, 464, 381, 348, 232, 116, 58, 20 Candida _2 (includes candida carcinomas and tropicalis)—1403, 675, 709, 2167, 2128, 2182, 465, 20, 60, 95, 125, 225, 427, 464, 727 Candida_albicans_HC—19217.81, 956.80 Candida_carcinomas—2167, 2128, 2182, 465 Candida_secondary (also use other parasite sets esp roundworm freqs if necessary)—72, 422, 582, 727, 787, 802, 1016, 1134, 1153, 1550, 2222, 412, 543, 2128 Candida_sweep_TR (sweep from 12006.25 to 12137.5 by 03125 dwell 0.5 pulse 64 75) Candida_tertiary (some causal factors)—880, 95, 125, 20, 60, 225, 427, 240, 650, 688, 152, 442, 8146, 751, 1146 Candida_tropicalis—1403, 675, 709 E_coli (Escherichia coli; can cause infections in wounds and the urinary tract. If using these leads to common cold symptoms, follow with Adenovirus freqs, 800/802*, 1550/1552*)—7849, 7847, 1730, 1722, 1552, 1550, 1320, 1244, 1000, 957, 934, 856, 840, 832, 804, 802, 800, 799, 776, 642, 634, 556, 548, 413, 333, 330, 327, 289, 282 E_coli_1 (recommended for cancer adjunct)—7847, 1730, 1712, 1244, 1000, 934, 856, 840, 800, 776, 642, 634, 556, 539, 358, 330 E_coli_comp—7849, 7847, 1730, 1722, 1712, 1703. 1552, 1550, 1320, 1244, 1242, 1000, 957, 934. 856, 840, 832, 804, 802, 800, 799, 776, 642, 634, 632, 556, 548, 539, 413, 358, 333, 330, 327, 289, 282 E_coli_HC—17724.20, 19566.32, 974.15, 882.44 E_coli_mutant_strain—556, 934, 1242, 1244, 1703, 632, 634, 776 Erysipelas (bacterial infection manifesting in skin inflammation caused by strep pyrogens or other pathogens and possibly related to the swine form of the disease)—616, 776, 735, 845, 660, 10000, 880, 787, 727, 465, 20 Erytheina_infectiosum (human parvovirus B19, sometimes known as Fifth disease, a contagious viral infection which causes blotchy or raised red rash with mild illness, exp)—809, 1618, 3236 Erytheina_nosodum—9.39 Escherichia_coli. (use E. coli) Esophagus (constriction. Also see General antiseptic and dental freqs)—880, 787 727 Euglena—432, 3215, 3225, 3325, 6448 Fungus_and_mold_v—4442, 2411, 1833, 1823, 1333, 1155, 1130, 1016, 942, 933, 886. 880, 866. 784, 774, 766, 745, 743, 728, 623, 623, 594, 592, 565, 555, 524, 512, 464, 414, 374, 344, 337, 321, 254, 242, 222, 158, 132 Fungus_EW_range—823, 824, 825, 826, 827, 828, 829 Fungus_flora_1—331, 336, 555, 587, 632, 688, 757, 882, 884, 887 Fungus_foot_and_general_1(use 1550 for 30 min)—1550 Fungus_general (also see candida, yeast, and other specific types)—2222, 1552, 1550, 1153, 1134, 1016, 880, 802, 787, 784, 727, 582, 465, 422, 254, 72, 20 Hepatitis_A (add Hepatitis general freqs if necessary)—321, 346, 414, 423, 487, 558, 578, 693, 786, 878, 3220, 717 Hepatitis_B (add Hepatitis general freqs if necessary)—334, 433. 767, 869, 876, 477, 574, 752, 779 Hepatitis_B_HC (antigen)—20562.06, 1023.72 Hepatitis_C (also try Parasites, schistosoma mansoni and Hepatitis general freqs if necessary)—5000, 3220, 3176, 2489, 2189, 1865, 1600, 1550, 1500, 1371, 933, 931, 929, 880. 802, 665, 650, 633, 625, 528, 444, 329, 317, 250, 224, 166. 146, 125, 95, 72, 28, 20 Hepatitis_C_1—10000, 5000, 3220, 3176, 2489, 1865, 1600, 1550, 1500, 880, 802, 665, 650, 600, 444, 250, 166, 146, 125. 95. 72, 28, 20 Hepatitis_C_TR—728, 166, 224, 317, 727, 787, 880, 2189 Hepatitis_general—1550, 1351, 922, 880, 802, 727, 477, 329, 317, 224, 28 Hepatitis_general_secondary—284, 458, 477, 534, 788, 922, 9670, 768, 777, 1041 Hepatitis_general_v—987, 934, 922, 878, 876, 842, 786, 781, 563, 562, 558, 534, 528, 477, 334, 321, 317, 224, 213, 166 Parasite sets including Parasites general and Parasites blood flukes.)—880, 787, 727, 444, 125, 95, 72, 20, 1865, 3176 Jaundice (see also Liver support, gallbladder, Leptospirosis,and Parasites fluke and general frequency sets)—5000, 1600, 1550, 1500, 880, 802, 650, 625, 600, 444, 1865, 146, 125, 95, 72, 20 Mold (see also specific types)—222, 242, 523, 565, 592, 623, 745, 933, 1130, 1155, 1333, 1833, 4442 Mold_and_fungus_general_v (see also specific types) - 4442, 2411, 1833, 1823, 1333, 1155, 1130, 1016, 942, 933, 886, 880, 866. 784, 774, 766, 745, 743, 728, 623, 623, 594, 592, 565, 555. 524, 512, 464, 414, 374, 344, 337, 321, 254, 242, 222, 158, 132 Mycobacterium_phlei_HC—20412.70, 1016.29 Mycobacterium_tuberculosis_HC (causes tuberculosis)—21508.01, 1070.82. Mycogone_fungoides—488, 532, 662, 764, 852, 1444 Mycogone_fungoides_secondary—328, 367, 490, 491, 495, 496, 628, 678, 761, 766, 768, 1055, 1074, 9979, 709, 714, 729, 746, 757 Mycogone_spp (homeopathic allergenic preparation based on fungus)—371, 446, 1123, 748 Nanobacteria_2—6771,59, 6772.13, 6749, 6773.44, 6772.29, 6725.50, 5965.19, 5198.33, 5.543.65, 5631.24, 9916.73, 8798.81, 8661.95, 4628.34, 4128.50, 2931.45, 2208.53, 2100.67 Nanobacteria_3—13543.18, 13543.89, 13544.26, 13544,49, 1:3546.48, 13546.88,13544.59, 13545.21, 13546.95, 11930.39, 10396.66, 9916,73, 8798.81, 8661,95, 4628.34, 4128.50, 2931.45, 2208.53, 2100.67 Nanobacteria_sangineum_TR—7635.45, 6653.86, 6346,71, 5631.24, 5543,65, 2962.14, 2642,24, 1876.13, 1413.46, 1344.43, 1902. 317 Parasites_ancylostoma_braziliense_HC (Dog and cat hookworm, the larva of which is the most common cause of cutaneous larva migrans aka creeping eruption. Also see Parasites hookworm)—19964.61, 993.98 Parasites_ancylostoma_caninum_HC—19914.83, 991.50, 19566.32, 974.15, 19217.81, 956.80 Parasites_ascaris (152*)—152, 442, 8146, 751, 1146, 797 Parasites_ascaris_HC (larvae in lung)—20313.12, 1011.33 Parasites_ascaris_megalocephala_HC—20313.12, 1011.33 Parasites_capillaria_hepatica_HC—21308.87, 1060.91 Parasites_cionorchis_sinensis_HC—21259.08, 1058.43 Parasites_cryptocotyle_lingua_HC—20611.85, 1026.20 Parasites_dirofilaria_intinitis_HC (dog heartworm)—20362.91, 1013.81 Parasites_echinoparyphium_recurvatum_HC—20960.36, 1043.55 Parasites_echinostoma_revolutum_HC—21308.87, 1060.91 Parasites_enterobiasis (pinworms; intestinal worms which cause itching of the anal and perianal areas)—20, 112, 120, 773. 826, 827, 835, 4152 Parasites_enterobitts_vermicularis_HC—21059.93, 1048.51 Parasites_eurytrema_pancreaticum_HC—20960.36, 1043.55 Parasites_fasciola_hepatica_HC—21159.50, 1053.47 Parasites_fasciola_hepatica_cercariac_HC—21259.08, 1058.43 Parasites_fasciola_hepatica_eggs_HC—21159.50, 1053.47 Parasites_fasciola_hepatica_miracidia_HC—21059.93, 1048.51 Parasites_fasciola_hepatica_rediae_HC—21159.50, 1053.47 Parasites_fasciolopsis_buskii_adult_HC—21607.59, 1075.78 Parasites_fasciolopsis_buskil_eggs_HC—21607.59, 1075.78 Parasites_fasciolopsis_cercariae_HC—21607.59, 1075.78 Parasites_fasciolopsis_ntiracidia_HC—21607.59, 1075.78 Parasites_fasciolopsis_rediae_HC—21508.01, 1070.82 Parasites_filatiose (worms in blood and organs of mammals, larvae passed from biting insects)—112, 120, 332, 753 Parasites_fischoedrius_elongatus_HC—22005.88, 1095.61 Parasites_flukes_blood—847, 867, 329, 419, 635. 7391. 5516. 9889 Parasites_flukes_general (pancreatic, liver, and intestinal)—6766, 6672, 6641, 6578, 2150, 2128, 2082, 2013, 2008, 2003, 2000, 1850, 945, 854, 846, 830, 763, 676, 651, 524, 435, 275, 142 Parasites_flukes_general_short_set—524, 854, 651 Parasites_flukes_intestinal (2127/2128*)—524, 6511, 676, 844, 848, 854, 2128, 2008, 2084, 2150, 6766 Parasites_flukes_liver—143, 275, 676, 763, 238, 66411, 6672 Parasites_flukes_lymph—10050. 157 Parasites_flukes_pancreatic_1—1850, 2000, 2003, 2008, 2013, 2050, 2080, 6578 Parasites_flukes_sheep_liver—826, 830, 834 Parasites_follicular_mange—253, 693, 701, 774 Parasites_gastrothylax elongatus_HC—22653.12, 1127.83 Parasites_general_1—4412, 2400, 2112, 1862, 1550, 800, 732, 728, 712, 688, 676, 644, 422, 128, 120 Parasites_general_2—10000, 3176, 1998, 1865, 1840, 880, 800, 780, 770, 740, 728, 727, 690, 665, 660, 465, 444, 440, 125, 120, 95, 80, 72, 47 Parasites_general_alternative_v—4122, 1522, 967, 942, 854, 829, 827, 749, 741, 732, 633, 605, 604, 591, 524, 422, 411, 344, 172, 102 Parasites_general_comprehensive—10000, 5000, 4412, 2720, 2400, 2112, 1864, 1550, 1360, 880, 854, 800, 784, 751, 732, 728, 712, 688, 651, 644, 524, 465, 442, 422, 334, 240, 152. 128, 125, 120, 112, 96, 72, 64, 20 Parasites_general_shortset—20, 64, 72, 96, 112, 120, 152, 651, 732, 1360, 2720, 10000 Parasites_gen_custom2_TR (sweep 2000 to 2008 by 1 dwell 360)—6578, 2000, 831, 2000, 2008, 2520, 689, 750, 880, 650, 187 Parasites_giardia—5768, 5429, 4334, 2163, 2018, 1442, 829, 812, 721, 407, 334 Parasites_giardia_lamblia_HC—21109.72, 1050.99 Parasites_gyrodactylus_HC—18919.09, 941.93 Parasites_haemonchus_contortus_HC—19566.32, 974.15 Parasites_heartworms—543, 2322, 200, 535, 1077, 799.728 Parasites_helminthsporium (worm eggs)—793, 969. 164, 5243 Parasites_hookworm—6.8, 440, 2008, 6436, 5868 Parasites_leishmania_braziliensis—787 Parasites_leishmania_braziliensis_HC—20064.19, 998.94 Parasites_leishmania_donovani—525, 781 Parasites_leishmania_donovani_HC—19914.83, 991.50 Parasites_leishmania_mexicana_HC—20014.40, 996.46 Parasites_leishmania_tropica—791 Parisites_leishmania_tropica_HC—20163.76, 1003.89 Parisites_loa_loa_HC—17973.13, 894.83 Parisites_macracanthorhynchus_HC—21906.31, 1090.65 Parasites_metagonimus Yokogawai_HC—21906.31, 1090.65 Parasites_nematode—771 Parasites_onchocerca_volvus_HC (tumor)—21906.31, 1090.65 Parasites_paragonimus_Westermanil_HC—22503.75, 1120.40, 22254.82, 11108.00 Parasites_passalurus_antiguus_HC—21956.110, 1093.13, 21756.95, 1083.21 Parasites_pinworm (use Parasites, enterobiasis) Parasites_roundworms_comp—7159, 5897, 4412, 4152, 3212, 2720, 2322, 1372,1113,1077, 1054, 942. 835, 827, 826, 822, 799, 776, 773, 772, 753, 752, 749, 746, 738. 732, 728, 722, 721, 698, 688, 650, 543, 541, 535, 422, 380, 332, 240, 200, 152, 128, 120, 112, 104, 101, 20 Parasites_roundworms_general—7159, 5897, 4412, 4152, 3212, 2720, 942, 835, 827, 772, 732, 721, 688, 650, 543, 422, 332, 240, 152, 128, 120, 112, 104, 20 Parasites_roundworms_general_short_set—128, 152, 240, 422, 650, 688 Parasites_roundworms_flatworms_TR (use when there is chronic pain from these. 40 min each with converge 0,03125 or 1 0.03333)—6187.5, 6468.8, 5050 Parasites_scabies (follicular mange which is contagious dermatitis found in many animals that is caused by mites and in which the principle activity is at the hair follicles. Use 90, 94, 98, 102, 106, 110, 253, 693 for 10 min. Scan 90 to 110 on lesser frequency intervals if needed. Also, rub skin with olive oil, let sit, then rinse with thyme tea)—920, 1436, 2871, 5742, 90. 94, 98, 102, 106, 110, 253, 693 Parasites_schistosoma_haernatobium (blood flukes)—847, 867, 635 Parasites_schistosoma_haernatobium_HC—23549.28, 1172.45 Parasites_schistosoma_mansoni (blood fluke which can cause symptoms identical to hepatitis C)—329, 9889 Parasites_stephanunts_dentalus (ova)—22951.84, 1142.70 Parasites_strongyloides (threadworm, genus of roundworms)—332, 422, 721, 732, 749, 942, 3212, 4412 Parasites_strongyloides_HC (filariform larva)—19914.83, 991.50 Parasites_strongyloides_secondary—380, 698, 752, 776, 722, 738, 746, 1113 Parasites_taenia (use Parasites, tapeworms) Parasites_tapeworms (if any of these frequencies are felt strongly, also use a good herbal antiparasitic regimen plus CoQ10 in large amounts, 187*, 5522*)—164, 187, 453, 523, 542, 623, 843, 854, 1223, 803, 1360, 3032, 5522 Parasites_tapeworms_echinococcinum (tapeworms found in dogs, wolves, cats, & rodents that can infect man, 5522*)—164, 453, 542, 623, 5522 Parasites_tapewonns_secondary—142, 187, 624, 662 Parasites_threadworms (use Parasites, strongvloides) Parasites_trichinella_spiralis_HC (found in muscle)—20138.87, 1002.66 Parasites_trichinosis—101, 541, 822, 1054, 1372 Parasites_trichonionas_vaginalis_HC—18968.87, 944.40 Parasites_trichuris_sp_HC (male)—20213.55, 1006.37 Parasites_trypanosorna_brucel_HC—21358.65, 1063.38 Parasites_trypanosoma_cruzi_HC (brain tissue)—23051.41, 1147.66 Parasites_trypanosoma_equiperdumilf—22055,67, 1098.09, 22005.88, 1095.61, 21707.16, 1080,74 Parasites_trypanosoma_gambiense HC—19715.68, 981,59 Parasites_trypanosoma_lewisi JIC (blood smear)—21159,50. 1053.47 Parasites_trypanosoma_rhodesiense_TR—21209.29, 1055.95 Parasites_turbatrix—104 Parasites_urocleidus HC-22254.82, 1108.00 Paresis—9.4 Paresthesia—5.5 Peptostreptococcus (see also other Strep sets)—201, 629 Pneumococcus (use Streptococcus pneumoniae) Pnetimocystis_camii (fungus which causes pneumonia usually developing in the immune suppressed or in infants)—204, 340, 742 Sacred_numbers—70, 72. 99, 144, 153, 1260, 3142 Solfeggio_scale—852, 741, 639, 528, 417, 396 Staph_and_Strep_v—40887, 9646, 7160, 2431, 1902, 1109, 1060, 1050, 1010, 985, 958, 934, 786, 727, 718, 686, 643, 576, 563, 542, 453, 436, 423, 411, 333, 134, 128 Staphylococci_infection (see also other Staph freqs, 727*, 786*)—960, 727, 786, 453, 678, 674, 550, 1109, 424, 943, 1050, 643, 2600, 7160, 639, 1089, 8697 Staphylococcus_aureus (can cause boils, carbuncles, abscesses, tooth infection, heart disease, and infect tumors, 786*)—8697, 7270. 1050. 999, 943, 824.4, 787, 784. 745, 738, 728. 727, 647, 644, 555, 478, 424 Staphylococcus_aureus±HC (tooth infection, abscesses, heart disease, invades tumors)—18819.51, 936.97, 18968.87, 944.40 Staphylococcus_coagulae_positive—643 Staphylococcus_comp—40887, 9646, 8697, 7270, 7160, 2600, 2431, 1902, 1109, 1089, 1060, 1050, 1010, 999, 985, 960, 958, 943, 934. 884, 882, 880, 878, 876. 824.4, 787, 786, 784, 745, 738, 728, 727, 718, 686, 678, 674, 647, 644, 643, 639, 634, 576, 563, 555, 550, 542, 478, 453, 436, 424, 423, 411, 333, 134, 128 Staphylococcus_general (728*, 786*)—7160, 1109, 1089, 885, 884, 883, 882, 881, 880, 879, 878, 877, 876, 875, 786, 728, 674, 639, 634, 550, 453 Streptococcus_enterococcinum (can cause infection in the digestive and urinary tracts)—686, 409 Streptococcus_hemolytic (blood infection by strep, 1522*, 535*, 368*, 318*)—728, 880, 786, 712, 128, 134, 334, 443, 535, 542, 675, 1415, 1522, 1902, 691, 710, 1203, 368, 318 Streptococcus_infection_general (streptococcus family. Also see General antiseptic and other Strep sets, 880*)—2000, 1266, 885, 884, 883, 882, 881, 880, 879, 878, 8177, 876, 875, 848, 802, 800, 787, 784, 727 Streptococcus_lactis_HC (occurs in milk)—19168.02, 954.32 Streptococcus_mitis_HC (lung infection, tooth infection, abscesses, stiff knees)—15832.29, 788.24 Streptococcus_mutant_strain—114, 437, 625, 883, 994 Streptococcus_mutant_strainsecondary—108, 433, 488, 687, 833, 8686, 8777, 9676, 660, 732, 745, 754, 764 Streptococcus_pepto (can infect digestive tract)—201, 629 Streptococcus_pneumoniae (can cause pneumonia, empyema, middle car infections, endocarditis, peril arthritis, bacteremia, and meningitis, 683*, 688*)—231, 232, 683, 688, 776, 766, 728, 846, 1552, 8865 Streptococcus_pneumoniae_HC (pneumonia, inner ear disease)—18321.64, 912.18 Streptococcus_pnettinoniae_hi_alt—1136.7, 2273.4, 46275, 46065.5, 46000, 45856, 23138, 23032.8,23000, 22938, 4546.9, 18187.4, 36374.8, 72749.6, 625.5, 20015.3, 40030.6 Streptococcus_pnetimoniae_mixed_flora—158, 174, 645, 801 Streptococcus_pyogenes (pus forming infections. Can cause sore throat, skin inflammation, scarlet fever, pharyngitis, scarlet fever, impetigo, erysipelas, cellulitis, septicemia., toxic shock syndrome, and acute glomerulonephritis See also General antiseptic)—10000, 5004, 8450, 2502, 2111, 1214, 880, 880, 845, 787, 776, 735, 727, 720, 660, 625.5, 616, 465, 20 Streptococcus_pyogenes_HC (infects teeth)—18570.58, 924.57 Streptococcus_sp_group_G_HC—18321.64, 912.18 Streptococcus_viridans (425*, 433*)—425, 433, 445, 935, 1010, 1060, 8478, 457, 465, 777, 778, 1214, 1216 Streptomyces_griseus (soil bacteria which yields streptomycin)—333, 887 Strcptothrix (includes Actinomycosis, Nocardia, and Actinomyces israeli)—10000, 7880, 7870, 2890, 2154, 887, 787, 784, 747, 727, 678, 567, 488, 465, 262, 237, 231, 228, 222, 192, 157, 20 Strongyloides (use Parasites, strongyloides) Struma (family of organisms that can infect the thyroid causing goiter. Use kelp internally. Use Struma cystica, nodosa, and parenchyme freqs.) Taenia (use Parasites tapeworm) Thermi_bacteria—233, 441 Toxin_elimination—0.5, 522, 146, 1552, 800 Toxoplasma_HC (human strain)—19665.89, 979.11 Toxoplasmosis (a serious, infectious disease that can be either acquired or present at birth and that is commonly contracted by handling contaminated cat litter)—434, 852 Transformation series (includes 18 ZOBET, 6 of which are the Sacred Solfeggio, 9 Activation, One KI, and the Sacred Spiral)—9999, 147, 174, 417, 471, 714, 741, 258, 285, 528, 582, 825, 852, 369, 396, 639, 693, 936, 963, 2664, 3330, 3996, 774, 855, 1584, 1746, 2475, 2556, 9990, 144, 234, 378, 612. 991, 1604

Categories of Water Use. The U.S. Geological Survey categorizes water use for analyzing current patterns and predicting future trends. Non-limiting examples of water use can optionally include: Commercial water use includes fresh water for motels, hotels, restaurants, and office buildings, other commercial facilities, and civilian and military institutions. Domestic liquid or water use is probably the most important daily use of water for most people. Domestic liquid or water use includes water that is used in the home every day, including water for normal household purposes, such as drinking, food preparation, bathing, washing clothes and dishes, flushing toilets, and watering lawns and gardens. Industrial water use is a valuable resource to the nation's industries for such purposes as processing, cleaning, transportation, dilution, and cooling in manufacturing facilities, Major water-using industries include steel, chemical, paper, and refining petroleum. Industries often reuse the same water over and over for more than one purpose. Irrigation water use is water artificially applied to farm, orchard, pasture, and horticultural crops, as well as water used to irrigate pastures, for frost and freeze protection, chemical application, crop cooling, harvesting, and for the leaching of salts from the crop root zone. Non-agricultural activities include self-supplied water to irrigate public and private golf courses, parks, nurseries, turf farms, cemeteries, and other landscape irrigation uses. The importance of irrigation to the United States is illustrated by the large amount of fresh water that is used to cultivate crops, which are consumed domestically and throughout the world. In fact, irrigation is the largest category of water use in the United States, as it is worldwide. Livestock water use includes water for stock animals, feed lots, dairies, fish farms, and other non-farm needs. Water is needed for the production of red meat, poultry, eggs, milk, and wool, and for horses, rabbits, and pets. Livestock water use only includes fresh water. Mining water use includes water for the extraction of naturally occurring minerals; solids, such as coal and ores; liquids, such as crude refining petroleum; and gases, such as natural gas. The category includes quarrying, milling (such as crushing, screening, washing, and flotation), and other operations as part of mining activity. A significant portion of the water used for mining, about 32%, is saline. Public Supply water use refers to water withdrawn by public and private water suppliers, such as county and municipal water works, and delivered to users for domestic, commercial, and industrial purposes. In 1995, the majority of the nation's population, about 225 million, or 84%, used water delivered from public water suppliers. About 42 million people supplied their own water, with about 99% of that water being groundwater, usually from a local well. Thermoelectric Power water use is the amount of water used in the production of electric power generated with heat. The source of the heat may be from fossil fuels, nuclear fission, or geothermal. Fossil fuel power plants typically reuse water. They generate electricity by turning a turbine using steam power. After the steam is used to turn the turbines, it is condensed back to water by cooling it. The condensed water is then routed back to the boiler, where the cycle begins again.

Chlorine is a chemical element with symbol CI and atomic number17. The second-lightest of the halogens, it appears between fluorine and bromine in the periodic table and its properties are mostly intermediate between them. Chlorine is a yellow-green gas at room temperature. It is an extremely reactive element and a strong oxidizing agent: among the elements, it has the highest electron affinity and the third-highest electronegativity, behind only oxygen and fluorine.

Chlorinated Water can destroy polyunsaturated fatty acids and vitamin E in the body while generating toxins capable of free radical damage (oxidation). This might explain why supplementation of the diet with essential fatty acids like flax seed oil, evening primrose oil, borage oil and antioxidants like vitamin E, selenium and others helps so many cases of eczema and dry skin. Chlorinated water destroys much of the intestinal flora, the friendly bacteria that help in the digestion of food and which protects the body from hamifuf disease causing pathogens. These bacteria are also responsible for the manufacture of several important vitamins like vitamin B12 and vitamin K Killing beneficial intestinal flora can lead compound to yeast infections, candida, and leaky gut.

Common Waterborne Contaminants. Microbial and organic contaminants cannot always be detected by human senses. Water near agricultural areas may contain harmful organic material from pesticide or fertilizer application. Chemicals from pesticides and fertilizers in water may increase cancer risk and reproductive problems, and can impair eye, liver, kidney, and other body functions Similar problems can result from exposure to water near industrial plants. Sonic common waterborne contaminants include, but not limited to: Aluminum, Ammonia, Arsenic, Barium, Cadmium, Chloramine, Chromium, Copper, Fluoride, Bacteria & Viruses, Lead, Nitrates/Nitrites, Mercury, Perchlorate, Radium, Selenium, Silver and Uranium.

Contaminants Found in Bottled Water, non-limiting examples of the most common contaminants tested in bottled water include: Coliform bacteria - while not dangerous by themselves, their presence often indicates the presence of other more serious bacteria. Synthetic chemicals - with more and more companies dumping their waste into public waters, synthetic chemicals are showing up in water tests. Many of these synthetic chemicals are so new that no one knows what long-term effects they may have on the human body. Fluoride - especially important for women concerned about bone loss, Excessive fluoride revels can cause adverse effects on bones. Arsenic contamination - this is a well-known human carcinogen. If the water is from communities near mining companies or other industrial companies, the groundwater may be contaminated with arsenic. Chloroform—another human carcinogen, Also thought to poison the liver and have adverse effects on the heart, Nitrates—the controversy still rages over whether this is or is not a carcinogen. Many health nutritionists believe that it is a cancer trigger.

Contaminants Found in Groundwater. Groundwater will normally look clear and clean because the ground naturally filters out particulate matter. But, natural and human-induced chemicals can be found in groundwater. As groundwater flows through the ground, metals such as iron and manganese are dissolved and may later be found in high concentrations in the water. Industrial discharges, urban activities, agriculture, groundwater pumpage, and disposal of waste all can affect groundwater quality. Contaminants can be human-induced, as from leaking fuel tanks or toxic chemical spills. Pesticides and fertilizers applied to lawns and crops can accumulate and migrate to the water table. Leakage from septic tanks andlor waste-disposal sites also can introduce bacteria to the water, and pesticides and fertilizers that seep into thnned soil can eventually end up in water drawn from a well. Or, a well might have been placed in land that was once used for something hike a garbage or chemical dump site. In any case, if you use your own well to supply drinking water to your home, it is wise to have your well water tested for contaminates.

Crystal is a crystal or crystalline solid is a solid material whose constituent atoms, molecules, or ions are arranged in an orderly repeating pattern extending in all three spatial dimensions. We call this orderly repeating pattern. a “crystal lattice.” Essentially these molecules are arranged in an orderly formation. In other words, a crystal is in-formation. Computers store and transmit information on silicone crystals. Crystals, which are basically, sand in formation and so can hold memory. Crystalline water or structured water is in-formation and so can also store and transmit information.

Crystalline Forms. Each of the Earth's minerals has a crystalline form. Diamonds are crystalline carbon; emeralds are crystalline beryllium; and rubies are crystalline corundum. The difference between corundum and a ruby is the way the molecules are organized or structured (see images of corundum and ruby at right). Each crystal has a specific structural pattern. Minerals form crystals when circumstances (for example: heat and/or pressure) cause the molecules to form a repeating pattern. Most people know that extreme pressure is required to form a diamond. Pressure forces molecules to arrange themselves in a different configuration to withstand the pressure. Structural organization changes the characteristics of the substance. Some of these changes are obvious—like the visible difference between carbon and a diamond. It's all a matter of organization.

Desalination or desalinization is a process that removes minerals from saline water. More generally, desalination may also refer to the removal of salts and minerals and other chemicals, synthetic compounds, suspended solids, as in soil desalination, which also happens to be a major issue for agricultural production. Salt water is desalinated to produce fresh water suitable for human consumption or irrigation or other water pretreatment uses or wastewater uses. One potential by-product of desalination is salt. Desalination is used on many seagoing ships and submarines. Most of the modern interest in desalination is focused on developing cost-effective ways of providing fresh water for human use. Along with recycled liquid or water uses, this is one of the few rainfall-independent water sources. Due to relatively high energy consumption, the costs of desalinating sea water are generally higher than the alternatives (fresh water from rivers or groundwater, water recycling and water conservation), but alternatives are not always available and rapid overdraw and depletion of reserves is a critical problem worldwide. The largest % of desalinated water used in any country is in Israel, which produces 40% of its domestic wastewater use from seawater desalination.

Dioxins and dioxin-like compounds (DLCs) are compounds that are highly toxic environmental persistent organic pollutants (POPs). They are mostly by-products of various industrial processes—or, in case of dioxin-like PCBs and PBBs, part of intentionally produced mixtures. They include: Polychlorinated dibenzo-p-dioxins (PCDDs), or simply dioxins. PCDDs are derivatives of dibenzo-p-dioxin. There are 75 PCDD congeners, differing in the number and location of chlorine atoms, and seven of them are especially toxic, the most dangerous being 2,3,7,8-Tetrachlorodibenzodioxin. (TCDD). Polychlorinated dibenzofurans (PCDFs), or furans. PCDFs are derivatives of diberrzofuran. There are 135 isomers, ten have dioxin-like properties. Polychlorinatectipolybrominated biphenyls (PCBs/PBBs), derived from biphenyl, of which twelve are “dioxin-like”. Under certain conditions PCBs may form dibenzofurans/dioxins through partial oxidation. Finally, dioxin may refer to 1,4-Dioxin proper, the basic chemical unit of the more complex dioxins. This simple compound is not persistent and has no PCDD-like toxicity. Dichlorodiphenyltrichloroethane (DDT) is a colorless, tasteless, and almost odorless crystalline organochlorine known for its insecticidal properties and environmental impacts. First synthesized in 1874, DDT's insecticidal action was discovered by the Swiss chemist Paul Hermann Willer in 1939. DDT was used in the second half of World War II to control malaria and typhus among civilians and troops. Muller was awarded the Nobel Prize in Physiology or Medicine “for his discovery of the high efficiency of DDT as a contact poison against several arthropods” in 1948.

Disinfectants are antimicrobial agents that are applied to the surface of non-living objects to destroy microorganisms that are living on the objects. Disinfection does not necessarily kill all microorganisms, especially resistant bacterial spores; it is less effective than sterilization, which is an extreme physical and/or chemical process that kills all types of life. Disinfectants are different from other antimicrobial agents such as antibiotics, which destroy microorganisms within the body, and antiseptics, which destroy microorganisms on living tissue. Disinfectants are also different from biocides the latter are intended to destroy all forms of life, not just microorganisms. Disinfectants work by destroying the cell wall of microbes or interfering with the metabolism. Sanitizer are substances that simultaneously clean and disinfect. Disinfectants are frequently used in hospitals, dental surgeries, kitchens, and bathrooms to kill infectious organisms. Bacterial endospores are most resistant to disinfectants, but some viruses and bacteria also possess some tolerance. In wastewater treatment, a disinfection step with chlorine, ultra-violet (UV) radiation or ozonation can be included as tertiary treatment to remove pathogens from wastewater, for example if it is to be reused to irrigate golf courses. An alternative tenni used in the sanitation sector for disinfection of waste streams, sewage sludge or fecal sludge is sanitization or sanitization.

Drinking Water, also known as potable water or improved drinking water, is water safe enough for drinking and food preparation. Globally, in 2012, 89% of people had access to water suitable for drinking. Nearly 4 billion had access to tap water while another 2.3 billion had access to wells or public taps. 1.8 billion people stilt use an unsafe drinking water source, which may be contaminated by feces. This can result in infectious diarrhea such as cholera and typhoid among others. Water is essential for life. The amount of drinking water required is variable. It depends on physical activity, age, health issues, and environmental conditions. It is estimated that the average American drinks about one liter of water a day with 95% drinking less than three liters per day. For those working in a hot climate, up to 16 liters a day may be required. Water makes up about 60% of weight in men and 55% of weight in women. Infants are about 70% to 80% water while the elderly are around 45%. Typically in developed countries, tap water meets drinking water quality standards, even though only a small proportion is actually consumed or used in food preparation Other typical uses include washing, toilets, and irrigation. Greywater may also be used for toilets or irrigation. Its use for irrigation however may be associated with risks. Water may also be unacceptable due to levels of toxins or suspended solids. Reduction of waterborne diseases and development of safe water resources is a major public health goal in developing countries. Bottled water is sold for public consumption in most parts of the world. The word potable came into English from the Late Latin potabilis, meaning drinkable. The amount of drinking water required is variable. It depends on physical activity, age, health, and environmental conditions. It is estimated that the average American drinks about one liter of water a day with 95% drinking less than three liters per day. For those working in a hot climate, up to 16 liters per day may be required. Some health authorities have suggested that at least eight glasses of eight fl oz, each (240 mL) are required by an adult per day (64 fl oz., or 1.89 liters). The British recommends 18 liters. However, various reviews of the evidence performed in 2002 and 2008 could not find any solid scientific evidence recommending eight glasses of water per day. In the United States, the reference daily intake (RDI) for total water intake is 3,7 liters per day (L/day) for human males older than 18, and 2.7 L/day for human females older than 18, which includes drinking water, water in beverages, and water contained in food. An individual's thirst provides a better guide for how much water they require rather than a specific, fixed quantity. The drinking water contribution to mineral nutrients intake is also unclear. Inorganic minerals generally enter surface water and ground water via storm water runoff or through the Earths crust. Treatment processes also lead compound to the presence of some minerals. Examples include calcium, zinc, manganese, phosphate, fluoride and sodium compounds. Water generated from the biochemical metabolism of nutrients provides a significant proportion of the daily water requirements for some arthropods and desert animals, but provides only a small fraction of a human's necessary intake There are a variety of trace elements present in virtually all potable water, some of which play a role in metabolism. For example, sodium, potassium and chloride are common chemicals found in small quantities in most waters, and these elements play a role in body metabolism. Other elements such as fluoride, while beneficial in low concentrations, can cause dental problems and other issues when present at high levels. Fluid balance is key, Profuse sweating can increase the need for electrolyte (salt) replacement. Water intoxication (which results in hyponatremia), the process of consuming too much water too quickly, can be fatal. Water covers some 70% of the Earth's surface, Approximately 97.2% of it is saline, just 2.8% fresh. Potable water is available in almost all populated areas of the Earth, although it may be expensive and the supply may not always be sustainable. Sources where water may be obtained include: Ground sources such as groundwater, springs, hyporheic zones and aquifers; Precipitation which includes rain, hail, snow, fog, etc.; Surface water such as rivers, streams, glaciers; Biological sources such as plants; Desalinated seawater; Water supply network; Atmospheric water generator. Springs are often used as sources for bottled waters. Tap water, delivered by domestic liquid or water in developed nations, refers to water piped to homes and delivered to a tap or spigot. For these water sources to be consumed safely they must receive adequate treatment and meet drinking water regulations. The most efficient way to transport and deliver potable water is through pipes. Plumbing can require significant capital investment. Some systems suffer high operating costs. The cost to replace the deteriorating water and sanitation infrastructure of industrialized countries may be as high as $200 billion a year. Leakage of untreated and treated water from pipes reduces access to water. Leakage rates of 50% are not uncommon in urban systems. Because of the high initial investments, many less wealthy nations cannot afford to develop or sustain appropriate infrastructure, and as a consequence people in these areas may spend a correspondingly higher fraction of their income on water. 2003 statistics from El Salvador, for example, indicate that the poorest 20% of households spend more than 10% of their total income on water. In the United Kingdom authorities define spending of more than 3% of one's income on water as a hardship. The World Health Organization/UNICEF Joint Monitoring Program (JMP) for Water Supply and Sanitation is the official United Nations mechanism tasked with monitoring progress towards the Millennium Development Goal (MDG) relating to drinking-water and sanitation (MDG 7, Target 7c). which is to: “Halve, by 2015, the proportion of people without sustainable access to safe drinking-water and basic sanitation.” The JMP is required to use the following MDG indicator for monitoring the water component of this: Proportion of population using an improved drinking-water source. According to this indicator on improved water sources, the MDG was met in 2010. five years ahead of schedule. Over 2 billion more people used improved drinking water sources in 2010 than did in 1990. However, the job is far from finished. 780 million people are still without improved sources of drinking water, and many more still lack safe drinking water: complete information about drinking water safety is not yet available for global monitoring of safe drinking water. Estimates suggest that at least 25% of improved sources contain fecal contamination and an estimated 1.8 billion people globally use a source of drinking water, which suffers from fecal contamination. The quality of these sources vary over time and are typically of worse quality in the wet season. Continued efforts are needed to reduce urban-rural disparities and inequities associated with poverty; to dramatically increase coverage in countries in sub-Saharan Africa and Oceania; to promote global monitoring of drinking water quality; and to look beyond the MDG target towards universal coverage. Expanding WASH (Water, Sanitation, Hygiene) coverage and monitoring in non-household settings such as schools, health care facilities, and workplaces, is an important post-2015 development objective. Drinking Water Quality Standards describes the quality parameters set for drinking water. Despite the truism that every human on this planet needs drinking water to survive and that water may contain many harmful constituents, there are no universally recognized and accepted international standards for drinking water. Even where standards do exist, and are applied, the permitted concentration of individual constituents may vary by as much as ten times from one set of standards to another. Many developed countries specify standards to be applied in their own countiy. In Europe, this includes the European and in the United States the United States Environmental Protection Agency(EPA) establishes standards as required by the Safe Drinking Water Act. For countries without a. legislative or administrative framework for such standards, the World Health Organization publishes guidelines ora the standards that should be achieved. China adopted its own drinking water standard GB3838-2002 (Type II) enacted by Ministry in 2002. Where drinking water quality standards do exist, most are expressed as guidelines or targets rather than requirements, and very few water standards have any legal basis or, are subject to enforcement. Two exceptions are the European Drinking Water Directive and the Safe Drinking Water Act in the USA, which require legal compliance with specific standards. In Europe, this includes a requirement for member states to enact appropriate local legislation to mandate the directive in each country. Routine inspection and, where required, enforcement is enacted by penalties imposed by the European Commission on non-compliant nations. Countries with guideline values as their standards include Canada, which has guideline values for a relatively small suite of parameters, New Zealand, where there is a legislative basis, but water providers have to make “best endeavors” to comply with the standards, and Australia.

Electromagnetic Coil is an electrical conductor such as a wire in the shape of a coil, spiral or helix. Electromagnetic coils are used in electrical engineering, in applications where electric currents interact with magnetic fields, in devices such as inductors, electromagnets, transformers, and sensor coils. Either an electric current is passed through the wire of the coil to generate a magnetic field, or conversely an external time-varying magnetic field through the interior of the coil generates an EMF (voltage) in the conductor. A current through any conductor creates a circular magnetic field around the conductor due to Ampere's law. The advantage of using the coil shape is that it increases the strength of magnetic field produced by a given current. The magnetic fields generated by the separate turns of wire all pass through the center of the coil and add (superpose) to produce a strong field there. The more tunes of wire, the stronger the field produced. Conversely, a changing external magnetic flux induces a voltage in a conductor such as a wire, due to Faraday's law of induction. The induced voltage can he increased by winding the wire into a coil, because the field lines intersect the circuit multiple times. The direction of the magnetic field produced by a coil can be detemiined by the right hand grip rule. If the fingers of the right hand are wrapped around the magnetic core of a coil in the direction of conventional current through the wire, the thumb will point in the direction the magnetic field lines pass through the coil. The end of a magnetic core from which the field lines emerge is defined to be the North pole.

Electromagnetic Radiation (EM radiation or EMR) is a form of radiant released by certain electromagnetic processes. Visible light is one type of electromagnetic radiation, and in some contexts light can refer to all EMR. Other familiar forms are invisible electromagnetic radiations such as X-rays and radio waves. Classically. EMR is made from or includes electromagnetic fields, which are synchronized oscillations of electric and magnetic fields that propagate at the speed of light. The oscillations of the two fields are perpendicular to each other and perpendicular to the direction of energy and wave propagation, forming a transverse wave. Electromagnetic fields can be characterized by either the resonant frequency or wavelength of their oscillations to form the electromagnetic spectrum, which includes, in order of increasing frequency and decreasing wavelength: waves, microwaves, infrared radiation, visible light, ultraviolet radiation. X-rays and ganuna rays. Electromagnetic fields are produced whenever charged particles are accelerated, and these waves can subsequently interact with any charged particles. EM waves carry energy, momentum and angular momentum away from their source particle and can impart those quantities to matter with which they interact. EM waves are massless, but they are still affected by gravity. Electromagnetic radiation is associated with those EM waves that are free to propagate themselves (“radiate”) without the continuing influence of the moving charges that produced them, because they have achieved sufficient distance from those charges. Thus, EMR is sometimes referred to as the far field. In this jargon, the nearfield refers to EM fields near the charges and current that directly produced them, as (for example) with simple magnets, electromagnetic induction and static electricity phenomena. In the quantum theory of electromagnetism, EMR includes photons, the particles responsible for all electromagnetic interactions, Quanthm2 effects provide additional sources of EMR, such as the transition of electrons to lower energy levels in an atom and black-body radiation. The energy of an individual photon is quantized and is greater for photons of higher frequency. This relationship is given by Planck's equation E=hv, where E is the energy per photon, v is the resonant frequency of the photon, and h is Planck's constant. A single gamma ray photon, for example, might carry ˜100,000 times the energy of a single photon of visible light. The effects of EMR upon biological systems (and also to many other chemical systems, under standard conditions) depend both upon the radiation's power and its frequency. For EMR of visible frequencies or lower (i.e., radio, microwave, infrared), the damage done to cells and other materials is determined mainly by power and caused primarily by heating effects from the combined energy transfer of many photons. By contrast, for ultraviolet and higher frequencies (i.e., X-rays and gamma rays), chemical materials and living cells can be further damaged beyond that done by simple heating, since individual photons of such using varying frequency have enough energy to cause direct molecular damage.

Electromagnetic Spectrum of Light, generally, EM radiation, or EMR (the designation “radiation” excludes static electric and magnetic and near fields), is classified by wavelength into radio, microwave, infrared, the visible region that we perceive as light, ultraviolet, X-rays and gamma rays. The behavior of EMR depends on its wavelength. Higher frequencies have shorter wavelengths, and lower frequencies have longer wavelengths, When EMR interacts with single atoms and molecules, its behavior depends on the amount of energy per quantum it carries. EMIR in the visible light region includes quanta (called photons) that are at the lower end of the energies that are capable of causing electronic excitation within molecules, which lead compounds to changes in the bonding or chemistry of the molecule. At the lower end of the visible light spectrum, EMR becomes invisible to humans (infrared) because its photons no longer have enough individual energy to cause a lasting molecular change (a change in conformation) in the visual molecule retinal in the human retina, which change triggers the sensation of vision There exist animals that are sensitive to various types of infrared, but not by quantum-absorption. Infrared sensing in snakes depends on a kind of natural thermal imaging, in which tiny packets of cellular water are raised in temperature by the infrared radiation. EMR in this range causes molecular vibration and heating effects, which is how these animals detect it. Above the range of visible light, ultraviolet light becomes invisible to humans, mostly because it is absorbed by the cornea below 360 nanometers and the internal lens is below 400. Furthermore, the rods and cones located in the retina of the human eye cannot detect the very short (below 360 nm) ultraviolet wavelengths and are in fact damaged by ultraviolet. Many animals with eyes that do not require lenses (such as insects and shrimp) are able to detect ultraviolet, by quantum photon-absorption mechanisms, in much the same chemical way that humans detect visible light. Various sources define visible light as narrowly as 420 to 680 to as broadly as 380 to 800 nm. Under ideal laboratory conditions, people can see infrared up to at least 1050 nm; children and young adults may perceive ultraviolet wavelengths down to about 310 to 313 nm.

Electrolysis of Water is the decomposition of water (H₂O) into oxygen (0₂) and hydrogen gas (I-1₂) due to an electric current being passed through the water. This technique can be used to make hydrogen fuel (hydrogen gas) and breathable oxygen; though currently most industrial methods make hydrogen fuel from natural gas instead,

Electromagnetic Absorption by Water, the absorption of electromagnetic radiation by water depends on the state of the water. The absorption in the gas phase occurs in three regions of the spectrum. Rotational transitions are responsible for absorption in the microwave and far-infrared, vibrational transitions in the mid-infrared and near infrared. Vibrational bands have rotational fine structure. Electronic transitions occur in the vacuum ultraviolet regions. Liquid water has no rotational spectrum but does absorb in the microwave region. The water molecule, in the gaseous state, has three types of transition that can give rise to absorption of electromagnetic radiation. Rotational transitions, in which the molecule gains a quantum of rotational energy. Atmospheric water vapor at ambient temperature and pressure gives rise to absorption in the far-infrared region of the spectrum, from about 200 cm⁻¹ (50 μm) to longer wavelengths towards the microwave region. Vibrational transitions are in which a molecule gains a quantum of vibrational energy. The fundamental transitions give rise to absorption in the mid-infrared in the regions around 1650 cm⁻¹ (μband, 6 μm) and 3500 cm⁻¹ (so-called X band, 2.9 μm). Electronic transitions are in which a molecule is promoted to an excited electronic state. The lowest energy transition of this type is in the vacuum ultraviolet region. In reality, vibrations of molecules in the gaseous state are accompanied by rotational transitions, giving rise to a vibration-rotation spectrum. Furthermore, vibrational overtones and combination bands occur in the near-infrared region. The HITRAN spectroscopy database lists more than 37,000 spectral lines for gaseous H₂¹⁶O, ranging from the microwave region to the visible spectrum. In liquid water the rotational transitions are effectively quenched, but absorption bands are affected by hydrogen bonding. in crystalline ice the vibrational spectrum is also affected by hydrogen bonding and there are lattice vibrations causing absorption in the far-infrared. Electronic transitions of gaseous molecules will show both vibrational and rotational fine structure. Units. Infrared absorption band positions may be given either in wavelength, micrometers, pm, often shortened to “microns,” or wavenumbers per centimeter, cm sometimes referred to as reciprocal centimeters. Since there are 10⁴ micrometers in 1 centimeter, the two units are related by wavenumber (cm⁻⁴)=10⁴/wavelength (μm). Wavenumber per centimeter is the reciprocal of the wavelength in cm. Rotational spectrum. The water molecule is an asymmetric top, that is, it has three independent moments of inertia. Consequently, the spectrum has no obvious structure. A large number of transitions can be observed: lines due to atmospheric water vapor can easily be observed from about 50 μm (200 cm⁻¹) to longer wavelengths. Measurements of microwave spectra have provided a very precise value for the O—H bond length, 95.84±0.05 μm and H—O—H bond angle, 104.5±0.3°. The water molecule has three fundamental molecular vibrations. The O—H stretching vibrations give rise to absorption bands with band at 3657 cm⁻¹ (v₁, 2,734 μm) and 3756 cm⁻¹ (v₃, 2,662 μm) in the gas phase. The asymmetric stretching vibration, of B₂ symmetry in the point group C₂, is a normal vibration, The H—O—H bending mode origin is at 1595 cm⁻¹ (v₂, 6.269 μm). Both symmetric stretching and bending vibrations have Aₗ symmetry, but the resonant frequency difference between them is so large that mixing is effectively zero. In the gas phase all three bands show extensive rotational fine structure, v₃ has a series of overtones at wavenumbers somewhat less than n v₃, n=2,3,4,5. Combination bands, such as v₂+v₃ are also easily observed in the near infrared region. The presence of water vapor in the atmosphere is important for atmospheric chemistry as the infrared and near infrared spectra are easy to observe. Standard (atmospheric optical) codes are assigned to absorption bands as follows. 0.718 μm (visible): α, 0.810 μm: μ, 0.935 μm: ρστ, 1.13 μm: φ, 1.38 μm: ψ, 1.88 μm: Ω, 2.68 μm: X. The gaps between the hands define the infrared window in the Earth's atmosphere. The infrared spectrum of liquid water is dominated by the intense absorption due to the fundamental O—H stretching vibrations. Because of the high intensity, very short path lengths, usually less than 50 μm, are needed to record the spectra of aqueous solutions. There is no rotational fine structure, but the absorption band is broader than might be expected, because of hydrogen bonding. Peak maxima for liquid water are observed at 3450 cm⁻¹(2.898 μm), 3615 cm⁻¹ (2.766 μm) and 1640 cm⁻¹ (6.097 μm). Direct measurement of the infrared spectra of aqueous solutions requires that the cuvette windows be made of substances such as fluoride compounds, which are water-insoluble. This difficulty can be overcome by using an Attenuated total reflectance (ATR) device. In the near-infrared range liquid water has absorption bands around 1950 nm (5128 cm⁻¹), 1450 nm (6896 cm⁻¹), 1200 run (8333 cm⁻¹) and 970 nm, (10300 cm ⁻¹). The regions between these bands can be used in near-infrared spectroscopy to measure the spectra of aqueous solutions, with the advantage that glass is transparent in this region, so glass cuvettes can be used. The absorption intensity is weaker than for the fundamental vibrations, but this is not important as longer path-length cuvettes are used. The absorption band at 698 nm (14300 cm⁻¹) is a 3rd overtone (n=4). It tails off onto the visible region and is responsible for the intrinsic blue color of water. This can be observed with a standard UV/vis spectrophotometer, using a 10 cm path-length. The color can be seen by eye by looking through a column of water about 10m in knoll; the water must be passed through an ultra-filter to eliminate color due to Rayleigh scattering which also can make water appear blue. in both liquid water and ice cluster vibrations occur, which involve the stretching (TS) or bending (TB) of intermolecular hydrogen bonds (O—H . . . O). Bands at wavelengths λ=50-55 μm (44 μm in ice) have been attributed to TS, intermolecular stretch, and 200 μm (166 μm in ice), to TB, intermolecular bend.The spectrum of ice is similar to that of liquid water, with peak maxima at 3400 cm⁻¹ (2.941 μm), 3220 cm⁻¹ (3.105 μm) and 1620 cm⁻¹ (6.17 μm): Visible region. Absorption coefficients for 200 nm and 900 nm are almost equal at 6.9 m⁻¹ (attenuation length of 14.5 cm). Very weak light absorption, in the visible region, by liquid water has been measured using an integrating cavity absorption meter (ICAM). The absorption was attributed to a sequence of overtone and combination bands whose intensity decreases at each step, giving rise to an absolute minimum at 418 nm, at which wavelength the attenuation coefficient is about 0.0044 m⁻¹, which is an attenuation length of about 227 meters. These values correspond to pure absorption without scattering effects. The attenuation of, e.g., a laser beam would be slightly stronger. Electronic spectrum. Microwaves and radio waves. The electronic transitions of the water molecule lie in the vacuum ultraviolet region. The pure rotation spectrum of water vapor extends into the microwave region. Liquid water has a broad absorption spectrum in the microwave region, which has been explained in terms of changes in the hydrogen bond network giving rise to a broad, featureless. microwave spectrum. The absorption (equivalent to dielectric loss) is used in microwave ovens to heat food that contains water molecules. A frequency of , wavelength 122 mm, is commonly used. Radio communication at GHz frequencies is very difficult in fresh waters and even more so in salt waters.

Electromagnetic Field (EMF or EM field or EHF, are herein collectively referred to as “EMF”) is a physical field produced by electrically charged objects. It affects the behavior of charged objects in the vicinity of the field. The electromagnetic field extends indefinitely throughout space and describes the electromagnetic. It is one of the four fimdamental forces of nature (the others are gravitation, weak interaction and strong interaction). The field can be viewed as the combination of an electric field and magnetic fields. The electric field is produced by stationary charges, and the magnetic fields by moving charges (currents); these two are often described as the sources of the field. The way in which charges and currents interact with an electromagnetic field that is described by Maxwell's equations and the Lorentz force law. From a classical perspective in the history of electromagnetism, the electromagnetic fields can be regarded as a smooth, continuous field, propagated in a wavelike manner; whereas from the perspective of quantum field theory, the field is seen as quantized, being composed of individual particles.

Electrical Polarity (positive and negative) is present in every electrical circuit. Electrons flow from the negative pole to the positive pole. In a direct current (DC) circuit, one pole is always negative, the other pole is always positive and the electrons flow in one direction only. In an alternating current (AC) circuit the two poles alternate between negative and positive and the direction of the electron flow using electromagnetic fields of specific varying field (EMT) frequencies alternating current electricity in combination with ultraviolet (UV) light, one or more filtration systems and counter rotating magnetic field generator and oscillating electrical field alternating in polarity, either permanently or periodically, within a water source to be purified that will make liquid or drinking water and one or more types of treated liquid or water for drinking or other purposes,

Electromagnetic Spectrum is the range of all possible frequencies of electromagnetic. The “electromagnetic spectrum” of an oblect has a different meaning, and is instead the characteristic distribution of electromagnetic radiation emitted or absorbed by that particular object. The electromagnetic spectrum extends from below the low frequencies used for modern radio communication to gamma radiation at the short-wavelength (high-frequency) end, thereby covering wavelengths from thousands of kilometers down to a fraction of the size of an atom. The limit for long wavelengths is the size of the universe itself, while it is thought that the short wavelength limit is in the vicinity of the Planck length. Until the middle of last century, it was believed by most physicists that this spectrum was infinite and continuous. Most parts of the electromagnetic spectrum are used in science for spectroscopic and other probing interactions, as ways to study and characterize matter. In addition, radiation from various parts of the spectrum has found many other uses for communications and manufacturing (see electromagnetic radiation for more applications). Electromagnetic waves are typically described by any of the following three physical properties: the resonant frequency f, wavelength λ, or photon energy E. Frequencies observed in astronomy range from 2.4×10²³ Hz (1 GeV gamma rays) down to the local plasma frequency of the ionized interstellar medium (˜1 kHz). Wavelength is inversely proportional to the wave frequency, so gamma rays have very short wavelengths that are fractions of the size of atoms, whereas wavelengths on the opposite end of the spectrum can be as long as the universe. Photon energy is directly proportional to the wave frequency, so gamma ray photons have the highest energy (around a billion electron volts), while radio wave photons have very low energy (around a femto electron volt), Whenever electromagnetic waves exist in a medium with matter, their wavelength is decreased. Wavelengths of electromagnetic radiation, no matter what medium they are traveling through, are usually quoted in terms of the vacuum wavelength, although this is not always explicitly stated. Generally, electromagnetic radiation is classified by wavelength into radio wave, microwave, terahertz (or sub-millimeter) radiation, infrared, the visible region is perceived as light, ultraviolet. X-rays and gamma rays. The behavior of EM radiation depends on its wavelength. When EM radiation interacts with single atoms and molecules, its behavior also depends on the amount of energy per quantum (photon) it carries. Spectroscopy can detect a much wider region of the EM spectrum than the visible range of 400 nm to 700 nm. A common laboratory spectroscope can detect wavelengths from 2 nm to 2500 nm. Detailed information about the physical properties of objects, gases, or even stars can be obtained from this type of device. Spectroscopes are widely used in astrophysics. For example, many hydrogen atoms emit a radio wave photon that has a wavelength of 21.12 cm. Also, frequencies of 30 Hz and below can be produced by and are important in the study of certain stellar nebulae and frequencies as high as 2.9×10²⁷ Hz have been detected from astrophysical sources. Electromagnetic radiation interacts with matter in different ways across the spectrum. These types of interaction are so different that historically different names have been applied to different parts of the spectrum, as though these were dilibrent types of radiation. Thus, although these “dilibrent kinds” of electromagnetic radiation form a quantitatively continuous spectrum of frequencies and wavelengths, the spectrum remains divided for practical reasons related to these qualitative interaction differences. Regions of the Spectrum. The types of electromagnetic radiation are broadly classified into the following classes: Gamma radiation, X-ray radiation, Ultraviolet radiation, Visible radiation, Infrared radiation, Terahertz radiation, Microwave radiation, Radio waves. This classification goes in the increasing order of wavelength, which is characteristic of the type of radiation. While, in general, the classification scheme is accurate, in reality there is often some overlap between neighboring types of electromagnetic energy. For example, SEE radio waves at 60 Hz may be received and studied by astronomers, or may be ducted along wires as electric power, although the latter is, in the strict sense, not electromagnetic radiation at all. The distinction between X-rays and gamma rays is partly based on sources: the photons generated from nuclear decay or other nuclear and sub nuclear/particle process, are always termed gamma rays, whereas X-rays are generated by electronic transitions involving highly energetic inner atomic electrons. In general, nuclear transitions are much more energetic than electronic transitions, so gamma-rays are more energetic than X-rays, but exceptions exist. By analogy to electronic transitions, muonic atom transitions are also said to produce X-rays, even though their energy may exceed 6 mega electron volts (0.96 pJ), whereas there are many (77 known to be less than 10 keV (1.6 0)) low-energy nuclear transitions (e.g., the 7.6 eV (1.22 aJ) nuclear transition of thorium-229), and, despite being one million-fold less energetic than some muonic X-rays, the emitted photons are still called gamma rays due to their nuclear origin. The convention that EM radiation that is known to come from the nucleus is always called “gamma ray” radiation is the only convention that is universally respected, however. Many astronomical gamma ray sources (such as gamma ray bursts) are known to be too energetic (in both intensity and wavelength) to be of nuclear origin. Quite often, in high energy physics and in medical radiotherapy, vety high energy EMR tin the >10 MeV region) which is of higher energy than any nuclear gamma ray is not called X-ray or gamma-ray, but instead by the generic term of “high energy photons.” The region of the spectrum where a particular observed electromagnetic radiation falls, is reference frame-dependent (due to the Doppler shift for light), so EM radiation that one observer would say is in one region of the spectrum could appear to an observer moving at a substantial fraction of the speed of light with respect to the first to be in another part of the spectrum. For example, consider the cosmic microwave background. It was produced, when matter and radiation decoupled, by the de-excitation of hydrogen atoms to the ground state, These photons were from Lyman series transitions, putting them in the ultraviolet (UV) part of the electromagnetic spectrum. Now this radiation has undergone enough cosmological red shift to put it into the microwave region of the spectrum for observers moving slowly (compared to the speed of light) with respect to the cosmos. Radio Frequency. Radio waves generally are utilized by antennas of appropriate size (according to the principle of resonance), with wavelengths ranging from hundreds of meters to about one millimeter. They are used for transmission of data, via modulation, television, mobile phones, wireless networking, and radio all use radio waves. The use of the radio spectrum is regulated by many governments through frequency allocation. Radio waves can be made to carry information by varying a combination of the amplitude, frequency, and phase of the wave within a frequency band. When EM radiation impinges upon a conductor, it couples to the conductor, travels along it, and induces an electric current on the surface of that conductor by exciting the electrons of the conducting material. This effect (the skin effect) is used in antennas.

Microwaves. The super-high frequency (SHF) and extremely high frequency (EHF) of microwaves are on the short side of radio waves. Microwaves are waves that are typically short enough (measured in millimeters) to employ tubular metal waveguides of reasonable diameter. Microwave energy is produced with klystron and magnetron tubes, and with solid state diodes such as Gunn and IMPATT devices. Microwaves are absorbed by molecules that have a dipole moment in liquids. In a microwave oven, this effect is used to heat food. Low-intensity microwave radiation is used in Wi-Fi, although this is at intensity levels unable to cause thermal heating. Volumettic heating, as used by microwave ovens, transfers energy through the material electromagnetically, not as a thermal heat flux. The benefit of this is a more uniform heating and reduced heating time; microwaves can heat material in less than 1% of the time of conventional heating methods, When active, the average microwave oven is powerful enough to cause interference at close range with poorly shielded electromagnetic fields such as those found in mobile medical devices and poorly made consumer electronics.

Terahertz Radiation. Terahertz radiation is a region of the spectrum between far infrared and microwaves. Until recently, the range was rarely studied and few sources existed for microwave energy at the high end of the band (sub-millimeter waves or so-called terahertz waves), but applications such as imaging and communications are now appearing. Scientists are also looking to apply terahertz technology in the armed forces, where high-frequency waves might be directed at enemy troops to incapacitate their electronic equipment. Infrared radiation.

The infrared part of the electromagnetic spectrum covers the range from roughly 300 GHz to 400 THz (1 mm-750 nm). It can be divided into three parts: Far-infrared, from 300 GHz to 30 THz (1 mm-10 μm). The lower part of this range may also be called microwaves or terahertz waves. This radiation is typically absorbed by so-called rotational modes in gas-phase molecules, by molecular motions in liquids, and by phonons in solids. The water in Earth's atmosphere absorbs so strongly in this range that it renders the atmosphere in effect opaque. However, there are certain wavelength ranges (“windows”) within the opaque range that allow partial transmission, and can be used for astronomy. The wavelength range from approximately 200 μm up to a few mm is often referred to as “sub-millimeter” in astronomy, reserving far infrared for wavelengths below 200 um. Mid-infrared, from 30 to 120 THz (10-2.5 μm). Hot objects (black-body radiators) can radiate strongly in this range, and human skin at normal body temperature radiates strongly at the lower end of this region. This radiation is absorbed by molecular vibrations, where the different atoms in a molecule vibrate around their equilibrium positions, This range is sometimes called the fingerprint region, since the mid-infrared absorption spectrum of a compound is very specific for that compound. Near-infrared, from 120 to 400 THz (2,500-750 nm). Physical processes that are relevant for this range are similar to those for visible light. The highest frequencies in this region can be detected directly by some types of photographic film, and by many types of solid state image sensors for infrared photography and videography, Visible Radiation (light). Above infrared in frequency comes visible light. The Sun emits its peak power in the visible region, although integrating the entire emission power spectrum through all wavelengths shows that the Sun emits slightly more infrared than visible light. By definition, visible light is the part of the EM spectrum the human eye is the most sensitive to. Visible light (and near-infrared light) is typically absorbed and emitted by electrons in molecules and atoms that move from one energy level to another. This action allows the chemical mechanisms that underlie human vision and plant photosynthesis. The light that excites the human visual system is a very small portion of the electromagnetic spectrum. A rainbow shows the optical (visible) part of the electromagnetic spectrum; infrared (if it could he seen) would be located just beyond the red side of the rainbow with ultraviolet appearing just beyond the violet end. Electromagnetic radiation with a wavelength between 380 nm and 760 nm (400-790 terahertz) is detected by the human eye and perceived as visible light. Other wavelengths, especially near infrared (longer than 760 nm) and ultraviolet (shorter than 380 nm) are also sometimes referred to as light, especially when the visibility to humans is not relevant. White light is a combination of lights of different wavelengths in the visible spectrum. Passing white light through a prism splits it up into the several colors of light observed in the visible spectrum between 400 nm and 780 nm. If radiation having a frequency in the visible region of the EM spectrum reflects off an object, say, a bowl of fruit, and then strikes the eyes, this results in visual of the scene. The brain's visual system processes the multitude of reflected frequencies into different shades and hues, and through this insufficiently-understood psychophysical phenomenon, most people perceive a bowl of fruit. At most wavelengths, however, the information carried by electromagnetic radiation is not directly detected by human senses. Natural Sources produce EM radiation across the spectrum, and technology can also manipulate a broad range of wavelengths. Optical fiber transmits light that, although not necessarily in the visible part of the spectrum (it is usually infrared), can carry information. The modulation is similar to that used with radio waves. Ultraviolet Radiation. Next in frequency comes ultraviolet (UV). The wavelength of UV rays is shorter than the violet end of the visible spectrum but longer than the X-ray. UV in the very shortest wavelength range (next to X-rays) is capable of ionizing atoms (see photoelectric effect), greatly changing their physical behavior. At the middle range of UV. UV rays cannot ionize but can break chemical bonds, making molecules unusually reactive. Sunburn, for example, is caused by the disruptive effects of middle range UV radiation on skin cells, which is the main cause of skin cancer. UV rays in the middle range can irreparably damage the complex DNA molecules in the cells producing thymine dimers making it a very potent mutagen. The Sun emits significant UV radiation (about 10% of its total power), including extremely short wavelength UV that could potentially destroy most life on land (ocean water would provide some protection for life there). However, most of the Sun's damaging UV wavelengths are absorbed by the atmosphere and ozone layer before they reach the surface. The higher energy (shortest wavelength) ranges of UV (called “vacuum UV”) are absorbed by nitrogen and, at longer wavelengths, by simple diatomic oxygen in the air. Most of the UV in the mid-range of energy is blocked by the ozone layer, which absorbs strongly in the important 200-315 nm range, the lower energy part of which is too long for ordinary dioNygen in air to absorb. The very lowest energy range of UV between 315 mn and visible light (called UV-A) is not blocked well by the atmosphere, but does not cause sunburn and does less biological damage. However, it is not harmless and does create oxygen radicals, mutations and skin damage. See ultraviolet for more information.

Electromagnetic Waves can be described by their wavelengths, energy, and frequency. All three of these things describe a different property of light, yet they are related to each other mathematically. This means that it is correct to talk about the energy of an X-ray or the wavelength of a microwave or the resonant frequency of a radio wave. In thct, X-rays and gamma-rays are usually described in terms of energy, optical and infrared light in terms of wavelength, and radio in terms of frequency. This is a scientific convention that allows the use of the units that are the most convenient for describing whatever energy of light you are looking at. After all—there is a huge difference in energy between radio waves and gamma-rays. Here's an example. Electron-volts, or eV. are a unit of energy often used to describe light in astronomy. A radio wave can have energy of around 4×10⁻¹⁰ eV—a gamma-ray can have energy of 4×10⁹ eV. That's an energy difference of 10¹⁹ (or ten million trillion) eV! Wavelength is usually measured in meters (m). Frequency is the number of cycles of a wave to pass some point in a second. The units of frequency are thus cycles per second, or Hertz (Hz). Radio stations have frequencies. They are usually equal to the station number times 1,000.000 Hz. For instance—the local Washington, DC station HFS has a frequency of 99.1 million Hz in the FM radio band.

Energized Water is water with 7.3 or higher pH and low surface tension.

Extremely High Frequency (EHF) is the ITU designation for the band of radio frequencies in the electromagnetic spectrum from 30 to 300 gigahertz (GHz), above which electromagnetic radiation is considered to be low (or far) infrared light, also referred to as terahertz radiation. Radio waves in this band have wavelengths from ten to one millimeter, giving it the name millimeter band or millimeter wave, sometimes abbreviated MMW or mmW. Millimeter length electromagnetic waves were first investigated in the 1890s by pioneering Indian scientist Jagadish Chandra Bose. Compared to lower bands, radio waves in this band have high atmospheric attenuation; they are absorbed by the gases in the atmosphere. Therefore, they have a short range and can only be used for terrestrial communication over about a kilometer. In particular, signals in the 57-64 GHz region are subject to a resonance of the O₂ molecule and are severely attenuated. Even over relatively short distances, rain fade is a serious problem, caused when absorption by rain reduces signal strength, In climates other than deserts absorption due to humidity also affects propagation. While this absorption limits potential communications range, it also allows for smaller frequency reuse distances than lower frequencies. The short wavelength allows modest size antennas to have a small beam width, further increasing frequency reuse potential

Fluoride/'ﬂυraid/,/'ﬂo:raid/is an inorganic, monatomic anion of fluorine with the chemical formula F-. Fluoride is the simplest anion of fluorine. Its salts and minerals are important chemical reagents and industrial chemicals, mainly used in the production of hydrogen fluoride for fluorocarbons. In terms of charge and size, the fluoride ion resembles the hydroxide ion. Fluoride ions occur on earth in several minerals, particularly fluorite, but are only present in trace quantities in water. Fluoride contributes a distinctive bitter taste. It contributes no color to fluoride salts. Harmonics or a sound wave is a component frequency of the signal that is an integer multiple of the fundamental, i.e. if the fundamental frequency isf the harmonics have frequencies 2f, 3f, 4f, . . . etc. The harmonics have the property that they are all periodic at the fundamental frequency; therefore, the sum of harmonics is also periodic at that frequency. Sound, harmonic frequencies are equally spaced by the width of the fundamental frequency and can be found by repeatedly adding that frequency. For example, if the fundamental frequency (first harmonic) is 25, the frequencies of the next harmonics are: 50 Hz (2nd harmonic), 75 Hz (3rd harmonic), 100 Hz (4th harmonic) etc.

Hertz, the hertz (symbol: Hz) is the derived unit of frequency in the International System of Units (SI) and is defined as one cycle per second. It is named for Heinrich Rudolf Hertz, the first person to provide conclusive proof of the existence of electromagnetic waves. Hertz are commonly expressed in multiples: kilohertz (10³′ kHz). megahertz (10⁶ MHz), gigahertz (10⁹ GHz), and terahertz (10 THz). Some of the unit's most common uses are in the description of sine waves and musical tones, particularly those used in radio- and audio-related applications. It is also used to describe the speeds at which computers and other electronics are driven. The hertz is equivalent to cycles per second, (i.e., “1/second”). The International Committee for Weights and Measures defined the second as “the duration of 9 192 631 770 periods of the radiation corresponding to the transition between the two hyperfine levels of the ground state of the cesium 133 atom” and then adds the obvious conclusion: “It follows that the hyperfine splitting in the ground state of the cesium 133 atom is exactly 9 192 631 770 hertz, v(hfs Cs)=9 192 631 770 Hz.”

In English, “hertz” is also used as the plural form. As an SI unit, Hz can be prefixed; commonly used multiples are kHz (kilohertz, 10³ Hz), MHz (megahertz, 10⁶ Hz), GHz (gigahertz, 10⁹ Hz) and THz (terahertz, 10¹² Hz). One hertz simply means “one cycle per second” (typically that which is being counted is a complete cycle); 100 Hz means “one hundred cycles per second,” and so on. The unit may be applied to any periodic event for example, a clock might be said to tick at 1, or a human heart might be said to beat at 1.2 Hz. The occurrence rate 4a periodic or stochastic events is expressed in reciprocal second or inverse second (1/s or s⁻¹) in general or, in the specific case of radioactive decay, in becquerels.

High Frequency (HF) is the ITU designation for the range of radio frequency electromagnetic waves (radio waves) between 3 and 30 megahertz (MHz). It is also known as the decameter band or decameter wave as its wavelengths range from one to ten decameters (ten to one hundred meters). Frequencies immediately below HF are denoted medium frequency (MF), while the next band of higher frequencies is known as the very high frequency (VHF) band. The HF band is a major part of the shortwave band of frequencies and pulses, so communication at these frequencies is often called shortwave. Because radio waves in this band can be reflected back to Earth by the ionosphere layer in the atmosphere—a method known as “skip” or “skywave” propagation—these frequencies are suitable for long-distance communication across intercontinental distances. The band is used by international shortwave broadcasting stations (2.31-25.82 MHz), aviation communication, government time stations, weather stations, amateur radio and citizens band services, among other uses.

Hydroelectricity is the term referring to electricity generated by hydropower, the production of electrical power through the use of the gravitational force of falling or flowing water. In 2015 hydropower generated 16.6% of the world's total electricity and 70% of all renewable electricity, and is expected to increase about 3.1% each year for the next 25 years. Hydropower is produced in 150 countries, with the Asia-Pacific region generating 33% of global hydropower in 2013. China is the largest hydroelectricity producer, with 920 TWh of production in 2013, representing 16,9% of domestic electricity use. The cost of hydroelectricity is relatively low, making it a competitive source of renewable electricity. The hydro station consumes no water, unlike coal or gas plants. The average cost of electricity from a hydro station larger than 10 megawatts is 3 to 5 U.S. cents per kilowatt-hour. With a dam and reservoir it is also a flexible source of electricity since the amount produced by the station can be changed up or down very quickly to adapt to changing energy demands. Once a hydroelectric complex is constructed, the project produces no direct waste, and has a considerably lower output level of greenhouse gases than fossil fuel powered energy plants.

Hydrogen Bond is the electrostatic attraction between two polar groups that occurs when a hydrogen (H) atom covalently bound to a highly electronegative atom such as nitrogen (N), oxygen (O), or fluorine (F) experiences the electrostatic field of another highly electronegative atom nearby. Hydrogen bonds can occur between molecules (intermolecular) or within different parts of a single molecule (intermolecular). Depending on geometry and environment, the hydrogen bond free energy content is between 1 and 5 kcal/mol. This makes it stronger than a van der Waals interaction, but weaker than covalent or ionic bonds. This type of bond can occur in inorganic molecules such as water and in organic molecules like DNA and proteins. Intermolecular hydrogen bonding is responsible for the high boiling point of water (100° C.) compared to the other group 16 hydrides that have much weaker hydrogen bonds. Intermolecular hydrogen bonding is partly responsible for the secondaty and tertiary structures of proteins and nucleic acids. It also plays an important role in the structure of polymers, both synthetic and natural. In 2011, an IUPAC Task Group recommended a modern evidence-based definition of hydrogen bonding, which was published in the IUPAC journal Pure and Applied Chemistry. This definition specifies: The hydrogen bond is an attractive interaction between a hydrogen atom from a molecule or a molecular fragment X-H in which X is more electronegative than H, and an atom or a group of atoms in the same or a different molecule, in which there is evidence of bond formation. A hydrogen atom attached to a relatively electronegative atom will play the role of the hydrogen bond donor. This electronegative atom is usually fluorine, oxygen, or nitrogen. A hydrogen attached to carbon can also participate in hydrogen bonding when the carbon atom is bound to electronegative atoms, as is the case in chloroform, CHCl₃. An example of a hydrogen bond donor is the hydrogen from the hydroxyl group of ethanol, which is bonded to an oxygen. In a hydrogen bond, the electronegative atom not covalently attached to the hydrogen is named proton acceptor, whereas the one covalently bound to the hydrogen is named the proton donor. In the donor molecule, the electronegative atom attracts the electron cloud from around the hydrogen nucleus of the donor, and, by decentralizing the cloud, leaves the atom with a positive partial charge. Because of the small size of hydrogen relative to other atoms and molecules, the resulting charge, though only partial, represents a large charge density. A hydrogen bond results when this strong positive charge density attracts a lone pair of electrons on another heteroatom, which then becomes the hydrogen-bond acceptor. The hydrogen bond is often described as an electrostatic dipole-dipole interaction. However, it also has some features of covalent bonding: it is directional and strong, produces interatomic distances shorter than the sum of the van der Waals radii, and usually involves a limited number of interaction partners, which can be interpreted as a type of valence. These covalent features are more substantial when acceptors bind hydrogen's from more electronegative donors. The partially covalent nature of a hydrogen bond raises the following questions: “To which molecule or atom does the hydrogen nucleus belong?” and “Which should be labeled ‘donor’ and which ‘acceptor’?” Usually, this is simple to determine on the basis of interatomic distances in the X-H-Y system, where the dots represent the hydrogen bond: the X-H distance is typically ≈110 μm. whereas the H-Y distance is ≈160 to 200 μm. Liquids that display hydrogen bonding (such as water) are called associated liquids. Hydrogen bonds can vary in strength from very weak (1-2 kJ mol⁻¹) to extremely strong (161.5 kJ mol⁻¹ in the ion HF-2). Typical enthalpies in vapor include: F-H...F (161.5 kJ/mol or 38.6 kcal/mol); O—H . . . :N (29 kJ/mol or 6.9 kcal/mol); O—H . . . :O (21 kJ/mol or 5.0 kcal/mol); N—H . . . :N (13 kJ/mol or 3.1 kcal/mol); N—H . . . :O (8 kJ/mol or 1.9 kcal/mol): HO—H . . . :OH+ 3 (18 kJ/mol or 4.3 kcal/mol; data obtained using molecular dynamics as detailed in the reference and should be compared to 7.9 kJ/mol for bulk water, obtained using the same molecular dynamics.) Quantum chemical calculations of the relevant interresidue potential constants (compliance constants) revealed large differences between individual H bonds of the same type. For example, the central interresidue N—H . . . N hydrogen bond between guanine and cytosine is much stronger in comparison to the N—H . . . N bond between the adenine-thymine pair. The length of hydrogen bonds depends on bond strength, temperature, and pressure. The bond strength itself is dependent on temperature, pressure, bond angle, and environment (usually characterized by local dielectric constant). The typical length of a hydrogen bond in water is 197 μm. The ideal bond angle depends on the nature of the hydrogen bond donor. The following hydrogen bond angles between a hydrofluoric acid donor and various acceptors have been determined experimentally.

Hydroponics is a subset of hydro culture and method of growing plants using mineral nutrient solutions, in water, without soil. Terrestrial plants may be grown with their roots in the mineral nutrient solution only or in an inert medium, such as perlite or gravel.

Lead is a chemical element with symbol Ph (from the Latinp/umbutn) and atomic number 82. It is a heavy metal with a density exceeding that of most common materials; it is soft, malleable, and melts at a relatively low temperature. When freshly cut, it has a bluish-white tint, it tarnishes to a dull gray upon exposure to air. Lead has the second-highest atomic number of the classically stable elements and lies at the end of three major decay of heavier elements. Lead is a relatively unreactive post-transition metal. Its weak metallic character is illustrated by its amphoteric nature (lead and lead oxides react with both acids and bases) and tendency to form covalent bonds. Compounds of lead are usually found in the +2 oxidation state, rather than the +4 common with lighter members of the carbon group. Exceptions are mostly limited to organ lead compounds. Like the lighter members of the group, lead exhibits a tendency to bond to itself; it can form chains, rings, and polyhedral structures. Magnetic Fields is the magnetic influence of electric currents and magnetic materials. The magnetic fields at any given point is specified by both a direction and a magnitude (or strength); as such it is a vector field The term is used for two distinct but closely related fields denoted by the symbols B and H, where H is measured in units of amperes per meter (symbol: A.m⁻¹ or A/m) in the SI. B is measured in Teslas (symbol: T) and newtons per meter per ampere (symbol: N.m⁻¹.A⁻¹ or N/(m.A)) in the SI. B is most commonly defined in terms of the Lorentz force it exerts on moving electric charges. Magnetic fields are produced by moving electric charges and the intrinsic magnetic moments of elementary particles associated with a fundamental quantum property, their spin. In special relativity, electric and magnetic fields are two interrelated aspects of a single object, called the electromagnetic tensor; the split of this tensor into electric and magnetic fields depends on the relative velocity of the observer and charge. In quantum physics, the electromagnetic fields are quantized and electromagnetic interactions :result from the exchange of photons.

Maximum Contaminant Levels (MCLS) are standards that are set by the United States Environmental Protection Agency (EPA) for drinking water quality. An MCL, is the legal threshold limit on the amount of a substance that is allowed in public water systems under the Safe Drinking Water Act. The limit is usually expressed as a concentration in milligrams or micrograms per liter of water, To set a Maximum Contaminant. Level for a contaminant, EPA first determines how much of the contaminant may be present with no adverse health effects. This level is called the Maximum Contaminant Level Goal (MCLG). MCLGs are non-enforceable public health goals. The legally enforced MCL is then set as close as possible to the MCLG, The MCL for a contaminant may be higher than the MCLG because of difficulties in measuring small quantities of a contaminant, a lack of available treatment technologies, or if EPA determines that the costs of treatment would outweigh the public health benefits of a lower MCL. In the last case, EPA is permitted to choose an MCL that balances the cost of treatment with the public health benefits. For some contaminants. EPA establishes a Treatment Technique (TT) instead of an MCL. TTs are enforceable procedures that drinking water systems must follow in treating their water for a contaminant. MCLs and TTs are known jointly as National Primary Drinking Water Regulations (NPDWRs), or primary standards. Some contaminants may cause aesthetic problems with drinking water, such as the presence of unpleasant tastes or odors, or cosmetic problems, such as tooth discoloration. Since these contaminants do not cause health problems, there are no legally enforceable limits on their presence in drinking water. However. EPA recommends maximum levels of these contaminants in drinking water. These recommendations are called National Secondary Drinking Water Regulations (NSDWRs), or secondary standards.

Maximum Contaminant Levels (MCLs) are standards that are set by the United States Environmental Protection Agency (EPA) for drinking water quality. An MCL is the legal threshold limit on the amount of a substance that is allowed in public water systems under the Safe Drinking Water Act. The limit is usually expressed as a concentration in milligrams or micrograms per liter of water. To set a Maximum Contaminant Level for a contaminant, EPA first determines how much of the contaminant may be present with no adverse health effects. This level is called the Maximum Contaminant Level Goal (MCLG). MCLGs are non-enforceable public health goals. The legally enforced MCL is then set as close as possible to the MCLG. The MCL for a contaminant may be higher than the MCLG because of difficulties in measuring small quantities of a contaminant, a lack of available treatment technologies, or if EPA determines that the costs of treatment would outweigh the public health benefits of a lower MCL. in the last case, EPA is permitted to choose an MCL that balances the cost of treatment with the public health benefits. For some contaminants, EPA establishes a Treatment Technique (TT) instead of an MCL. TTs are enforceable procedures that drinking water systems must follow in treating their water for a contaminant MCLs and TTs are known jointly as “National Primary Drinking Water Regulations” (NPDWRs), or primary standards Some contaminants may cause aesthetic problems with drinking water, such as the presence of unpleasant tastes or odors, or cosmetic problems, such as tooth discoloration. Since these contaminants do not cause health problems, there are no legally enforceable limits on their presence in drinking water. However, EPA recommends maximum levels of these contaminants in drinking water. These recommendations are called “National Secondary Drinking Water Regulations” (NSDWRs), or secondary standards.

Medication (also called medicine or pharmaceutical drugs) is the use of legal drugs to treat or cure an illness. Some drugs are ficely sold. They are called over-the-counter (OTC) drugs. Other drugs are so powerful or dangerous that a doctor must give permission to use the drug. The note from the doctor is called a “prescription.” These drugs are called prescription drugs, prescription medicines, or prescription only medicines (POM).

Methyl tert-butyl ether (also known as MTBE and Cert-butyl methyl ether) is an organic compound with a structural formula (CH₃)₃COCH₃. MTBE is a volatile, flammable, and colorless liquid that is sparingly soluble in water. It has a minty odor vaguely reminiscent of diethyl ether, leading to unpleasant taste and odor in water. MTBE is a gasoline additive, used as an oxygenate to raise the octane number, Its use is controversial because of its contamination of groundwater and legislation favoring ethanol. However, worldwide production of MTBE has been constant owing to growth in Asian markets.

Mercury is a chemical element with symbol Hg and atomic number 80. it is commonly known as quicksilver and was formerly named hydrargyrum (/hai'drα:rd3∂r∂m). A heavy, silvery d-block element, mercury is the only metallic element that is liquid at standard conditions for temperature and pressure; the only other element that is liquid under these conditions is bromine, though metals such as cesium, gallium, and rubidium melt just above room temperature. Mercury occurs in deposits throughout the world mostly as cinnabar (mercuric sulfide). The red pigment vermilion is obtained by grinding natural cinnabar or synthetic mercuric sulfide.

Microfiltration (commonly abbreviated to MF) is a type of physical filtration process where a contaminated fluid is passed through a special sized membrane to separate microorganisms and suspended particles from process liquid. It is commonly used in conjunction with various other separation processes such as ultrafiltration and reverse osmosis to provide a product stream, which is free of undesired contaminants. Molecular Composition of Cells. Cells are composed of water, inorganic ions, and carbon-containing (organic) molecules. Water is the most abundant molecule in cells, accounting for 70% or more of total cell mass. Consequently, the interactions between water and the other constituents of cells are of central importance in biological chemistry. The critical property of water in this respect is that it is a polar molecule, in which the hydrogen atoms have a slight positive charge and the oxygen has a slight negative charge. Because of their polar nature, water molecules can form hydrogen bonds with each other or with other polar molecules, as well as interacting with positively or negatively charged ions. As a result of these interactions, ions and polar molecules are readily soluble in water (hydrophilic). In contrast, nonpolar molecules, which cannot interact with water, are poorly soluble in an aqueous environment (hydrophobic). Consequently, nonpolar molecules tend to minimize their contact with water by associating closely with each other instead. Interactions of polar and nonpolar molecules with water and with each other play crucial roles in the formation of biological structures, such as cell membranes.

Nanofiltration is a relatively recent membrane filtration process used most often with low total dissolved solids water such as surface water and fresh groundwater, with the purpose of softening (polyvalent cation removal) and removal of disinfection by-products precursors such as natural organic matter and synthetic organic matter. Nanofiltration is also becoming more widely used in food processing liquid or water uses such as dairy, for simultaneous concentration and partial (monovalent ion) demineralization.

Ozonation is a process for infusing water with ozone. This is co witty done to kill bacteria and other organisms, but also for color, taste and odor control.

Over-the-counter (OTC) drugs are medicines sold directly to a consumer without a prescription from a healthcare professional, as opposed to prescription drugs, which may only be sold to consumers possessing a valid prescription. In many countries, OTC drugs are selected by a regulatory agency to ensure that they are ingredients that are safe and effective when used without a physician's care. OTC drugs are usually regulated by active pharmaceutical ingredients (APIs), not final products. By regulating APIs instead of specific drug formulations, governments allow manufacturers freedom to formulate ingredients, or combinations of ingredients, into proprietary mixtures/

pH adjustment systems: pH is important in healthy drinking water, and is preferably higher than 7.0, such as 7.2, 7.5, 8.0, 8.5, and the like. There are two primary types of system design for pH adjustments—continuous and batch, Continuous flow maintains the same volume during the process, where the amount of influent entering it equal to the treated effluent exiting the tank. The advantage of this system is that can handle relatively high flows, However, it is not certain that the effluent will always be in the desired pH range, In batch processing, the batch has a fixed water volume, Which is discharged only after the desired pH is obtained, The batch volume is treated in one cycle.

pH adjusting methods include, but are not limited to raising the pH or lowering the pH, which can include the use of one or more of neutralizing filters, acid injections, magnesium oxide (MgO) beads (which raise the pH); CO2, Soda ash/sodium hydroxide injections (which raise the pH).

Water with pH greater than 6 can be treated with calcium carbonate (limestone) and water with the pH below 6 is treated with the synthetic magnesium oxide. Untreated water passes through a filter filled with either calcium caibonate or a synthetic magnesium oxide medium and the material dissolves in the water therefore raising the pH level. The flow rate should not the greater than 2 l/s.m2. The bed should be deep enough to provide sufficient contact time. The material in the neutralizing filter needs refilling and regular backwashing. If cartridge filters, that retain solids from passing through, are installed before the neutralizing filters, the neutralizing filters will last longer. After the neutralizing filter a water softener can be added to regulate the water hardness. The neutralizing filter may result in pressure loss, since the water passes through the finely ground neutralizing material. The corrosion of the pressure tank and the well pump may occur since the neutralizing filters are installed after the pressure tank. In case of a high flow rate, liquid injection systems are a better solution.

Magnesium oxide beads can be used when the water pH needs to be raised. They are preferably used after reverse osmosis. For this process, pressure is needed the hydrostatic pressure needs to be greater than the osmotic pressure. MgO beads can raise and balance pH levels of the water to 8,7 without any chemicals. In addition to adjusting the pH, the beads lower the surface tension of water, remove toxins and pull out heavy metals from water.

Injection systems can include, but are not limited to, Soda ashIsodium hydroxide injection for acidic water. Acid injection is used for water with a high pH. Acid injection is a point-of-entiy system and can include a solution of acetic acid injected into water. Usually white vinegar is used, as it is the cheapest, but citric acid and alum are also an option, as well as more hazardous weak solutions of hydrochloric acid or sulfuric acid if the pH is above 11. Carbon dioxide is used to reduce in alkaline water. It is used as a pretreatment and sulfuric, acid is added in the second step. The main purpose of this secondary acidification is to reduce the bicarbonate content and avoid calcium carbonate precipitation. It was gives better control of pH than sulfuric acid. It shows self-buffering when reaching neutral pH levels. The self-buffering enables precise end-point control eliminating the danger of lowering the pH too much.

Parasitism, in biologylecology, parasitism is a non-mutual relationship between species, ere one species, the parasite, benefits at the expense of the other, the host. Traditionally parasite (in biological usage) referred primarily to organisms visible to the naked eye, or macro parasites (such as helminths). Parasites can be micro parasites, Which are typically smaller, such as protozoa, viruses, and bacteria. Examples of parasites include the plants mistletoe and cuscuta, and animals such as hookworms. Unlike predators, parasites typically do not kill their host, are generally much smaller than their host, and will often live in or on their host for an extended period. Both are special cases of consumer-resource interactions. Parasites show a high degree of specialization, and reproduce at a faster rate than their hosts. Classic examples of parasitism include interactions between vertebrate hosts and tapeworms, flukes, the Plasmodium species, and fleas.Parasitoidy is an evolutionary strategy within parasitism in which the parasite generally kills its host. Parasites reduce host biological fitness by general or specialized pathology, such as parasitic castration and impairment of secondary sex characteristics, to the modification of host behavior. Parasites increase their own fitness by exploiting hosts for resources necessary for their survival, such as food, water, heat, habitat, and transmission. Although parasitism applies unambiguously to many cases, it is part of a continuum of types of interactions between species, rather than an exclusive category. In many cases, it is difficult to demonstrate harm to the host. In others, there may be no apparent specialization on the part of the parasite, or the interaction between the organisms may remain short-lived.

Pharmaceutical Drug (also referred to as medicine, medication, or simply as drug) is a drug used to diagnose, cure, treat, or prevent disease.Drug therapy (pharmacotherapy) is an important part of the medical field and relies on the science of pharmacology for continual advancement and on pharmacy for appropriate management. Drugs are classified in various ways. One of the key divisions is by level of control, which distinguishes prescription drugs (those that a pharmacist dispenses only on the order of a physician, physician assistant, or qualified nurse) from over-the-counter drugs (those that consumers can order for themselves). Another key distinction is between traditional small-molecule drugs, usually derived from chemical, and biopharmaceuticals, which include recombinant proteins, vaccines, blood products used therapeutically(such as IVIG), gene therapy, monoclonal antibodies and cell therapy (for instance, stem-cell therapies). Other ways to classify medicines are by mode of action, route of administration, biological system affected, or therapeutic effects. An elaborate and widely used classification system is the Anatomical Therapeutic Chemical Classification System (ATC system). The World Health Organization keeps a list of essential medicines. Drug discovery and drug development are complex and expensive endeavors undertaken by pharmaceutical compardes, academic scientists, and governments. As a result of this complex path from discovery to commercialization, partnering has become a standard practice for advancing drug candidates through development pipelines. Governments generally regulate what drugs can be marketed, how drugs are marketed, and in some jurisdictions, drug pricing. Controversies have arisen over drug pricing and disposal of used drugs. One of the key classifications is between traditional small molecule drugs, usually derived from chemical synthesis, and biologic medical products, which include recombinant proteins, vaccines, blood products used therapeutically (such as IViG), gene therapy, and cell therapy (for instance, stem cell therapies). Pharmaceutical or drug or medicines are classified in various other groups besides their origin on the basis of pharmacological properties like mode of action and their pharmacological action or activity, such as by chemical properties, mode or route of administration, biological system affected, or therapeutic effects. An elaborate and widely used classification system is the Anatomical Therapeutic Chemical Classification System (ATC system). The World Health Organization keeps a list of essential medicines. A sampling of classes of medicine includes: Antipyretics: reducing fever (pyrexia/pyresis); Analgesics: reducing pain (painkillers); Antimalarial drugs: treating malaria; Antibiotics: inhibiting germ growth Antiseptics: prevention of germ growth near burns, cuts and wounds; Mood stabilizers: lithium and valpromide; Hormone replacements: Premarin; Oral contraceptives: EnovidTM. “biphasic” pill, and “triphasic” pill; Stimulants: methylphenidate, amphetamine; Tranquilizers; meprobamate, chlorpromazine, reserpine, chlordiazepoxide, diazepam, and alprazolam; Statins: lovastatin, pravastatin, and simvastatin. Pharmaceuticals may also be described as “specialty,” independent of other classifications, which is an ill-defined class of drugs that might be difficult to administer, require special handling during administration, require patient monitoring during and immediately after administration, have particular regulatory requirements restricting their use, and are generally expensive relative to other drugs.

Per-fluorinated Compound (PFC) per- or polyfluoroalkyl chemical is an organofluoride compound containing only carbon-fluorine bonds (no C—H bonds) and C—C bonds but also other heteroatoms. PFCs have properties that represent a blend of fluorocarbons (containing only C—F and C—C bonds) and the parent functionalized organic species. For example, perfluorooctanoic acid functions as a carboxylic acid but with strongly altered surfactant and hydrophobic characteristics. Fluoro-surfactants are ubiquitously used in Teflon, water resistant textiles and fire-fighting foam.

Polarization is a property of waves that can oscillate with more than one orientation. Electromagnetic fields such as light exhibit polarization, as do some other types of wave, such as gravitational waves. Sound waves in a gas or liquid do not exhibit polarization since the oscillation is always in the direction the wave travels. in an electromagnetic wave, both the electric field and magnetic fields are oscillating but in different directions; by convention the “polarization” of light refers to the polarization of the electric field. Light, which can be approximated as a plane wave in free space or in an isotropic medium propagates as a transverse waveboth the electric and magnetic fields are perpendicular to the wave's direction of travel. The oscillation of these fields may be in a single direction (linear polarization), or the field may rotate at the optical frequency (circular or elliptical polarization). In that case the direction of the fields' rotation, and thus the specified polarization, may be either clockwise or counter clockwise; this is referred to as the wave's chirality or handedness. The most common optical materials (such as glass) are isotropic and simply preserve the polarization of a wave but do not differentiate between polarization states. However, there are important classes of materials classified as birefringent or optically active in which this is not the case and a wave's polarization will generally be modified or will affect propagation through it. A polarizer is an optical filter that transmits only one polarization. Polarization is an important parameter in areas of science dealing with transverse wave propagation, such as optics, seismology, radio, and microwaves. Especially impacted are technologies such as lasers, wireless and optical fiber telecommunications, and radar.

Polychlorinated Biphenyl (PCB) is an organic chlorine compound with the formula C₁₂H₁₀₋ₓClₓ. Polychlorinated biphenyls were once widely deployed as dielectric and coolant fluids in electrical apparatus, carbonless copy paper and in heat transfer fluids. Because of their longevity, PCBs are still widely in use, even though their manufacture has declined drastically since the 1960s, when a host of problems were identified. Because of PCBs' environmental toxicity and classification as a persistent organic pollutant, PCB production was banned by the United States Congress in 1979 and by the Stockholm Convention on Persistent Organic Pollutants in 2001, The International Agency for Research on Cancer (IARC), rendered PCBs as definite carcinogens in humans. According to the U.S. Environmental Protection Agency (EPA), PCBs cause cancer in animals and are probable human carcinogens. Many rivers and buildings including schools, parks, and other sites are contaminated with PCBs, and there have been contaminations of food supplies with the toxins. Some PCBs share a structural similarity and toxic mode of action with dioxin. Other toxic effects such as endocrine disruption (notably blocking of thyroid system functioning) and neurotoxicity are known. The maximum allowable contaminant level in drinking water in the United States is set at zero, but because of the limitations of water treatment technologies, a level of 0.5 parts per billion is the de facto level. The bromine analogues of PCBs are polybrominated biphenyls (PBBs), which have analogous applications and environmental concerns.

Portable Water disinfection, filtration and purification systems devices—better described as point-of-use (POU) water treatment systems and field water disinfection techniques—are self-contained, hand-carried units used by recreational enthusiasts, military personnel, survivalists, and others for water disinfection, filtration and purification systems when they need to obtain drinking water from untreated sources (e.g, rivers, lakes, groundwater, etc.). These personal devices and methods attempt to render water potable (i.e. safe and palatable for drinking purposes - without disease-causing pathogens). Techniques include heat (including boiling), filtration, activated charcoal absorption, chemical disinfection (e.g. chlorine, iodine, ozone, etc.), ultraviolet purification systems (including SODIS), distillation (including solar distillation), and flocculation. Often these are used in combination. Many commercial portable water disinfection, filtration and purification systems or chemical additives are available for hiking, camping, and other travel in remote areas.

Purified Water is water that has been mechanically filtered or processed to remove impurities and make it suitable for use. Distilled water has been the most common form of purified water, hut, in recent years, water is more frequently purified by other processes including capacitive deionization, reverse osmosis, carbon filtering, microfiltration, ultrafiltration, ultraviolet oxidation, or electro deionization. Combinations of a number of these processes have come into use to produce water of such high purity that its trace contaminants are measured in parts per billion (ppb) or parts per trillion (ppt). Purified water has many uses, largely in the production of medications, in science and engineering laboratories and industries, and is produced in a range of purities. It can be produced on site for immediate use or purchased in containers. Purified water in colloquial English can also refer to water, which has been treated (“rendered potable”) to neutralize, but not necessarily remove contaminants considered harmful to humans or animals.

Reverse Osmosis (RO) is a water disinfection, filtration and purification systems technology that uses a semipetmeable membrane that can optionally include removing larger particles in drinking water. In using reverse osmosis, an applied pressure is used to overcome osmotic pressure, a colligative property, that is driven by chemical potential, a thermodynamic parameter. Reverse osmosis is achieved by applying high pressure to seawater to counteract the osmotic flow. Saltwater is basically forced through a semi-permeable membrane, which removes all the dissolved solids and produces fresh, potable water on the other side. This method of membrane desalination rejects at least 98% of salts, contaminants and pollutants from seawater. The freshwater produced flows out of the reverse osmosis membrane where it is up to 99.2% free of salts, minerals and other irons. It then passes into the product flow meter where the amount of potable water is registered. The salinity probe then registers the salt content of the water. If the water quality is good, it passes through the 1-micron carbon block post-filer and micron ceramic post-filler (this purifies the water of unpleasant odors and taste). The desalination of seawater filtration process is then final complete by an optional ultraviolet sterilizer where 99.8% of all microorganisms, including vimses and bacteria are destroyed. Using reverse osmosis can remove many types of molecules and ions from solutions, including bacteria, parasites, viruses, molds, pathogens, inorganic compounds, organic material and macroscopic pollutants, and other contaminants that are used in the industrial processes and the production of potable water. The result is that the solute is retained on the pressurized side of the membrane and the pure solvent is allowed to pass to the other side. To be “selective,” this membrane should not allow large molecules or ions through the pores (holes), but should allow smaller components of the solution (such as the solvent) to pass freely. In the normal osmosis process, the solvent naturally moves from an area of low solute concentration (high water potential), through a membrane, to an area of high solute concentration (low water potential). The movement of a pure solvent is driven to reduce the free energy of the system by equalizing solute concentrations on each side of a membrane, generating osmotic pressure. Reverse osmosis is most commonly known for its use in drinking water disinfection, filtration and purification systems from seawater, removing the salt and other effluent materials from the water molecules.

Saline Water is water that contains a significant concentration of dissolved salts (mainly NaCl) and is commonly known as salt water. The salt concentration is usually expressed in parts per thousand (per mille, %) or parts per million (ppm). The Survey classifies saline water in three salinity categories. Salt concentration in slightly saline water is around 1,000 to 3,000 ppm (0.1-0.3%); in moderately saline water 3,000 to 10,000 ppm (0.3-1%) and in highly saline water 10,000 to 35,000 ppm (1-3.5%). Seawater has a salinity of roughly 35,000 ppm, equivalent to 35 grams of salt per one liter (or kilogram) of water. The saturation level is dependent on the temperature of the water. At 20° C. one milliliter of water can dissolve about 0.357 grams of salt; a concentration of 35.7%. At boiling (100° C.) the amount that can be dissolved in one milliliter of water increases to about 0.391 grams or 39.1% saline solution. Some industries make use of saline water, such as mining and therm-electric power.

Structured Water, much of the water in a healthy human body is in a liquid crystalline/strictured state. Many components of the body are also considered to be liquid crystals, including collagen and cell membranes. These tissues work cooperatively with structured water to create an informational network that reaches to every cell. The liquid crystalline organization of the human body accounts for the instantaneous transfer of signals and other biological information. Healthy DNA is surrounded by structured water. This water is responsible for the DNA's stability. Structured water is also responsible for supporting the electromagnetic fields surrounding DNA. As water loses its crystalline structure (because of age and disease), the integrity of the DNA is often compromised. Youthful DNA, surrounded by crystalline/stn uctured water, has a much stronger electromagnetic fields than DNA from older individuals. Water's crystalline structure is based on tetrahedral geometry where oxygen atoms form the center of each tetrahedron. Under ideal circumstances, as water tetrahedra join together, a repeating hexagonal pattern is generated with oxygen atoms forming the vertices of each hexagon. This is the reason liquid crystalline water has also been referred to as hexagonal water.

Regulated Drinking Water contaminant or other pollutants, The National Primary Drinking Water Regulations (NPDWRs or primary standards) are legally enforceable standards that apply to public water systems. Primary standards protect public health by limiting the levels of contaminants in drinking water. Visit the list below of regulated contaminants for details: Microorganisms, Disinfectants, disinfectant by-product (DBPs), chemicals, synthetic compounds, Organic Chemicals and Radionuclides.

Sacred Geometry and Cubits: Cubit: cubits are historical units of measurement and can include one or more of: 518.6, 523.5529.2 340. and/or 444 mm; or 13, 17.5, 20.42, 20.61, and/or 20.83 inches. Sacred geometry, refers to ratios of dimensions of objects or device components. such as but not limited to, the golden ratio, mean,. section, or proportion, as where two dimensions a and b are related where a/b=1+the square root of 5 divided by 2 as phi approximated as 1.6180339887 or −0.6180339887, where a/b+phi is selected from Additional and/or optional ratios can include those using proportions such as one or more of 1:1:2.3; 1:1,34; spirals using the ratio of m/(n-m), where m is the height and n is the width: a minimum polynominal as x2-x-1: or the absolute value of phi-1=0.6180339887 (as capital phi) as ratio of 1:1.618; a continued fraction for the golden ratio or the reciprical, e.g., 1/(1+(1+1/1+1/1+. , where the convergents of continued fractions (1/1, 2/1, 3/2, 5/3, 8/5, 13/8, . . . or 1/2, 2/3, 3/5, 5/8, 8/13) are ratios of successive Fibonacci numbers: phi=(1+2 sin 18 degrees) or (1/2 csc 18 decrees) or (2 cos 36 degrees) or (2 sin 54 degrees). The dimensions can optionally include where one or more dimensions or shapes include one or more golden spirals (e.g., but not limited to, a spiral made from quarter circles tangent to the interior of each square, where an initial square of sides of 1 unit is added by a square in the upper right quadrant with sides 1/phi units; followed by a square in the lower right quadrant with sides 1/phi squared: followed by adjacent square between first square and third square with sides 1/phi cubed: followed by adjacent fifth square between first, second, third and fourth square the fifth square with sides Ilphi to the fourth power. etc. where the spiral is formed between first and third corners of each successive square, and the like.

In the present subiect matter, dimensions of components of water purification systems., devices or methods can optionally comprise multiples or fractions of cubits and/or ratios using sacred geometry where dimensions a and b are related by the golden ratio, as presented above, or as known in the art.

Safe Drinking Water Act (SDWA) is the principal federal law in the United States intended to ensure safe drinking water for the public. Pursuant to the act, the Environmental (EPA) is required to set standards for drinking water quality and oversee all states, localities, and water suppliers that implement the standards. The SDWA applies to every ptiblic water system (PWS) in the United States. There are currently about 155,000 public water systems providing water to almost all Americans at some time in their lives. The Act does not cover private wells. The SDWA does not apply to bottled water. Bottled water is regulated by the Food and Drug Administration (FDA), under the Federal Food, Drug, and Cosmetic Act.

Soft Drink is a drink that typically contains carbonated water, a sweetener, and a natural or artificial flavoring. The sweetener may be sugar, high-fructose corn syrup, fruit juice, sugar substitutes (in the case of diet drinks), or some combination of these. Soft drinks may also contain caffeine, colorings, preservatives, and other ingredients.

Solfeggio Frequencies, the name “Solfeggio” and the note syllables Do, Re, etc.—comes from Solfège, a traditional way of naming the tones primarily of the C major scale or any major scale Kodaly Method-, especially in teaching singers. The healing powers attributed to “Solfeggio frequencies” or “Ancient Solfeggio” should not be confused with Solfege. The Frequencies. The Solfeggio frequencies include: 01=174 Hz; 02=285 Hz; Ut=396 Hz; Re=417 Hz; Mi=528 Hz; Fa=639 Hz, Sol=741 Hz; La=852 Hz; 09=963 Hz. The numerical values of the Solfeggio Frequencies are generated by starting with the vector 1, 7, 4 and adding the vector 1, 1, 1 MOD 9. Each higher frequency is found by adding 1, 1, 1 MOD 9 to the previous lower frequency. The final frequency, when 1, 1, 1 is added to is, returns the frequency to the lowest tone 1, 7, 4.Ut=396 Hz which reduces to 9 [reducing numbers: 3+9=12=1+2=3; 3+6=9]Re=417 Hz which reduces to 3Mi=528 Hz which reduces to 6Fa=6:39 Hz which reduces to 9Sol 741 Hz. which reduces to 3La=852 Hz which reduces to 6. The frequency assigned to Mi for “Miracles”, 528, is said by proponents of the idea to be the exact frequency used by genetic engineers throughout the world to repair DNA, The “Solfeggio frequencies” arc cyclic variation of the numbers 369, 147 and 258. It is claimed that each frequency has specific spiritual and physical healing properties. It is also claimed that they are part of a process that can assist you in creating the possibility of life without stress, illness, and sickness.

Types of Bottle Water. The FDA established standards that define the types of water. Artesian water: Water from a well tapping a confined aquifer (layers of porous rock, sand and earth containing water) where the water level stands above the top of the aquifer. Mineral water: Water containing more than 250 parts per million total dissolved solids originating from a protected underground water source. It must have constant levels and relative proportions of minerals and trace elements at the source. No minerals may be added to the water. Purified water: Produced by distillation, deionization, reverse osmosis or other process that meets the definition. Sparkling water: Water that contains that same amount of carbon dioxide that it had at emergence from the source after treatment and possible replacement of carbon dioxide. Spring water: Water that may be collected at the spring or through a borehole. Its any water that comes to the surface.

Types of Drinking Water Contaminants or Other Pollutants. The Safe Drinking Water Act defines the term “contaminant” as meaning any physical, chemical, biological, or radiological substance or matter in water. Therefore, the law defines “contaminant” very broadly as being anything other than water molecules. Drinking water may reasonably he expected to contain at least small amounts of some contaminants. Some drinking water contaminant or other pollutants may be harmful if consumed at certain levels in drinking water while others may be harmless. The presence of contaminants does not necessarily indicate that the water poses a health risk. Only a small minter of the universes of contaminants as defined above are listed on the Contaminant Candidate List (CCL). The CCL serves as the first level of evaluation for unregulated drinking water contaminant or other pollutants that may need further investigation of potential health effects and the levels at which they are found in drinking water. The following are general categories of drinking water contaminant or other pollutants and examples of each: Physical contaminants primarily impact the physical appearance or other physical properties of water. Examples of physical contaminants are sediment or organic material suspended in the water of lakes, rivers and streams from soil erosion. Chemical contaminants are elements or compounds. These contaminants may be naturally occurring or man-made. Examples of chemical contaminants include nitrogen, bleach, salts, pesticides, carbon monoxide, arsenic, toxins produced by bacteria, parasites, and human or animal drugs. Biological contaminants are organisms in water. They are also referred to as microbes or microbiological contaminants. Examples of biological or microbial contaminants include bacteria, parasites, viruses, molds, pathogens, inorganic compounds, organic material and macroscopic pollutants, protozoan, and parasites. Radiological contaminants are chemical elements with an unbalanced number of protons and neutrons resulting in unstable atoms that can emit ionizing radiation. Examples of radiological contaminants include cesium, plutonium and uranium.

Types of Water Pollution. Water pollution takes many forms. Although there are natural causes of water pollution, for instance that caused by volcanoes and other natural phenomenon, the pollution caused by man is of the greatest concern. Biological Water Pollution. Some viruses and bacteria are water born. These can cause serious diseases in people in direct contact with this contaminated water. This might include people drinking, swimming or washing in the contaminated water and extremely serious and contagious diseases such as cholera and typhoid are spread in this manner. Oxygen Depletion. Oxygen depletion destroys the natural balance of the water and ultimately bacteria thrive and fish and other wildlife die. Oxygen depletion is caused by the release of biodegradable matter into the water, such as sewage and the natural process of breaking this down uses the oxygen in the water. Once all the oxygen has been depleted, bacteria are able to take over making the water polluted. Nutrients. Nutrients such as phosphorus and nitrogen are essential to plant growth. Fertilizers contain many nutrients and when these enter the water supply, perhaps due to water running off a field into a river, the nutrients cause an imbalance in the make-up of the water. As nutrients are important to plant growth on land, the same applies to plants in the water. Therefore, too many nutrients in the water encourage the growth of weeds and algae. This can make the water highly polluted and result in oxygen depletion as mentioned above. The growth of algae is also known as a bloom, and the bright green spread of an algae bloom in fresh water is easily recognizable. Chemical. Chemical water pollution is perhaps the type of ⁻water pollution that we are most familiar with. This term is used to describe the act of adding unwanted chemicals to the water and is done through the accidental spillage of substances into water, waste from factories or industry and through pesticides running off fields into water. Chemicals in water are poisonous and harmful to wildlife as well as making the water too polluted to drink. The effects of chemical pollution are wide reaching. Chemical water pollution is also used to describe the pollution of water by oil, for instance when an oil tank ruptures or a ship sinks. The photographs and images we see on the television of oil covered birds and dying wildlife gives some indication of the serious nature of this and other types of pollution. Suspended Matter. Not all chemicals and pollutants are water soluble, and those that aren't are called suspended matter. The tiny particles of matter stay in the water and eventually fall to the bottom, forming a layer of silt on the floor of the lake or river. This is hamiful to wildlife and causes long term problems due to an Unbalance in the natural infrastructure of the water. In addition to the problems caused by the suspended matter, the problem caused by pollution due to suspended matter is compounded by dead fish and wildlife decomposing in the water.

Types of Fluoride Additives. Community water systems in the United States typically use one of three additives for water fluoridation. Decisions on which additive to use are based on cost of product, product-handling requirements, space availability, and equipment. The three additives are: Fluorosilicic acid: a water-based solution used by most water systems in the United States. Fluorosilicic acid is also referred to as hydro fluorosilicate, FSA, or HFS. Sodium fluorosilicate: a dry additive, dissolved into a solution before being added to water. Sodium fluoride: a dry additive, typically used in small water systems, dissolved into a solution before being added to water. Sources of Fluoride Additives. Most fluoride additives used in the United States are produced from phosphorite rock, Phosphorite is mainly used for manufacturing phosphate fertilizer. phosphorite contains calcium phosphate mixed with limestone (calcium carbonates) minerals and apatite a mineral with high phosphate and fluoride content, It is refluxed (heated) with sulfuric acid to produce a phosphoric acid-gypsum (calcium sulfate-CaSO4) slurry. The heating process releases hydrogen fluoride (HF) and silicon tetrafluoride (SiF4) gases, which are captured by vacuum evaporators. These gases are then condensed to a water-based solution of approximately 23% FSA. Approximately 95% of FSA used for water fluoridation comes from this process. The remaining 5% of FSA is produced in manufacturing hydrogen fluoride or from the use of hydrogen fluoride to etch silicates and glasses when manufacturing solar panels and electronics. Since the early 1950s, FSA has been the main additive used for water fluoridation in the United States. The favorable cost and high purity of FSA make it a popular additive. Sodium fluorosilicate and sodium fluoride are dry additives that come from FSA. FSA can he partially neutralized by either table salt (sodium chloride) or caustic soda to get sodium fluorosilicate. If enough caustic soda is added to completely neutralize the fluorosilicate, the result is sodium fluoride. About 90% of the sodium fluoride used in the United States comes from FSA. Sodium fluoride is also produced by mixing caustic soda with hydrogen fluoride. Ultrafiltration (UF) is a variety of membrane filtration in which forces like pressure or concentration gradients lead compound to a separation through a semipermeable. Suspended solids and solutes of high molecular weight are retained in the so-called retentate, while water and low molecular weight solutes pass through the membrane in the permeate. This separation process is used in industry and research for purifying and concentrating macromolecular (10³-10⁶ Da) solutions, especially protein solutions. Ultrafiltration is not fundamentally different from microfiltration. Both of these separate based on size exclusion or particle capture. It is fundamentally different from membrane gas separation, which separate based on different amounts of absorption and different rates of diffusion. Ultrafiltration membranes are defined by the molecular weight cut-off (MWCO) of the membrane used. Ultrafiltration is applied in cross-flow or dead-end mode.

Ultraviolet Light is electromagnetic radiation with a wavelength from 400 nm to 10 nm, shorter than that of visible light but longer than X-rays. Though usually invisible, under some conditions children and young adults can see ultraviolet down to wavelengths of about 310 nm, and people with aphakia (missing lens) can also see some UV wavelengths. Near-UV is visible to a number of insects and birds. UV radiation is present in sunlight, and is produced by electric arcs and specialized lights such as mercury-vapor lamps, tanning lamps, and black lights. Although lacking the energy to ionize atoms, long-wavelength ultraviolet radiation can cause chemical reactions, and causes many substances to glow or fluoresce. Consequently, biological effects of UV are greater than simple heating effects, and many practical applications of UV radiation derive from its interactions with organic molecules. UV light damages the DNA in bacteria, parasites, viruses, molds, pathogens, inorganic compounds, organic material and macroscopic pollutants, viruses, molds and some protozoa, leaving them unable to perform cellular functions and multiply. LTV is particularly highly effective against Cryptosporidrum and Giardia—organisms resistant to chlorine that are a major risk to hu an health, Another advantage of UV is the absence of color, taste and odor.

Vesica Piscis, is a shape that is the intersection of two or more copper or metal rings, electrodes or frequency generators with the same radius, intersecting in such a way that the center of each disk lies on the perimeter of the other. The name literally means the “bladder of a fish” in Latin. This vesica piscis in the first proposition of Euclid's Elements, where it forms the first step in constructing an equilateral triangle using a compass and straightedge. The triangle has as its vertices the two disk centers and one of the two sharp corners of the vesica piscis.

Visible Light Spectrum is the portion of the electromagnetic spectrum that is visible to (can be detected by) the eye. Electromagnetic in this range of wavelengths is called visible light or simply light. A typical human eye will respond to wavelengths front about 390 to 700 nm. In terms of frequency, this corresponds to a band in the vicinity of 430-790 THz. The spectrum does not, however, contain all the colors that the human eyes and brain can distinguish. Unsaturated colors such as pink, or purple variations such as magenta, are absent, for example, because only a mix of multiple wavelengths can make them. Colors containing only one wavelength are also called pure colors or spectral colors. Visible wavelengths pass through the “optical window,” the region of the electromagnetic spectrum that allows wavelengths to pass largely unattenuated through the Earth's atmosphere. The near infrared (NIR) window lies just out of the human vision, as well as the Medium Wavelength IR (MWIR) window and the Long Wavelength or Far Infrared (LWIR or FIR) window thought other animals may experience them.

Water (H2O) is a polar inorganic compound that is at room temperature a tasteless and odorless liquid, nearly colorless with a hint of blue. This simplest hydrogen chalcogenide is by far the most studied chemical compound and is described as the “universal solvent” for its ability to dissolve many substances. This allows it to be the “solvent of life”. It is the only common substance to exist as a solid, liquid, and gas in normal terrestrial conditions. Water is a liquid at the temperatures and pressures that are most adequate for life. Specifically, at a standard pressure of 1 atm (1.01325 bar, 101.325 kPa, 14.69595 psi), water is a liquid between the temperatures of 273.15 K (0° C., 32° F.) and 373.15 K (100° C., 212° F.). Increasing the pressure slightly lowers the melting point, which is about 5° C. at 600 atm, 22° C. at 2100 atm. This effect is relevant, for example, to ice skating, to the buried lakes of Antarctica, and to the movement of glaciers. (At pressures higher than 2100 atm the melting point rapidly increases again, and ice takes several exotic forms that do not exist at lower pressures.) Increasing the pressure has a more dramatic effect on the boiling point, that is about 374° C. at 220 atm. This effect is important in, among other things, deep-seahvdrothermal vents and geysers, pressure cooking, and steam engine design. At the top of Mount Everest, where the atmospheric pressure is about 0.34 atm, water boils at 68° C. (154° F.). At very low pressures (below about 0.006 atm), water cannot exist in the liquid state and passes directly from solid to gas by sublimation—a phenomenon exploited in the freeze drying of food. At very high pressures (above 221 atm), the liquid and gas states are no longer distinguishable, a state called supercritical steam. Water also differs from most liquids in that it becomes less dense as it freezes. The maximum density of water in its liquid form (at 1 atm) is 1,000 kg/m³ (62.43 lb/cu ft); that occurs at 3.98° C. (39.16° F.). The density of ice is 917 kg/m³ (57.25 lb/cu ft). Thus, water expands 9% in volume as it freezes, which accounts for the fact that ice floats on liquid water. The details of the exact chemical nature of liquid water are not well understood; some theories suggest that water's unusual behavior is as a result of it having 2 liquid states. Taste and odor. Pure water is usually described as tasteless and odorless, although humans have specific sensors that can feel the presence of water in their mouths, and frogs are known to be able to smell it. However, water from ordinary sources (including bottled mineral water) usually has many dissolved substances, that may give it varying tastes and odors. Humans and other animals have developed senses that enable them to evaluate the pot ability of water by avoiding water that is too salty or putrid. Color and Appearance. The apparent color of natural bodies of water (and swimming pools) is often determined more by dissolved and suspended solids, or by reflection of the sky, than by water itself. Light in the visible electromagnetic spectrum can traverse a couple meters of pure water (or ice) without significant absorption, so that it looks transparent and colorless. Thus aquatic plants, algae, and other photosynthetic organisms can live in water up to hundreds of meters deep, because sunlight can reach them. Water vapor is essentially invisible as a gas. Through a thickness of 10 meters or more, however, the intrinsic color of water (or ice) is visibly turquoise (greenish blue), as its absorption spectrum has a sharp minimum at the corresponding color of light (1/227 m⁻¹ at 418 nm). The color becomes increasingly stronger and darker with increasing thickness. (Practically no sunlight reaches the parts of the oceans below 1000 meters of depth.) Infrared and ultraviolet light, on the other hand, is strongly absorbed by water. The refraction index of liquid water (1.333 at 20° C.) is much higher than that of air (1.0), similar to those of alkanes and ethanol, but lower than those of glycerol (1.473), benzene (1.501), carbon disulfide (1.627), and common types of glass (1.4 to 1.6). The refraction index of ice (1.31) is lower than that of liquid water. Since the water molecule is not linear and the oxygen atom has a higher electronegativity than hydrogen atoms, it is a polar molecule, with an electrical dipole moment: the oxygen atom carries a slight negative charge, whereas the hydrogen atoms are slightly positive. Water is a good polar solvent, that dissolves many salts and hydrophilic organic molecules such as sugars and simple alcohols such as ethanol. Most acids dissolve in water to yield the corresponding anions. Many substances in living organisms, such as proteins, DNA and polysaccharides, are dissolved in water. Water also dissolves many gases, such as oxygen and carbon dioxidethe latter giving the fizz of carbonated beverages, sparkling wines and beers. On the other hand, many organic substances (such as fats and oils and alkanes) are hydrophobic, that is, insoluble in water. Many inorganic substances are insoluble too, including most metal oxides, sulfides, and silicates. Because of its polarity, a molecule of water in the liquid or solid state can form up to four hydrogen bonds with neighboring molecules. These bonds are the cause of water's high surface tension and capillary forces. The capillary action refers to the tendency of water to move up a narrow tube against the force of gravity. This property is relied upon by all vascular plants, such as trees. The hydrogen bonds are also the reason why the melting and boiling points of water are much higher than those of other analogous compounds like hydrogen sulfide (H2S). They also explain its exceptionally high specific heat capacity (about 4.2 J/g/K), heat of fusion (about 333 J/g), heat of vaporization (2257 J/g), and thermal conductivity (between 0.561 and 0.679 W/m/K). These properties make water more effective at moderating Earth's climate, by storing heat and transporting it between the oceans and the atmosphere. Electrical conductivity and electrolysis. Pure water has a low electrical conductivity, which increases with the dissolution of a small amount of ionic material such as common salt. Liquid water can be split into the elements hydrogen and oxygen by passing an electric current through it a process called electrolysis. The decomposition requires more energy input than the heat released by the inverse process (285.8 kJ/mol, or 15.9 MJ/kg). Mechanical properties. Liquid water can be assumed to be incompressible for most purposes: its compressibility ranges from 4.4 to 5.1×10⁻¹⁰ Pa^{31 1} in ordinary conditions. Even in oceans at 4 km depth, where the pressure is 400 atm, water suffers only a 1.8% decrease in volume. The viscosity of water is about 10⁻³ Pa·s or 0.01 poise at 20° C., and the speed of sound in liquid water ranges between 1400 and 1540 m/s depending on temperature. Sound travels long distances in water with little attenuation, especially at low frequencies (roughly 0.03 dB/km for 1 kHz), a property that is exploited by cetaceans and humans for communication and environment sensing (sonar). Reactivity. Elements which are more electropositive than hydrogen such as lithium, sodium, calcium, potassium and cesium displace hydrogen from water, forming hydroxides and releasing hydrogen.

Water Contaminants or Other Pollutants occurs when pollutants are released into the water before they are treated to remove any of their harmful compounds, Polluted water causes the destruction of plants and organisms living in or around the polluted body of water. Contaminated water also harms people, plants and creatures that consume it. Water pollution can be caused by pathogens, inorganic compounds, organic material and macroscopic pollutants. Water contaminant or other pollutants can include, without limitation, bacteria, parasites, pathogens, inorganic compounds, organic material and macroscopic pollutants and other chemicals, synthetic compounds, fluoride compounds, chlorine or by-products, lead compound, carbon monoxide, arsenic, nitrates, personal care products, caffeine, a nicotine chemical, toxic metal salts, hormones, pesticides and more. Pathogens. Bacteria are commonly found in water; it is when they start to increase in numbers that are above safe levels that water contamination occurs. Two of the most common pathogen pollutants are Coliform and E. coli bacteria. Conforms are normally present in the environment in safe levels and can actually be used to detect other pathogens in water. However. Water Filter Review reports that if conforms increase in numbers, it can be dangerous for the health of the environment. The presence of E. coli bacteria indicates that water has been contaminated with human or animal wastes. Inorganic Material. Inorganic materials such as heavy metalscarbon monoxide, arsenic, mercury, copper, chromium, zinc and barium, for examplethough harmless in small concentrations, act as pollutants when they end up in the water due to heavy industrialization or industrial accidents. This kind of water pollution can cause severe health problems and can even be fatal. Organic Materials. These materials contain molecules, which have carbon in their make-up. One of the most frequently detected volatile organic chemicals is Methyl Tertiary Butyl Ether (MTBE). MTBE was used as an air-cleaning gas additive, and was once added to gasoline. Although it is now a banned chemical, it will take years before MBTE is thoroughly removed from contaminated water systems. Water contaminated with this organic chemical can cause leukemia, lymphoma and tumors in testicles, the thyroid glands and kidneys. Macroscopic Pollution. Macroscopic pollution is when large, visible items pollute the water. The first common pollutant is trash-paper, plastic or food waste. It is either thrown directly into the water or washed away by the rain into a body of water. Other types of macroscopic pollution include nurdles (small waterborne plastic pellets); pieces of wood: metals; and even obvious things like shipwrecks. This form of pollution is the most manageable; however, these pollutants must be removed in order to avoid loss of life in aquatic animals and contamination upon the chemical breakdown of these objects.

Water Purification is the process of removing undesirable chemicals, biological contaminants, suspended solids and gases from water. The goal is to produce water fit for a specific purpose. Most water is disinfected for human consumption (drinking water), but water purification may also be designed for a variety of other purposes, including fulfilling the requirements of medical, phamiacological, chemical and industrial applications. The methods used include physical processes such as filtration, sedimentation, and distillation; biological processes such as slow sand filters or biologically active carbon; chemical processes such as flocculation and chlorination and the use of electromagnetic radiation such as ultraviolet. Purifying water may reduce the concentration of particulate matter including suspended particles, parasites, bacteria, parasites, algae, viruses, fungi, as well as reducing the amount of a range of dissolved and particulate material derived from the surfaces that come from runoff due to rain. The standards for drinking water quality are typically set by governments or by international standards. These standards usually include minimum and maximum concentrations of contaminants, depending on the intended purpose of water use. Visual inspection cannot determine if water is of appropriate quality. Simple procedures such as boiling or the use of a household activated carbon filter are not sufficient for treating all the possible contaminants that may be present in water from an unknown source. Even natural spring water considered safe for all practical purposes in the 19th century—must now be tested before determining what kind, of treatment, if any, is needed. Chemical and microbiological, while expensive, are the only way to obtain the information necessary for deciding on the appropriate method of purification, According to a 2007 World Health Organization (WHO) report, 1.1 billion people lack access to an improved drinking water supply, 88% of the 4 billion annual cases of diarrheal disease are attributed to unsafe water and inadequate sanitation and hygiene, while 1.8 million people die from diarrheal diseases each year. The WHO estimates that 94% of these diarrheal cases are preventable through modifications to the environment, including access to safe water. Simple techniques for treating water at home, such as chlorination, filters, and solar disinfection, and storing it in safe containers could save a huge number of lives each year. Reducing deaths from waterborne is a major public health goal in developing countries. Pretreatment. Pumping and containment The majority of water must be pumped from its source or directed into pipes or holding tanks. To avoid adding contaminants to the water, this physical infrastructure must be made from appropriate materials and constructed so that accidental contamination does not occur. Screening (see also screen filter)—The first step in purifying surface water is to remove large debris such as sticks, leaves, rubbish and other large particles which may interfere with subsequent purification steps. Most deep groundwater does not need screening before other purification steps. Storage-Water from rivers may also be stored in bankside reservoirs for periods between a few days and many months to allow natural biological purification to take place. This is especially important if treatment is by slow sand filters. Storage reservoirs also provide a buffer against short periods of drought or to allow water supply to be maintained during transitory pollution incidents in the source river. Pre-chlorination—In many plants the incoming water was chlorinated to minimize the growth of fouling organisms on the pipe-work and tanks Because of the potential adverse quality effects (see chlorine below), this has largely been discontinued. pH adjustment. Pure water has a pH close to 7 ((neither alkaline nor acidic). Sea water can have pH values that range from 7.5 to 8.4 (moderately alkaline). Fresh water can have widely ranging pH values depending on the geology of the drainage or aquifer and the influence of contaminant inputs (acid rain). If the water is acidic (lower than 7), lime, soda ash, or sodium hydroxide can be added to raise the pH during water purification processes. Lime addition increases the calcium ion concentration, thus raising the water hardness. For highly acidic waters, forced draft degasifiers can be an effective way to raise the pH, by stripping dissolved carbon dioxide from the water. Making the water alkaline helps coagulation and flocculation processes work effectively and also helps to minimize the risk of lead compound being dissolved from lead compound pipes and from lead compound solder in pipe fittings. Sufficient alkalinity also reduces the corrosiveness of water to iron pipes. Acid (carbonic acid, hydrochloric acid or sulfuric acid) may be added to alkaline waters in some circumstances to lower the pH Alkaline water (above pH 7.0) does not necessarily mean that lead compound or copper from the plumbing system will not be dissolved into the water. The ability of water to precipitate calcium carbonate to protect metal surfaces and reduce the likelihood of toxic metals being dissolved in water is a function of pH, mineral content, temperature, alkalinity and calcium concentration. Coagulation and flocculation. One of the first steps in a conventional water purification process is the addition of chemicals to assist in the removal of particles suspended in water. Particles can be inorganic such as clay and silt or organic such as algae, bacteria, parasites, viruses, protozoa and natural organic matter. Inorganic and organic particles contribute to the turbidity and color of water. The addition of inorganic coagulants such as aluminum sulfate (or alum) or iron (III) salts such as chloride cause several simultaneous chemical and physical interactions on and among the particles. Within seconds, negative charges on the particles are neutralized by inorganic coagulants. Also within seconds, metal hydroxide precipitates of the iron and aluminum ions begin to form. These precipitates combine into larger particles under natural processes such as Brownian motion and through induced mixing which is sometimes referred to as flocculation. The term most often used for the amorphous metal hydroxides is “floc.” Large, amorphous aluminum and iron (III) hydroxides adsorb and enmesh particles in suspension and facilitate the removal of particles by subsequent processes of sedimentation and filtration. Aluminum hydroxides are formed within a fairly narrow pH range, typically: 5,5 to about 7.7. Iron (III) hydroxides can form over a larger pH range including pH levels lower than are effective for alum, typically: 5.0 to 8.5. In the literature, there is much debate and confusion over the usage of the terms coagulation and flocculationwhere does coagulation end and flocculation begin? In water purification plants, there is usually a high energy, rapid mix unit process (detention time in seconds) where the coagulant chemicals are added followed by flocculation basins (detention times range from 15 to 45 minutes) where low energy inputs turn large paddles or other gentle mixing devices to enhance the formation of floc. In fact, coagulation and flocculation processes are ongoing once the metal salt coagulants are added. Organic polymers were developed in the 1960s as aids to coagulants and, in some cases, as replacements for the inorganic metal salt coagulants. Synthetic organic polymers are high molecular weight compounds that early negative, positive or neutral charges. When organic polymers are added to water with particulates, the high molecular weight compounds adsorb onto particle surfaces and through interparticle bridging coalesce with other particles to form floc. PolyDADMAC is a popular cationic (positively charged) organic polymer used in water purification plants. Sedimentation. Waters exiting the flocculation basin may enter the sedimentation basin, also called a clarifier or settling basin. It is a large tank with low water velocities, allowing floc to settle to the bottom. The sedimentation basin is best located close to the flocculation basin so the transit between the two processes does not permit settlement or floc break up. Sedimentation basins may be rectangular, where water flows from end to end, or circular where flow is from the center outward. Sedimentation basin outflow is typically over a weir so only a thin top layer of water that furthest from the sludge exits. In 1904, Allen Hazen showed that the efficiency of a sedimentation process was a function of the particle settling velocity, the flow through the tank and the surface area of tank. Sedimentation tanks are typically designed within a range of overflow rates of 0.5 to 1.0 gallons per minute per square foot (or 1.25 to 2.5 meters per hour). In general, sedimentation basin efficiency is not a function of detention time or depth of the basin. Although, basin depth must be sufficient so that water currents do not disturb the sludge and settled particle interactions are promoted. As particle concentrations in the settled water increase near the sludge surface on the bottom of the tank, settling velocities can increase due to collisions and agglomeration of particles. Typical detention times for sedimentation vary from 1.5 to 4 hours and basin depths vary from 10 to 15 feet (3 to 4.5 meters). Inclined flat plates or tubes call be added to traditional sedimentation basins to improve particle removal performance. Inclined plates and tubes drastically increase the surface area available for particles to be removed in conceit with Hazen's original theory. The amount of ground surface area occupied by a sedimentation basin with inclined plates or tubes can be far smaller than a conventional sedimentation basin. Sludge storage and removal. As particles settle to the bottom of a sedimentation basin, a layer of sludge is formed on the floor of the tank which must be removed and treated. The amount of sludge generated is significant, often 3 to 5% of the total volume of water to be treated. The cost of treating and disposing of the sludge can impact the operating cost of a water treatment plant. The sedimentation basin may be equipped with mechanical cleaning devices that continually clean its bottom, or the basin can be periodically taken out of service and cleaned manually.

Water Quality refers to the chemical, physical, biological, and radiological characteristics of water. It is a measure of the condition of water relative to the requirements of one or more biotic species and or to any human need or purpose. It is most frequently used by reference to a set of standards against which compliance can be assessed. The most common standards used to assess water quality relate to health of ecosystems, safety of human contact and drinking water.

Wastewater is any water that has been adversely affected in quality by anthropogenic influence. Wastewater can originate from a combination of domestic, industrial, commercial or agricultural activities, surface ninoff or storm water, and from sewer inflow or infiltration. Municipal wastewater (also called sewage) is usually conveyed in a combined sewer or sanitary sewer, and treated at a wastewater plant. Treated wastewater is discharged into receiving water via an effluent pipe. Wastewaters generated in areas without access to centralized sewer systems rely on on-site wastewater systems. These typically comprise a septic tank, drain field, and optionally an on-site treatment unit. The management of wastewater belongs to the overarching term sanitation, just like the management of human excreta, solid waste and storm water (drainage). Sewage is a type of wastewater that comprises domestic wastewater and is therefore contaminated with feces or urine from people's toilets, but the term sewage is also used to mean any type of wastewater. Sewerage is the physical infrastructure, including pipes, pumps, screens, channels etc. used to convey sewage from its origin to the point of eventual treatment or disposal.

Water disinfection, filtration and purification systems is the process of removing undesirable chemicals, synthetic compounds, biological contaminants, suspended solids and gases from contaminated water. The goal is to produce water fit for a specific purpose. Most water is disinfected for human consumption (drinking water), but water disinfection, filtration and purification systems may also be designed for a variety of other purposes, including fulfilling the requirements of medical, pharmacological, chemical and industrial applications. The methods used include physical processes such as filtration, sedimentation, and distillation, biological processes such as slow sand filters or biologically active carbon; chemical processes such as flocculation and chlorination and the use of electromagnetic radiation such as ultraviolet light. Purifying water may reduce the concentration of particulate matter including suspended particles, bacteria, parasites, algae, viruses, fungi, algae, as well as reducing the amount of a range of dissolved and particulate material derived from the surfaces that come from runoff due to rain. The standards for drinking water quality are typically set by governments or by international standards. These standards usually include minimum and maximum concentrations of contaminants, depending on the intended purpose of water use. Visual inspection cannot determine if water is of appropriate quality. Simple procedures such as boiling or the use of a household activated carbon filter are not sufficient for treating all the possible contaminants that may be present in water from an unknown source. Even natural spring water --- considered safe for all practical purposes in the 19th century must now be tested before determining what kind of treatment, if any, is needed. Chemical and microbiological analysis, while expensive are the only way to obtain the information necessary for deciding on the appropriate method of purification systems.

Ultraviolet Germicidal Irradiation (UVGI) is a disinfection method that uses short-wavelength ultraviolet (UV-C) light to kill or inactivate microorganisms by destroying nucleic acids and disrupting their DNA, leaving them unable to perform vital cellular functions. UVGI is used in a variety of applications, such as food, air, and water disinfection, filtration and purification systems. UV-C light is weak at the Earth's surface as the ozone layer of the atmosphere blocks it. UVGI devices can produce strong enough UV-C light in circulating air or water systems to make them inhospitable environments to microorganisms such as bacteria, parasites, viruses, molds and other pathogens. UVGI can he coupled with a filtration system to sanitize air and water.

Water Treatment is, collectively, the industrial-scale process that makes water more acceptable for an end-use that can be drinking, industry, or medicine. Water treatment is unlike portable water disinfection, filtration and purification systems that campers and other people in wilderness areas practice. Water treatment should remove existing water contaminant or other pollutant or so reduce their concentration that their water becomes fit for its desired end-use that can be safely returning used water to the enviromnent. The term “water treatment” generally refers to potable water production from raw water, whereas “wastewater” refers to the treatment of polluted water, where the pollution could be from human waste, industry, agricultural waste or other sources of pollution. The processes involved in treating water for drinking purposes to provide a safe source of water supply may be solids separation using physical processes such as settling and filtration, and chemical processes such as disinfection and coagulation, Water disinfection, filtration and purification systems is the removal of contaminants from untreated water to produce drinking water that is pure enough for the most critical of its intended uses. usually for human consumption. Substances that are removed during the process of drinking water treatment include suspended solids, bacteria, parasites, algae, viruses, fiErigi, algae, minerals such as iron, manganese and sulfur, and other chemical pollutants such as fertilizers. Measures taken to ensure water quality not only relate to the treatment of the water, but to its conveyance and distribution after treatment as well. It is therelbre common practice to have residual disinfectants in the treated water in order to kill any bacteriological contamination during distribution. World Health Organization (WHO) guidelines are generally followed throughout the world for drinking water quality requirements. In addition to the WHO guidelines, each country or territory or water supply body can have their own guidelines in order for consumers to have access to safe drinking water.

Uses of Water. Plants and animals (including people) are mostly water inside, and must drink water to live. It gives a medium for chemical to take place, and is the main part of blood. It keeps the body temperature the same by sweating from the skin. Water helps blood carry nutrients from the stomach to all parts of the body to keep the body alive. Water also helps the blood carry oxygen from the lungs to the body. Saliva, which helps animals and people digest food, is mostly water. Water helps make urine. Urine helps remove bad chemicals from the body. The human body is between 60% and 70% water. Water is the main component of drinks like milk, juice, and wine. Each type of drink also has other things that add flavor or nutrients, things like sugar, fruit, and sometimes alcohol. Water that a person can drink is called “potable water” (or “drinking water”). The water in oceans is salt water, but lakes and rivers usually have unsalted water. Only about 3% of all the water on earth is fresh water, The rest is salt water. Many places, including cities and deserts, don't have as much water as people want. They build aqueducts to bring water there, Though people can survive a few months without food, they can only survive for a day or two without water. A few desert animals can get enough water from their food, but the others must drink.

Waterborne Diseases are caused by pathogenic microorganisms that most commonly are transmitted in contaminated fresh water. Infection commonly results during bathing, washing, drinking, in the preparation of !food, or the consumption of food thus infected, Various forms of waterborne diarrheal disease probably are the most prominent examples, and affect mainly children in developing countries: according to the World Health Organization, such diseases account for an estimated 4.11% of the total DALY global burden of disease, and cause about 1.8 million human deaths annually. The World Health. Organization estimates that 88% of that burden is attributable to unsafe water supply, sanitation and hygiene.

Pharmaceuticals or by-products in thinking water can be found in prescription medicines, over-the-counter therapeutic drugs and veterinary drugs. Pharmaceuticals contain active ingredients that have been designed to have pharmacological effects and confer significant benefits to society. Pharmaceutical ingredients can be introduced into water sources through sewage or human waste, which carries the excreta of individuals and patients who have used these chemicals, synthetic compounds, from uncontrolled drug disposal (e.g, discarding drugs into toilets) and from agricultural runoff comprising livestock manure. They have become chemicals of emerging concern to the public because of their potential to reach drinking water.

Occurrence of pharmaceuticals or by-products in drinking-water. The ubiquitous use of pharmaceuticals (both prescribed and over the counter) has resulted in a relatively continuous discharge of pharmaceuticals and their metabolites into wastewater. In addition, pharmaceuticals or by-products may be released into water sources in the effluents from poorly controlled manufacturing or production facilities, primarily those associated with generic medicines. Following advances in the sensitivity of analytical methods for the measurement of these chemicals at very low concentrations, a number of studies found trace concentrations of pharmaceuticals or by-products in wastewater, various water sources and some drinking waters. Concentrations in surface waters, groundwater and partially treated water were typically less than 0.1 μg/l (or 100 ng/l), whereas concentrations in treated water were generally below 0.05 μg/l (or 50 ng/l). These investigations suggested that pharmaceuticals are present, albeit at trace concentrations, in many water sources receiving wastewater effluents. The presence of specific pharmaceuticals or by-products in a water source will vaty from place to place depending upon the type of pharmaceutical and the extent of discharge into water bodies. Key factors include the pharmaceuticals prescribed, used or manufactured in the area and the size of the population in the catchment. The occurrence and concentration of pharmaceuticals or by-products in receiving water sources, which are the primary pathway into thinking water are dependent on dilution, natural attenuation and the degree of wastewater applied.

Bottled water contains disinfectant by-product (DBPs), fertilizer residue, and pain medication. The bottled water industry promotes an image of purity, but comprehensive testing by the, Environmental Working Group (EWG) reveals a surprising array of chemical contaminants in every bottled water brand analyzed, including toxic by-products of chlorination in Wal-Mart's Sam's Choice and Giant Supermarkets Acadia brands, at levels no different than routinely found in tap water. Several Sam's Choice samples purchased in California exceeded legal limits for bottled water contaminant or other pollutants in that state. Cancer-causing contaminants in bottled water purchased :in 5 states (e.g., North Carolina, California, Virginia, Delaware and Maryland) and the District of Columbia substantially exceeded the voluntary standards established by the bottled water industry. Unlike tap water, where consumers are provided with test results every year, the bottled water industry is not required to disclose the results of any contaminant testing that it conducts. Instead, the industry hides behind the claim that bottled water is held to the same safety standards as tap water, But with promotional campaigns saturated with images of mountain springs, and prices 1,900 times the price of tap water, consumers are clearly led to believe that they are buying a product that has been purified to a level beyond the water that comes out of the garden hose. To the contrary, our tests strongly indicate that the purity of bottled water cannot be trusted. Given the industry's refusal to make available data to support their claims of superiority, consumer confidence in the purity of bottled water is simply not, ustified. Laboratory tests conducted for ONG at one of the country's lead compounding water quality laboratories found that 10 popular brands of bottled water, purchased from grocery stores and other retailers in 9 states and the District of Columbia, contained 38 chemical pollutants altogether, with an average of 8 contaminants in each brand. More than one-third of the chemicals found are not regulated in bottled water. in the Sam's Choice and Acadia brands levels of some chemicals exceeded legal limits in California as well as industry-sponsored voluntary safety standards. Four brands were also contaminated with bacteria.

Pharmaceuticals or other by-products in drinking water, A vast array of pharmaceutical compounds including antibiotics, anti-convulsants, mood stabilizers and sex hormones have been found in the drinking water supplies of at least 41 million Americans, an Associated Press investigation shows. To he sure, the concentrations of these pharmaceuticals are tiny, measured in quantities of parts per billion or trillion, far below the levels of a medical dose. Also, utilities insist their water is safe. But the presence of so many prescription drugs and over-the-counter medicines like acetaminophen and ibuprofen in so much of our drinking water is heightening worries among scientists of long-term consequences to human health, in the course of a five-month inquiry, the AP discovered that drugs have been detected in the drinking water supplies of 24 major metropolitan areas from Southern California to Northern New Jersey, from Detroit to Louisville, Ky. Water providers rarely disclose results of pharmaceutical screenings, unless pressed, the AP found. For example, the head of a group representing major California suppliers said the phblic “doesn't know how to interpret the information” and might he unduly alarmed. How do the drugs get into the water? People take pills. Their bodies absoth some of the medication, but the rest of it passes through and is flushed down the toilet. The wastewater is treated before it is discharged into reservoirs, rivers or lakes. Then, some of the water is cleansed again at drinking water treatment plants and piped to consumers. But most treatments do not remove all drug residue. And while researchers do not yet understand the exact risks from decades of persistent exposure to random combinations of low levels of pharmaceuticals, recent studies which have gone virtually unnoticed by the general public have found alarming effects on human cells and wildlife, Non-limiting examples of pharmaceutical and by-products that are found in the drinking water supply include:

ANTIBIOTICS, Amoxicillin_for pneumonia, stomach ulcers; Azithromycin_for pneumonia, sexually transmitted diseases; Bacitracin_prevents infection in cuts and burns; Chloramphenicol_for serious infections when other antibiotics cant be used; Ciprofloxacin_for anthrax, other infections; Doxycycline_for pneumonia, Lyme disease, acne; Erythromycin_for pneumonia, whooping cough, Legionnaires' disease, Lincomycin_for strep, staph, other serious infections; Oxytetracycline for respiratory, urinary infections; Penicillin G_for anthrax, other infections; Penicillin V_for pneumonia, scarlet fever, infections of ear, skin, throat; Roxithromycin_for respiratory, skin infections; Sulfadiazine_for urinary infections, burns; Sulfamethizole_for urinary infections; Sulfamethoxazole_for traveler's diarrhea, pneumonia, urinary and ear infections; Tetracycline for pneumonia, acne, stomach ulcers, Lyme disease; Trimethoprim for urinary and car infections, traveler's diarrhea, pneumonia.

PAIN RELIEVERS. Acetaminophen_soothes arthritis, aches, colds; reduces fever; Antipyrine_for ear infections; Aspirin_for minor aches, pain; lowers risk of heart attack and stroke; Diclofenac_for arthritis, menstrual cramps, other pain; ibuprofen_for arthritis, aches, menstrual cramps, reduces fever; Naproxen for arthritis, bursitis, tendinitis, aches; reduces fever; Prednisone_for arthritis, allergic reactions, multiple sclerosis, some cancers. HEART DRUGS Atenolol_for high blood pressure; Bezafibrate for cholesterol problems, Clofibric acid_by-product of various cholesterol medications; Diltiazem_for high blood pressure, chest pain; Gemfibrozil_regulates cholesterol, Simvastatin_slows production of cholesterol. MIND DRUGS. Carbamazepine_for seizures, mood regulating; Diazepam_for anxiety, seizures; eases alcohol withdrawal; Fluoxetine_for depression, relieves premenstrual mood swings; Meprobamate_for anxiety; Phenytoin_controls epileptic seizures; Risperidone_for schizophrenia, bipolar disorder, severe behavior problems. OTHER PHARMACEUTICAL OR DRUGS. Caffeine_found in coffee; also used in pain relievers; Cotinine_by-product of nicotine; drug in tobacco, also used in products to help smokers quit; Iopromide_given as contrast agent for medical imaging; Nicotine_found in tobacco, also in medicinal products to help smokers quit; Paraxanthine_a by-product of caffeine; Theophylline_for asthma, bronchitis and emphysema. VETERINARY. Carbadox_for control of dysentery, bacterial enteritis in pigs; promotes growth, Chlortetracycline_for eye, joint, other animal ailments; Enrofloxacin_for infections in farm animals and pets; treats wounds; Monensin_for weight gain, prevention of severe diarrhea in farm animals; Narasin_for severe diarrhea in faim animals; Oleandomycin_for respiratory disease; promotes growth m farm animals; Salinomycin_promotes growth in livestock; Suffachloropyridazine for enteritis in farm animals; Sulfadimethoxine for severe diarrhea, fowl cholera, other conditions in farm animals; Sulfamerazine_for a range of infections in cats, fowl; Sulfamethazine_for bacterial diseases in farm animals; promotes growth; Sulfathiazole_for diseases in aquarium fish: Tylosin_promotes growth, treats infections in farm animals, including bees; Virginiamycin MI_prevents infection, promotes growth in farm animals.

What elfeds can contaminated water have on your health? Each contaminant is caused by a different source. Pesticides may be in your water because of agricultural run-off E. coli and other bacteria found in fecal matter may seep into your well if a neighbor's sewage tank is leaking. Just as each contaminant may have a different source, each one can have different health effects. Chlorine or by-products, a common disinfectant, can cause skin rashes. Low levels of arsenic can cause stomach problems and vomiting, but high levels have been known to cause cancer. Nitrates are known to inhibit cellular oxygen levels and can even be fatal for infants.

Risk assessment of pharmaceuticals or other by-products in drinking-water. There are currently few systematic monitoring programs or comprehensive studies available on human exposure to pharmaceuticals or by-products in drinking water. Therefore, a key challenge in assessing the potential human health risk associated with exposure to very low concentrations of pharmaceuticals or by-products in drinking-water is the limited occurrence data available for the diverse group of pharmaceuticals or by-products in use today and their active metabolites. However, several approaches for screening and prioritizing pharmaceuticals for human health risk assessment for exposure through drinking water have been published in the peer-reviewed literature. These approaches usually apply the principle of the “minimum therapeutic dose” (also known as the “lowest clinically effective dose”) or the acceptable daily intake, in conjunction with safety factors or uncertainty factors for different groups of pharmaceuticals, to derive a margin of safety, or margin of exposure, between the worst-case exposure observed or predicted and the minimum therapeutic dose or acceptable daily intake. Current observations suggest that it is very unlikely that exposure to very low levels of pharmaceuticals or by-products in drinking-water would result in appreciable adverse risks to human health, as concentrations of pharmaceuticals detected in drinking-water (twit) are several orders of magnitude (typically more, and often much more, than 1000-fold) lower than the minimum therapeutic dose.

Plastic Toxic Chemical Components. Drinking water from certain types of plastic water bottle can cause health risks due to toxic plastic components leaking into the water they are containing, whereas other materials such as glass and stainless steel do not leak toxic components into the water. BPA Bisphenol A or BPA is an estrogen-mimicking chemical that has been linked to a host of serious health problems including: Learning and behavioral problems; Altered immune system function; Early puberty in girls and fertility problems; Decreased sperm count; Prostate and breast cancer; Diabetes and obesity. If you. are pregnant or nursing, your child is also at risk. If you are feeding your baby or toddler from a plastic bottle, switch to glass to avoid BPA contamination. Phthalates—Phthalates are widely used in the United States to make plastics like polyvinyl chloride (PVC) more flexible. Phthalates are endocrine-disrupting chemicals that have been linked to a wide range of developmental and reproductive effects, including: Reduced sperm counts; Testicular atrophy or structural abnormality; Liver cancer. Further, in experiments on rats, phthalates have demonstrably blocked the action of fetal androgens, which affects gender development in male offspring, lead compounding to undescended testes at birth and testicular tumors later in life. Studies have also found that boys whose mothers had high phthalate exposures while pregnant were much more likely to have certain demasculinized traits and produce less testosterone. Yet another study found that pregnant women who are exposed to phthalates gave birth more than one week earlier than women who were not exposed to them. Pharmacy in a Bottle—As mentioned above, about 40% of bottled water is tap water. This means you are not only exposed to dangerous BPA from the bottle, you may also be exposed to a variety of water contaminant or other pollutants such as fluoride, chlorine or by-products, carbon monoxide, arsenic, aluminum, products, a prescription drug. Although you may have been told that disposing your unused prescription or over-the-counter (OTC) drugs in the garbage instead of down the toilet means this eliminates the threat of your water supply being contaminated, this is simply not true. Water that drains through landfills, known as leach rate, eventually ends up in rivers. Although not all states source drinking water from rivers, many do. According to studies, human cells do not grow normally when exposed to even minute amounts of prescription or over-the-counter drugs. Some drugs that were never meant to be combined are mixed together in the drinking water you, consume every day. Millions of people have drug allergies. Are you one of them? If so, how do you know the unusual symptoms you've been exhibiting are not due to ingesting small doses of the drugs you're allergic to from your bottled water?

Chemicals in Plastic Water Bottles. Though drinking bottled water directly from a store shelf poses serious health risks, leaving this bottled water in your car or strapped to your bike and exposed to the hot sun will cause even more serious chemical exposure. Ultraviolet rays from the sun or high temperatures will accelerate leaching of the plastic chemicals mentioned above into the water. Adding to this health threat is a toxic substance called dioxin, which is also released into bottled water when it is left in the sun. Dioxin has been strongly linked to the development of breast cancer. Health-conscious people like to transport filtered water from home to ensure a safe supply on the go. If you're one of these individuals, using a glass or steel bottle instead will bypass the risks associated with carrying filtered water in plastic.

Materials dissolved in water: Inorganic Compounds. Compounds that typically do not contain the element Carbon. They can become dissolved in water from natural sources or as the result of human activity. Dissolved gases (oxygen, carbon dioxide, nitrogen, radon, methane, hydrogen sulfide, etc.)—no appreciable health effects, except for hydrogen sulfide and dissolved radioactive gases like radon. Both methane and hydrogen sulfide can be inflammable. Carbon dioxide dissolved in water creates carbonic acid—a weak acid that gives carbonated water its “bite” and plays an important role in the weathering of limestone and other carbonate rocks. Caverns are a product of eons of erosion by carbonic acid laced water. Metal and metalloid positive ions—(aluminum, arsenic {MCL=0.05}, lead compound {MCL=0.015}, mercury {MCL=0.002}, calcium, magnesium, sodium, potassium, zinc, copper {MCL=1.3}, etc.) Some of these ions (lead compound, mercury, and arsenic) are dangerous at extremely low concentrations and can be introduced into drinking water either though natural processes or as a result of human activity. Other ions in this group (for example, calcium, magnesium, sodium, and potassium) are essential to human health - in the correct amounts. Calcium and magnesium are interesting ions. Although their presence in drinking water is actually a health benefit, they are the prime, culprits in most hard water, and are considered undesirable contaminants by those who must live with scaly deposits of calcium carbonate on their faucets (and in their pipes and water heaters) or who cannot get their soap to lather. Negative ions—(fluoride {MCL=4.0}, chloride, nitrate {MCL=10.0}, nitrite {MCL=1.0}, phosphate, sulfate, carbonate, cyanide {MCL=0.2}) As with the positive ions, some of these negative ions are necessary to life in proper concentrations (chloride and carbonate), others can be dangerous to health at moderate concentrations (nitrates and nitrites—look at the ingredients in the next slice of ham, bacon, or hot dog you eat), and others are dangerous at even small concentrations (cyanide).Some, like fluoride, have raised quite a controversy over its safety as an additive (in many areas) to drinking water in an effort to lessen tooth decay, particularly in children. Radon - Radon is a radioactive gas that comes from the natural breakdown (radioactive decay) of radium, which is it a decay product of uranium. The primmuy source of radon in homes is from the underlying soil and bedrock. However, an additional source could be the water supply, particularly if the house is served by a private well or a small conmumity water system. Organic Compounds—These compounds all contain the element Carbon. Although there are many exceptions, naturally occurring organic compounds (sugars, proteins, alcohol's, etc.) are synthesized in the cells of living organisms, or like raw refining petroleum and coal, formed by natural processes acting on the organic chemicals of once living organisms. Synthetic Organic Chemicals—Organic chemicals can also be synthesized in laboratories and by chemical companies. A growing number of these synthetic organic compounds are being produced. They can include pesticides used in agriculture, plastics, synthetic fabrics, dyes, gasoline additives like MTBE, solvents like carbon tetrachloride {MCL=0.005}, and many other chemicals. Many synthetic organic chemicals, synthetic compounds, like benzene {MCL=0.0051} carbon tetrachloride, and vinyl chloride {MCL=0.0021}, vaporize easily in air and are grouped under the category of volatile organic chemicals (VOCs). Methyl tertiary butyl ether (MTBE) is a common synthetic organic chemical used for a number of years as a gasoline additive, In January 2000 it received national notoriety on CBS' 60 Minutes because of its ability to contaminate water supplies after leaking from storage tanks. The potential for water contamination by synthetic organic chemicals can be understood by the fact that Denver Water (the company that supplies municipal water to much of the metro Denver area) tests for 54 VOCs (21 with MCLs established by the EPA), 73 different pesticides (23 with IVICLs), 25 different chemicals classified as synthetic organic compounds (5 with MCLs), and 7 as non-specific organics. Nearly all of these chemicals tested below the levels of detectability. It somewhat disconcerting to realize that Denver water tests for only 150 or so of the thousands of the synthetic organic chemicals manufactured, and the EPA has established MCLs for even fewer. Vitamin Waters are marketed as health drinks but often contain health-harming additives such as high fructose corn syrup, which is a cause of obesity and diabetes, and.

Fluoride in tap water, and bottled water that originates from tap water as added fluoride, which concentrations have been significantly increased during the last 15-25 years, e.g., from 0.1 to 0.3 ppm to 3-10 ppm. A recent study done on children in India showed fluoride in the higher concentrations actually is a toxin that lead compounds to an increased risk of cavities, and also has been found to cause a wide range of health problems, including weakened immune system function, and increasing cellular damage. The Center for Disease Control (CDC) and the Department of Health and Human Services (DHHS) have recently recommended that the amount of fluoride in drinking water be reduced to 0.7 milligrams per liter of water. The EPA is also initiating a review of the maximum amount of fluoride allowed.

Frequencies RFID frequency bands

| Band | Regulations | Range | | Data speed | Remarks |
|---|---|---|---|---|---|
| 120-150 kHz (LF) | Unregulated | 10 | cm | Low | Animal identification |
| | | | | | data collection |
| 13.56 MHz (HF) | ISM band worldwide | 10 cm-1 m | | Low to moderate | Smart cards |
| (MIFARE, ISO/IEC 14443) | | | | | |
| 433 MHz (UHF) | Short Range Devices | 1-100 | m | Moderate | |
| 865-868 MHz (Europe) | | | | | |
| 902-928 MHz (North America) | UHF | ISM band | | 1-12 m Moderate to high EAN, various | |
| standards | | | | | |
| 2450-5800 MHz | | | | | |
| (microwave) | ISM band | 1-2 | m | High | 802.11 WLAN, |
| | | | | | Bluetooth standards |
| 3.1-10 GHz (microwave) | Ultra-wide band | to 200 | m | High | Semi-active or active |
| | | | | | tags |

Low-Frequency Tags. Low-frequency (LF: 125-134.2 kHz and 140-148.5 kHz,) (Low FID) tags, high-frequency (HF: 13.56 MHz) (High FID) tags can he used globally without a license, Ultra-high-frequency (UHF: 865-928 MHz) (Ultra-High FID or UHFID) tags cannot be used globally as there is no single global standard. In North America, UHF can be used unlicensed for 902-928 MHz (±13 MHz from the 915 MHz center frequency), but restrictions exist for transmission power. In Europe, RFID and other low-power radio applications are regulated by ETSI recommendations EN 300 220 and EN 302 208, and ERO recommendation 70 03, allowing RFID operation with somewhat complex band restrictions from 865-868 MHz. Readers are required to monitor a channel before transmitting personal data, location data, logistics data, point of sale data communications (“Listen Before Talk”); this requirement has led to some restrictions on performance, the resolution of which is a subject of current research. The North American UHF standard is not accepted in France as it interferes with its military bands. Japan changed UHF band to 920 M, United States' uses 915 M, China has no regulation UHF, Australia and New Zealand use 918-926 MHz. Standards that have been made regarding RFID include: ISO 14223 Radio frequency [sic] identification of animals Advanced transponders: ISO/IEC 14443: This standard is a popular HF (13.56 MHz) standard for High Fids which is being used as the basis of RFID-enabled passports under ICAO 9303. The Near Field Communication standard that lets mobile devices act as RFID readers/transponders is also based on ISO/IEC 14443. ISO/IEC 15693: This is also a popular TM (13.56 MHz) standard for High Fids widely used for non-contact smart payment and credit cards.

ISO/IEC 18000: InfOrmation data technology—Radio frequency identification for item management includes the following standards: Part 1: Reference architecture and definition of parameters to be standardized; Part 2: Parameters for air interface communications below 135 kHz; Part 3: Parameters for air interface communications at 13,56 MHz; Part 4: Parameters fOr air interface communications at 2.45 GHz; Part 6: Parameters for air interface communications at 860-960 MHz; Part 7: Parameters for active air interface communications at 433 MHz; Other standards include: ISO/TEC 18092 information data technologyTelecommunications, biometric data and information data exchange between systemsNear Field CommunicationInterface and Protocol (NFCIP-1); ISO 18185: This is the industry standard for electronic seals or “e-seals” for tracking cargo containers using the 433 MHz and 2.4 GHz frequencies, ISO/IEC 21481 Information data technology Telecommunications, biometric data and information data exchange between systems—Near Field Communication Interface and Protocol-2 (NFCIP-2); ASTM D7434, Standard Test Method for Determining the Performance of Passive Radio Frequency Identification (MD) Transponders on Palletized or Unitized Loads; ASTM D7435, Standard Test Method for Determining the Performance of Passive Radio Frequency Identification (RFID) Transponders on Loaded Containers; ASTM D7580, Standard Test Method for Rotary Stretch Wrapper Method for Determining the Readability of Passive RFID Transponders on Homogenous Palletized or Unitized Loads; and ISO 28560-2 specifies encoding standards and data model to be used within libraries.

### DESCRIPTION OF NON-LIMITING EXEMPLARY EMBODIMENTS

The present subject matter relates to methods, apparatus, non-transitory computer readable storage medium, computer systems, networks, andlor systems to provide one or more water disinfection, filtration and purification systems for providing one or more liquid or water disinfection, filtration and purification systems that will make liquid or drinking water and one or more types of treated liquid or water for drinking or other purposes that can optionally include contaminant removal, energizing liquid or water molecules, improving one or more liquid or water conditions, changing the molecular structure of drinking water, improving the color, taste and odor of drinking water and providing a method of liquid or water disinfection, filtration and purification systems that can optionally include removing one or more pharmaceutical ingredients, compounds, chemicals, synthetic compounds, toxins, pollutants and other undesirable impurities or bacteria, contaminations, waterborne contaminant, bacteria, parasites, pathogens, inorganic compounds, organic material and macroscopic pollutants and other chemicals, synthetic compounds, fluoride compounds, chlorine or by-products, lead compound, carbon monoxide, arsenic, nitrates, personal care products, caffeine, a nicotine chemical, toxic metal salts, hormones, pesticides and other harmful contaminants in drinking water, bottled water, alcoholic beverages, non-alcoholic beverages or other beverages and one or more types of treated liquid or water for drinking or other purposes that can optionally include removing bacteria, parasites, viruses, molds, pathogens, inorganic compounds, organic material and macroscopic pollutants, chemicals, synthetic compounds, toxins, pollutants and other undesirable impurities or contaminations via a liquid or water disinfection, filtration and purification systems using electromagnetic fields of specific varying field (EMF) frequencies alternating current electricity in combination with ultraviolet (UV) light, one or more filtration systems and counter rotating magnetic field generator and oscillating electrical field alternating in polarity, either permanently or periodically, within a water source to be purified that will make liquid or drinking water and one or more types of treated liquid or water for drinking or other purposes that can optionally include providing one or more liquid or water disinfection, filtration and purification systems that can optionally include removing one or more pharmaceutical ingredients, compounds, chemicals, synthetic compounds, toxins, pollutants and other undesirable impurities or bacteria, contaminations, waterborne contaminant, bacteria, parasites, pathogens, inorganic compounds, organic material and macroscopic pollutants and other chemicals, synthetic compounds, fluoride compounds, chlorine or by-products, lead compound, carbon monoxide, arsenic, nitrates, personal care products, caffeine, a nicotine chemical, toxic metal salts, hormones, pesticides and other harmful contaminants in drinking liquid or water and one or more types of treated liquid or water for drinking or other purposes and other water uses that can optionally include domestic liquid or water uses, bottled liquid or water uses, municipal tap liquid or water uses, sewage wastewater uses, recycled liquid or water uses, groundwater uses, lead compound wastewater removal, medical and pharmacological water uses, industrial water uses, hydroelectricity water uses, marine wastewater uses. commercial liquid or water uses, manufacturing liquid or water uses, agricultural liquid or water uses, demineralization system, water ionizer uses, consumer packaged goods water uses, food processing liquid or water uses, packaged beverages and drinking liquid or water uses, livestock liquid or water uses, farm animal liquid or water uses, mining wastewater uses, public supply water and sanitation liquid or water uses, thermoelectric power water uses, recreational water uses, irrigation water uses, municipal tap water uses, environmental water uses, oil wastewater and gas wastewater for refining petroleum liquid or water uses, ballast wastewater liquid or water uses, desalination of salt water pretreatment uses for human consumption or irrigation water uses, wastewater plant water uses, pressurized liquid or water uses, aquaculture water uses, plant and animal liquid or water uses, stimulating plant liquid or water uses, or other water pretreatment uses or wastewater uses.

This present subject matter can optionally include systems or methods for providing one or more water disinfection, filtration and purification systems that will make liquid or drinking water and one or more types of treated liquid or water for drinking or other purposes that can optionally include contaminant removal, energizing water molecules, improving one or more water conditions, changing the molecular structure of drinking water, improving the color, taste and odor of drinking water and providing a method of water disinfection, filtration and purification systems that can optionally include removing one or more pharmaceutical ingredients, compounds, chemicals, synthetic compounds, toxins, pollutants and other undesirable impurities or bacteria, contaminations, waterborne contaminant, bacteria, parasites, pathogens, inorganic compounds, organic material and macroscopic pollutants and other chemicals, synthetic compounds, fluoride compounds, chlorine or by-products, lead compound, carbon monoxide, arsenic, nitrates, personal care products, caffeine, a nicotine chemical, toxic metal salts, homiones, pesticides and other harmful contaminants in drinking water, bottled water, alcoholic beverages, non-alcoholic beverages or other beverages and one or more types of treated liquid or water for drinking or other purposes that can optionally include removing bacteria, parasites, viruses, molds, pathogens, inorganic compounds, organic material and macroscopic pollutants, chemicals, synthetic compounds, toxins, pollutants and other undesirable impurities or contaminations that will make liquid or drinking water and one or more types of treated liquid or water for drinking or other purposes. The present subject matter can optionally include using EMFID wireless device for collection of information data also includes EMFID logistic applications.

The features described can be implemented in digital electronic circuitry, or in computer hardware, firmware, software, or in combinations of them. The features can be implemented in a computer program product tangibly embodied in an information data carrier, e.g., in a machine-readable storage device or in a propagated signal, for execution by a programmable processor; and method steps can be performed by a programmable processor executing a program of instructions to perform functions of the described implementations by operating on input data and generating output.

The described features can be implemented advantageously in one or more computer programs that are executable on a programmable system including a generator or system of generators of high frequency currents using copper or metal rings, electrodes or frequency generators that produces at least one programmable processor coupled to receive data and instructions from, and to transmit data and instructions to, a data storage system, a input device, and a output device. A computer program is a set of instructions that can be used, directly or indirectly, in a computer to perform a certain activity or bring about a certain result. A computer program can be written in any form of programming language, (e.g., Objective-C, Java), including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor one of multiple processors or cores, of any kind of computer. Generally, a processor can receive instructions and other data to develop a biometric profile for one or more individuals or each end user using EMFID biometric sensors and electromagnetic frequency (EMF) identification devices and other frequency tags and relaying data from EMFID biometric sensors tag communications to a database for analysis, retrieval of data and marketing of promotions or offers, of interest, and including the detection, diagnosis and treatment of disease causing pathogens, inorganic compounds, organic material and macroscopic pollutants, bacteria or viruses andlor illnesses, medical conditions and diseases and conditions for disease control and prevention, including collection of biometric marker data or symptoms data for medical diagnosis and other biomedical applications and/or treatment of other health problems that can he accessed by members of a network from a read-only memory or a random access memory or both. The essential elements of a computer are a processor for executing instructions and one or more memories for storing instructions and data. Generally, a computer can also include, or be operatively coupled to communicate with one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices, magnetic disks such as internal hard disks and removable disks; magneto-optical disks; and CD-ROM and DVD-ROM disks. The processor and the memoty can be supplemented by, or incorporated in. ASICs, (application-specific integrated circuits). To provide for interaction with a user, the features can be implemented on a computer having a display device such as a CRT, (cathode ray tube) or LCD, (liquid crystal display) monitor for displaying information data to the user and a keyboard and a pointing device such as a mouse or a trackball by which the user can provide input to the computer.

The features can be implemented in a computer system that can optionally include a back-end component, such as a data server, or that can optionally include a middleware component, such as an application server or an Internet server, or that can optionally include a front-end component, such as a client computer having a graphical user interface or an Internet browser, or any combination of them. The components of the system can be connected by any form or medium of digital data communication such as a communication network. Examples of communication networks include, e.g., a LAN, a WAN, and the computers and networks forming the Internet. The computer system can include clients and servers. A client and server are generally remote from each other and typically interact through a network. The relationship of client and server arises by virtue of computer programs running on the respective computers and having a client-server relationship to each other.

Additional Terms for First and Second Exemplary Embodiments;

The following terms are used herein:

“Wastewater” is water that has been used in a manner or subject to a condition in which the water has acquired a load of contaminants and/or waste products that render the water incapable of at least certain desired practical uses without being subject to reclamation.

“Water reuse” is a beneficial use of a treated wastewater. “Wastewater reclamation” is a treatment of a wastewater to a degree to which the water can be reused, yielding “reclaimed” water.

“Direct muse” is a direct use of a reclaimed wastewater, such as for agricultural and landscape irrigation, use in industry, or use in a dual water system.

“Indirect reuse” is the mixing, dilution, or dispersion of a reclaimed wastewater into a body of “receiving” water or into a groundwater supply prior to reuse.

“Potable water reuse” is the use of a highly treated reclaimed water to provide or augment a supply of drinking water.

“Direct potable reuse” is the introduction of highly treated, high-quality reclaimed water directly into a drinking-water distribution system.

“Indirect potable reuse” is the mixing of reclaimed water with an existing water resource (e.g., a surface resource or a groundwater resource) before the water from the resource is delivered to a drinking-water treatment system. The mixing can occur in a river, lake, or reservoir, or by injection into an aquifer, for example.

“Seawater” (abbreviated “SW”) is saline water from the sea or from any source of brackish water. “Feed water” is water, such as seawater, input to a treatment process such as a desalination process. “Make-up water” is pretreated and diluted seawater used to augment a desalination loop with salt lost due to diffusion from a concentrate to the seawater or from a concentrate to the treated wastewater during a forward-osmosis process.

“Seawater pretreatment” is a treatment of seawater destined for use as make-up water, wherein the pretreatment includes, but is not limited to, one or more of coagulation, filtration, ion-exchange, disinfection, and any other membrane process, in the stated order or any other order.

“Treated Wastewater” (abbreviated “Treated WW”) is reclaimed wastewater that has been subjected to a secondary or tertiary wastewater-treatment process.

“Concentrated Treated Wastewater” (abbreviated “Concentrated Treated WW”) is a treated wastewater after water has been extracted from it, such as by an forward-osmosis process; thus, concentrated treated wastewater typically has a higher concentration of solutes and/or other non-water waste products than treated wastewater.

“Impaired Water” is any water that does not meet potable water quality standards. “Concentrate” is a byproduct of a water purification processes having a higher concentration of a solute or other material than the feed water, such as a brine by-product produced by a desalination process.

“Draw solution” is a solution having a relatively high osmotic potential that can be used to extract water from a solution having a relatively low osmotic potential. In certain embodiments, the draw solution may be formed by dissolving an osmotic agent in the draw solution.

“Receiving stream” is a stream that receives water by a water purification or extraction process. For example, in forward-osmosis, the draw solution is a receiving stream that receives water from a feed stream of water having a lower osmotic potential than the receiving stream.

“Product Water” is potable water produced by a system as described herein. In addition, the terms “upstream” and “downstream” are used herein to denote, as applicable, the position of a particular component, in a hydraulic sense, relative to another component. For example, a component located upstream of a second component is located so as to be contacted by a hydraulic stream (flowing in a conduit for example) before the second component is contacted by the hydraulic stream. Conversely, a component located downstream of a second component is located so as to be contacted by a hydraulic stream after the second component is contacted by the hydraulic stream.

Forward Osmosis: A forward-osmosis process is termed “osmosis” or “direct osmosis.” Forward-osmosis typically uses a semipermeable membrane having a permeate side and a feed side. The feed (active) side contacts the water (feed water) to be treated. The permeate (support) side contacts a hypertonic solution, referred to as an osmotic agent or a draw solution or receiving stream, that serves to draw (by osmosis) water molecules and certain solutes and other compounds from the feed water through the membrane into the draw solution. The draw solution is circulated on the permeate side of the membrane as the feed water is passed by the feed side of the membrane. Unlike reverse osmosis, which uses a pressure differential across the membrane to induce mass-transfer across the membrane from the feed side to the permeate side, forward-osmosis uses an osmotic-pressure difference as the driving force for mass transfer across the membrane. As long as the osmotic potential of water on the permeate side (draw solution side) of the membrane is higher than the osmotic potential of water on the feed side, water will diffuse from the feed side through the membrane and thereby dilute the draw solution. To maintain its effectiveness in the face of this dilution, the draw solution must typically be re-concentrated, or otherwise replenished, during use. This re-concentration typically consumes most of the energy that conventionally must be provided to conduct a forward-osmosis process.

Because the semipermeable membranes used in forward-osmosis are typically similar to the membranes used in reverse osmosis, most contaminants are rejected by the membrane and only water and some small molecules diffuse through the membrane to the draw solution side. A contaminant that is “rejected” is prevented by the membrane from passing through the membrane. Selecting an appropriate membrane usually involves selecting a membrane that exhibits high rejection of salts as well as various organic andlor inorganic compounds while still allowing a high flux of water through the membrane at a low driving force.

Other advantages of the forward-osmosis process can include relatively low propensity to membrane fouling, low energy consumption, simplicity, and reliability. Because operating pressures in the forward-osmosis process typically are very low (up to a few bars, reflective of the flow resistance exhibited by the housing containing the membranes), the equipment used for performing forward-osmosis can be vely simple. Also, use of lower pressure may alleviate potential problems with membrane support in the housing and reduce pressure-mediated fouling of the membrane.

In one application, the disclosed systems and methods can be used to treat raw wastewater to make it potable. The disclosed systems and methods can also be used in the treatment of landfill leachates, foods, and beverages. In particular implementations, more than 97% of the total nitrogen and more than 99.5% of the phosphorus in a feed solution can be rejected by disclosed methods and systems.

Forward-Osmosis-Assisted Desalination: With a suitable forward-osmosis semipermeable membrane, a relatively high flux of fresh water, or water from impaired water, through the membrane into the draw solution ,.g., seawater, concentrated seawater, or other suitable hypertonic solution) can be realized. For example, a draw solution having a solute concentration close to that of seawater can produce flux of at least 10 L/(m2.hr) of clean water through the suitable forward-osmosis membrane into the draw solution, Thus, using forward-osmosis, seawater can be diluted with highly treated wastewater prior to the seawater being subject to desalination, thereby reducing the salinity of the seawater and correspondingly reducing the energy required to desalinate it. The concentrated brine produced may be used as a draw solution in downstream purification processes.

Non-Limiting Examples of Optional Embodiments of the present subject matter.

### First Exemplary Embodiment

A first exemplary embodiment of an optional liquid- or water-treatment system, method or apparatus hereof, can include, in addition to liquid treatment comprising one or more of disinfection, filtration, and/or purification of the liquid using at least one electromagnetic field (EMF) comprising two or more specific and/or varying frequencies and pulses, the ENIFs optionally applied to the fluid using one or more of alternating current electricity, counter rotating magnetic fields, and/or oscillating electrical fields of alternating polarity, the additional optional aspects including a reverse osmosis or desalination process and/or one or more forward-osmosis pretreatment stages to reduce feed-water salinity and to reduce or eliminate conventional pretreatment of the feed water.

In such an additional, optional process, a reverse osmosis and/or desalination step is performed in which the feed water is diluted with fresh water. The fresh-water diluent is supplied by forward-osmosis of treated wastewater, run-off water, or any impaired water, for example. Although generally described in these exemplary systems for use in desalinating salt water, the methods and systems described in the exemplary embodiments may be applied to other source liquids.

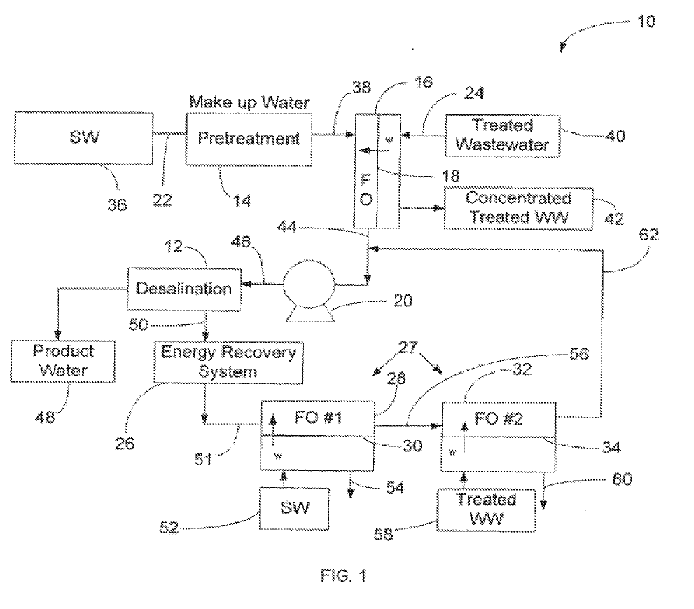

An exemplary apparatus 10 for performing the process is shown n FIG. 1 and includes the following components: a reverse osmosis and/or desalination unit 12, a liquid, water, or seawater-pretreatment unit 14, an upstream forward-osmosis unit 16 comprising a forward-osmosis membrane 18, a pump 20, a liquid, water, or seawater-feed stream 22, a wastewater (reclaimed or impaired) feed stream 24, an energy-recovery system 26, and a dual-stage froward-osmosis system 27 arranged in a loop.

The liquid, water, or seawater-pretreatment unit 14 and upstream forward-osmosis unit 16 collectively provide a, water stream that may be used to provide make-up water or start-up water to the reverse osmosis and/or desalination unit 12. The reverse osmosis andlor desalination unit 12 can be, for example, a reverse osmosis, nanofiltration, electro dialysis, forward-osmosis, ammonium bicarbonate forward-osmosis (“ABFO” or “FO desalination”), distillation or any other suitable device.

The energy-recovery system 26 can include a heat-exchanger, such as condensers, shell and tube heat exchangers, plate heat exchangers, circulators, radiators, and boilers, which may be parallel flow, cross flow, or counter flow heat exchangers (if the reverse osmosis and/or desalination unit 12 is a thermal-reverse osmosis and/or desalination device), a power exchanger (if the reverse osmosis andlor desalination unit 12 is a pressure-driven reverse osmosis and/or desalination device), or other suitable device that extracts usable energy from liquid entering it. The energy-recovery system 26 can be a combination of these exemplary devices as required or desired.

In the embodiment shown in FIG. 1, the dual-stage forward-osmosis system 27 includes a first-stage forward-osmosis unit 28 including a first forward-osmosis membrane 30, and a second-stage forward-osmosis unit 32 including a second forward-osmosis membrane 34. The first-stage forward-osmosis unit 28 and the second-stage forward-osmosis unit 32 are arranged hydraulically in tandem in a hydraulic loop.

Liquid, water, or seawater (or other make-up water, termed generally “seawater” here) 36 is drawn from an appropriate source and passes through the pretreatment unit 14. The pretreatment unit 14 pretreats the liquid, water, or seawater, as required, such as subjecting it to one or more processes such as coagulation, media filtration, microfiltration, ultrafiltratiou nanofiltration beach wells, ion-exchange, chemical addition, disinfection, and other membrane process, in any suitable order. The effluent make-up water 38 from the pretreatment unit 14 enters the upstream thrward-osmosis unit 16.

As the make-up water 38 passes through the upstream forward-osmosis unit 16 on the permeate side of the membrane 18. treated wastewater 40, or impaired water, is circulated through the upstream forward-osmosis unit 16 on the feed side of the membrane 18. As a result, the make-up water 38 is diluted by transfer of water (as indicated by the “W” arrows in FIG. It) from the feed side through the membrane 18. Thus, the treated wastewater 24 is concentrated to produce a concentrate stream 42. and the make-up water 38 is diluted. The diluted water stream 44 exiting the upstream forward-osmosis unit 16 is suitably pressurized by the pump 20 as required by the reverse osmosis and/or desalination unit 12. The resulting pressurized water 46 enters the reverse osmosis and/or desalination unit 12, which removes particulates, if any, and solutes, such as salt solutes, from the water 46 sufficiently to produce the desired product water 48 (such as potable water) The product water 48 may be subjected to further purification steps. The removed particulates, if any, and solutes, entrained in a concentrate stream 50, pass through the energy-recovery system 26 configured appropriately for the particular type of reverse osmosis and/or desalination unit 12, as discussed above.

The de-energized water stream 51 (now at relatively low pressure) passes through the dual-stage forward-osmosis system 27, namely first through the first-stage forward-osmosis unit 28 and then through the second-stage forward-osmosis unit 32. As the de-energized concentrate 51 passes through the first-stage forward-osmosis unit 28 on the permeate side of the membrane 30, liquid, water, or seawater 52 (or other suitable impaired water) is circulated through the first-stage forward-osmosis unit 28 on the feed side of the membrane 30. As a result, the concentrate stream 51 is diluted by transfer of water (as indicated by the “W” arrows in FIG. 1) from the feed side of the membrane 30. The concentrated brine 54 from the forward-osmosis unit 28 may be discharged from the first-stage forward-osmosis unit 28.

As the diluted concentrate 56 from the first-stage forward-osmosis unit 28 passes through the second-stage forward-osmosis unit 32 on the permeate side of the membrane 34, treated wastewater 58 (or other impaired water having a suitably low salinity) is circulated through the second-stage forward-osmosis unit 32 on the feed side of the membrane 34. As a result, the diluted concentrate 56 is further diluted by transfer of water (as indicated by the “W” arrows in FIG. 1) from the feed of the membrane 34, thereby concentrating the wastewater 58, or impaired water, in a concentrate stream 60 that is discharged from the second-stage fotward-osmosis unit 32. The brine 62 from the second-stage forward-osmosis unit 32, now further diluted, is routed to upstream of the pump 20, thereby completing the loop from downstream of the reverse osmosis and/or desalination unit 12 to upstream of it.

After an initial priming of the system 10, in which all the feeds to the reverse osmosis and/or desalination unit 12 are passed through the upstream forward-osmosis unit 16, the system 10 tuns in a manner by which at least most of the feed water to the reverse osmosis and/or desalination unit 12 is supplied by the diluted brine 62 from the second-stage forward-osmosis unit 32. Any required make-up water can be provided by the upstream forward-osmosis unit 16. Supplying at least most of the feed water to the reverse osmosis and/or desalination unit 12 from the two-stage forward-osmosis system 27 minimizes dependence of the system 10 on the pretreatment unit 14, thus promoting savings in capital equipment, maintenance, and operating costs.

As an alternative to the hydraulic circuit shown in FIG. 1, the pretreatment unit 14 can be located downstream of the upstream forward-osmosis unit 16, in which event the pretreatment unit 14 still will be located upstream of the pump 20 and upstream of the connection of stream 62 with stream 44. In other words, the make-up water 36 can be pretreated either before or after (but more desirably before) the osmosis step performed by the upstream forward-osmosis unit 16.

The liquid, water, or seawater 36 is used as make-up water for replenishing salt lost during reverse osmosis and/or desalination by the reverse osmosis and/or desalination unit 12, at least during system start-up. The liquid, water, or seawater 36 desirably is diluted by the upstream forward-osmosis unit 16 for feeding the reverse osmosis and/or desalination unit 12, at least during system start-up. After desalination, as noted above, the energy-recovery system 26 recovers energy from the pressurized concentrate or heated concentrate 50 exiting the reverse osmosis and/or desalination unit 12. After recovery of energy from the concentrate 50, the resulting de-energized concentrate 51 passes through the two-stage forward-osmosis system 27, as discussed above, in which the concentrate is diluted by water supplied from liquid, water, or seawater, impaired water, wastewater, run-off water, or any other impaired water by forward-osmosis.

Passing the concentrate 50 through the two-stage forward-osmosis unit 27 dilutes the concentrate 50 for use as feed 46 to the reverse osmosis and/or desalination unit 12. Since the salinity and load of solutes and other contaminants in the feed 46 may be reduced (compared to ordinaty liquid, water, or seawater) by the two-stage forward-osmosis system 27, the reverse osmosis and/or desalination unit 12 can be operated at a reduced pressure and/or temperature than it otherwise would have to be for producing the desired flux or volume of product water 48. The reduced pressure andlor temperature can yield reduced rates of membrane clogging and fouling in the reverse osmosis and/or desalination unit 12.

Because forward-osmosis membranes and processes generally exhibit a low degree of fouling, forward-osmosis can be advantageously used in this embodiment for pretreating reclaimed water or impaired water for use in most reverse osmosis and/or desalination processes. This can eliminate other, more expensive, pretreatment steps as well as protect the reverse osmosis and/or desalination process.

The concentrate 50 expelled from the reverse osmosis and/or desalination unit 12 is mostly recycled in this embodiment, and only a small amount of salt is typically added (in the dual-stage forward-osmosis system 27 and from the upstream forward-osmosis unit 16 as required) to compensate for losses through the forward-osmosis membranes and the reverse osmosis and/or desalination unit 12. This is an advantage because, as a result, the reverse osmosis and/or desalination unit 12 is not exposed to substantial amounts of new foulants. Moreover, a solution exhibiting a very low scaling tendency can be specifically selected as an osmotic agent in the forward-osmosis units 28, 32, which may reduce the need for use of scale inhibitors.

In the two-stage forward-osmosis system 27, the forward-osmosis performed with liquid, water, or seawater dilutes the concentrate stream to below the normal level of liquid, water, or seawater salinity This produces feed water having a lower osmotic pressure for the reverse osmosis andlor desalination unit 12. Similarly, in the upstream forward-osmosis unit 16, the forward-osmosis performed with treated liquid, water, or seawater dilutes the liquid, water, or seawater to below the normal level of liquid, water, or seawater salinity, providing feed water having a lower osmotic pressure than liquid, water, or seawater for the reverse osmosis and/or desalination unit 12. As a result, the energy required by the reverse osmosis and/or desalination unit 12 for performing reverse osmosis and/or desalination can be lowered or the overall water-recovery or flux of the system 10 enhanced.

Although in this embodiment the forward-osmosis system 27 is depicted and described as a “two-stage” forward-osmosis system, it will be understood that this forward-osmosis system alternatively can include only one forward-osmosis unit or can include more than two forward-osmosis units. In addition, even though the forward-osmosis system 27 is shown and described with the forward-osmosis units being connected in tandem (in series), it will be understood that other interconnection schemes (including parallel connection schemes and/or combinations of parallel and series) can be used.

Another advantage of this embodiment is that advanced pretreatment (by the pretreatment unit 14) is performed on only the minimal volume of liquid, water, or seawater 36 that is required for making up for salt losses in the system 10. Yet potential advantage of this embodiment is that water streams that would be otherwise typically be treated as waste, such as concentrated brine from the reverse osmosis and/or desalination unit 12, can be used to create more product water or lower the capital, maintenance, or energy costs of the system.

It may be desirable to post-treat the product water 48. The particular nature of the post-treatment may depend on the use of the product water 48. In one implementation, the product water 48 can be subjected to one or more of pH adjustment (such as by suitable titration), chlorination, ozonation. UV irradiation, ion exchange, activated-charcoal adsorption, or the like.

It will be understood that this embodiment can be used for purposes other than reverse osmosis and/or desalination of liquid, water, or seawater or of impaired water. The disclosed embodiment can be used for treating raw wastewater to drinking-water levet. The disclosed embodiment may also be used in the treatment of landfill leachates. The disclosed embodiment can also be used in the food industry or in feed solutions as used in the chemical industry, pharmaceutical industry, or biotechnological industry. In particular implementations, more than 97% of the total nitrogen and more than 99.5% of the phosphorus in the feed solution are rejected by the disclosed systems.

### Second Exemplary Embodiment

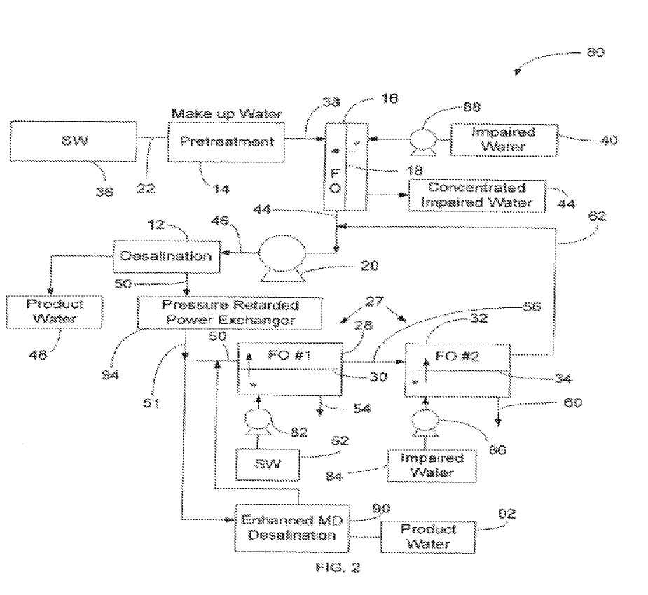

A system 80, which is similar to the system of FIG. 1 in many respects, is depicted in FIG. 2. Components of the system 80 shown in FIG. 2 that are the same as respective components of the system 10 shown in FIG. 1 have the same respective reference designators and are not described further except as noted below.

The system 80 of FIG. 2 includes a dual-stage forward-osmosis device 27 comprising a first-stage forward-osmosis unit 28 and a second-stage forward-osmosis unit 32, as in the first exemplary embodiment. FIG. 2 shows the first-stage forward-osmosis unit 28 being supplied with liquid, water, or seawater 52 (as a feed water) by a respective pump 82, and the second-stage forward-osmosis unit 32 being supplied with impaired water 84 (as a feed water) by a respective pump 86. Similarly, the forward-osmosis unit 16 upstream of the reverse osmosis and/or desalination unit 12 is supplied with impaired water 40 (as feed water) by a respective pump 88.

In the dual-stage forward-osmosis device 27, the concentrated draw solution 50 produced by the reverse osmosis and/or desalination unit 12 contacts the receiving side of the forward-osmosis membrane 30 and liquid, water, or seawater (or other suitable water) contacts the feed side of the fotward-osmosis membrane 30 in the first-stage forward-osmosis unit 28. Water passing through the membrane 30 from the feed side to the receiving side dilutes the draw solution. The diluted draw solution 56 exiting the first-stage forward-osmosis unit 28 then enters the second-stage forward-osmosis unit 32, in which the diluted draw solution 56 contacts the permeate side of the forward-osmosis membrane 34 and impaired water 84, or another suitable water source, contacts the feed side of the forward-osmosis membrane 34. Both forward-osmosis stages 28, 32 are used to induce liquid, water, or seawater (or other feed water) dilution of a draw solution to be used again as feed water 62 to the reverse osmosis and/or desalination unit 12.

The embodiment 80 shown in FIG. 2 also includes a membrane distillation reverse osmosis and/or desalination device 90 that is used to extract additional product water from the concentrated draw solution 50 produced by the reverse osmosis and/or desalination unit 12. The membrane distillation reverse osmosis and/or desalination device 90 produces a product-water stream 92 and returns spent concentrated draw solution to concentrate 50 to serve as the draw solution in the first-stage forward-osmosis unit 28. The membrane distillation reverse osmosis and/or desalination device 90 is typically relatively insensitive to the salt concentration of the feed solution. Thus, the membrane distillation reverse osmosis and/or desalination device 90 can further increase overall recovery or flux of product water 48, 92 from the system 80 and enhance the efficiency of the dual-stage forward-osmosis device 27.

In at least one embodiment, the membrane distillation reverse osmosis and/or desalination device 90 is an enhanced membrane distillation reverse osmosis and/or desalination device that is able to produce relatively high flux across a membrane (not shown). In a particular implementation, the enhanced membrane distillation reverse osmosis and/or desalination device is a direct-contact membrane-distillation device. In a more particular implementation, the enhanced membrane distillation reverse osmosis and/or desalination device 90 uses an enhanced membrane distillation method whereby vacuum is applied to a permeate side, and optionally a feed side, of a flow cell (not shown) containing the membrane to cause the stream to flow under vacuum or reduced pressure.

The system 80 can be configured to be more energy efficient. For example, if the reverse osmosis and/or desalination unit 12 is pressure-driven (such as Nanofiltration or reverse osmosis), the energy-recovery system 26 in the system 80 may include a “pressure-retarded power exchanger” 94. Alternatively, if the reverse osmosis and/or desalination unit 12 is thermally driven, the energy-recovery system 26 desirably includes a heat-exchanger (HX) for recovering heat from the concentrate. Suitable heat exchangers include condensers, shell and like heat exchangers, plate heat exchangers, circulators, radiators, and boilers and may be parallel flow, cross flow, or counter flow heat exchangers.

### Examples of the First Exemplary Embodiment

A mathematical model was developed to predict the cost saving in a 35,000 gallon-per-day reverse osmosis and/or desalination plant using forward-osmosis-assisted reverse osmosis and/or desalination by reverse osmosis, as described in the foregoing exemplary embodiments. Reverse osmosis-modeling software (ROSA®, Dow Chemical Company of Midland, Mich.) was used for modeling the reverse osmosis unit, and a self-developed modeling spreadsheet was used for modeling the forward-osmosis stages. The reverse osmosis unit was modeled using eight 8-inch Filmtecml membranes (SW30-380, 35 m2 membrane area per membrane element, available from Dow Chemical Company of Midland, Mich.) under operational parameters of 800 psi feed pressure and 45 gpm feed flow rate. The dual-stage forward-osmosis units were modeled as having a total of 16 membrane elements each having an area of 35 m2, Three cases were modeled, including: (1) direct liquid, water, or seawater desalination, (2) diluted liquid, water, or seawater reverse osmosis and/or desalination under similar operating conditions as with direct liquid, water, or seawater desalination, and (3) diluted liquid, water, or seawater reverse osmosis and/or desalination at lower feed pressure than used for direct liquid, water, or seawater desalination.

When comparing cases (1) and (2), the product-water recovery (ratio between product-water flow rate and feed flow rate to the reverse osmosis and/or desalination unit) and water-production rate were both more than 30% higher than obtained using conventional systems. When comparing cases (1) and (3), the model predicted that, under the same recovery and production rates (approximately 49% recovery) the reverse osmosis reverse osmosis and/or desalination unit could be operated at a feed pressure of 595 psi instead of 800 psi, with a corresponding increase in usable lifetime of the reverse osmosis and/or desalination unit.

### EXAMPLE 1

This example sets forth the RASA results expected to obtained under case (1) noted above.

System Summary (non-limiting example of expected values):

| Feed flow to stage 1 | 30-60 | gpm |
|---|---|---|
| Permeate flow | 20-30 | gpm |
| Raw water flow to system | 30-60 | gpm |
| Recovery | 40-60% | |
| Feed pressure | 400-1000 | psig |
| Feed temperature | 15-30 | C. |
| Fouling factor | 0.8-1.2 | |
| Feed TDS | 20k-50k | mg/L |
| Chem. Dose | none | |
| Number of elements | 3-10 | |
| Total active area | 2000-5000 | ft² |
| Average system flux | 5-25 | gfd |

| | |
|---|---|
| Water classification | liquid, water, or seawater |
| | (open intake) SDI < 2-10 |

(non-limiting example of expected values)

| | Feed | Retirc | Conc | Conc | Perm | Avg | Perm | Boost | Perm | | | | |
|---|---|---|---|---|---|---|---|---|---|---|---|---|---|
| Feed | Flow | Press | Flow | Flow | Press | Flow | Flux | Press | Press | TDS | | | |
| Stage | Element | #PV | #Ele | (gpm) | (psig) | (gpm) | (gpm) | (psig) | (gpm) | (gfd) | (psig) | (psig) | (mg/L) |
| 1 | SW30-380 | 1 | 8 | 45.00 | 795.00 | 0.00 | 23.00 | 765.56 | 22.00 | 10.42 | 0.00 | 800.00 | 451.98 |

| (mg/L, except pH) | Raw Water | Adj Feed | Permeate | Concentrate |
|---|---|---|---|---|
| NH4 | 0.00 | 0.00 | 0.00 | 0.00 |
| K | 0.00 | 0.00 | 0.00 | 0.00 |
| Na | 10k-15k | 10k-15k | 100-2500 | 15k-30k |
| Mg | 800-1500 | 800-1500 | 3-8 | 2000-4000 |
| Ca | 200-500 | 300-6000 | 0.8-2.5 | 600-1000 |
| Sr | .05-.4 | .05-.4 | 0.00 | .05-.40 |
| Ba | .05-.40 | .05-.4 | 0.00 | 0.1-.8 |
| CO3 | 0.00 | 0.00 | 0.00 | 0.00 |
| HCO3 | 0.00 | 0.00 | 0.00 | 0.00 |
| NOS | 0.00 | 0.00 | 0.00 | 0.00 |
| Cl | 15k-25k | 15k-25k | 150-400 | 5k-10k |
| F | 8-15 | 8-15 | 0.05-.5 | 15-35 |
| SO4 | 1500-3500 | 1500-3500 | 1.5-6 | 2500-7500 |
| Boron | 0.00 | 0.00 | 0.00 | 0.00 |
| SiO2 | 1-5 | 1-5 | .05-1.1 | 3-7 |
| CO2 | 0.00 | 0.00 | 0.00 | 0.00 |
| TDS | 25k-45k | 25-45K | 250-700 | 45k-80k |
| pH | 7.1-8.5 | 7.1-8.5 | 7.1-8.5 | 7.1-8.5 |

Solubility Warnings: BaSO4 (% Saturation) > 100%; CaF2 (% Saturation) > 100%;

| Scaling Calculations: | Raw Water | Adj Feed | Concentrate |
|---|---|---|---|
| pH | 7.1-8.5 | 7.1-8.5 | 7.1-8.5 |
| Langelier Saturation Index | −3 to −6 | −3 to −6 | −3 to −6 |
| Stiff & Davis Stability Index | −6.5 to −6.9 | −6.5 to −6.9 | −6.2 to 6/6 |
| Ionic Strength (Molal) | 0.5 to 0.8 | 0.5 to 0.8 | 1.2 to 1.5 |
| TDS (mg/L) | 25k to 50k | 25k to 50k | 50k to 75k |
| HCO3 | 0.00 | 0.00 | 0.00 |
| CO2 | 0.00 | 0.00 | 0.00 |
| CO3 | 0.00 | 0.00 | 0.00 |
| CaSO4 (% Saturation) | 10-20 | 10-20 | 25-50 |
| BaSO4 (% Saturation) | 65-80 | 65-80 | 140-180 |
| SrSO4 (% Saturation) | .15-.25 | .15-.25 | .35-.60 |
| CaF2 (% Saturation) | 8k-12k | 8k-12k | 50k-75k |
| SiO2 (% Saturation) | 2-3.5 | 2-3.5 | 4-6 |

To balance: 0.01 mg/L Na added to feed.

Array Details:

| | | | Perm | Perm | Feed | Feed | Feed |
|---|---|---|---|---|---|---|---|
| Stage | Ele- | | Flow | TDS | Flow | TDS | Press |
| 1 | ment | Recov. | (gpm) | (mg/L) | (gpm) | (mg/L) | (psig) |
| | 1 | 0.1-.4 | 4-6 | 100-300 | 30-60 | 25k-50k | 600-900 |
| | 2 | 0.1-.4 | 3-6 | 150-350 | 25-50 | 30k-60k | 600-900 |
| | 3 | 0.1-.4 | 2-5 | 200-500 | 35-60 | 44002.44 | 600-900 |
| | 4 | 0.0.7-1.0 | 1-4 | 250-600 | 20-50 | 48926.88 | 600-900 |
| | 5 | 0.05-.09 | 1-4 | 450-700 | 15-45 | 53644.99 | 600-900 |
| | 6 | 0.04-.08 | .5-3 | 600-950 | 15-50 | 57922.11 | 600-900 |
| | 7 | 0.03-.06 | .5-3 | 900-1300 | 15-45 | 61611.17 | 600-900 |
| | 8 | 0.03-.06 | .7-1.5 | 1400-1800 | 15-45 | 64745.41 | 600-900 |

### EXAMPLE 2

This example sets forth the ROSA results expected to he obtained under case (2) noted above.

System Summary (non-limiting example of expected values):

| Feed flow to stage 1 | 30-60 | gpm |
|---|---|---|
| Permeate flow | 20-30 | gpm |
| Raw water flow to system | 30-60 | gpm |
| Recovery | 40-60% | |
| Feed pressure | 400-1000 | psig |
| Feed temperature | 15-30 | C. |
| Fouling factor | 0.8-1.2 | |
| Feed TDS | 20k-50k | mg/L |
| Chem. Dose | none | |
| Number of elements | 3-10 | |
| Total active area | 2000-5000 | ft² |
| Average system flux | 5-25 | gfd |

| | |
|---|---|
| Water classification | liquid, water, or seawater |
| | (open intake) SDI < 2-10 |

(non-limiting example of expected values)

| | Feed | Recirc | Conc | Cone | Perm | Avg | Perm | Boost | Perm | | | | |
|---|---|---|---|---|---|---|---|---|---|---|---|---|---|
| Feed | Flow | Press | Flow | Flow | Press | Flow | Flux | Press | Press | TDS | | | |
| Stage | Element | #PV | #Ele | (gpm) | (psig) | (gpm) | (gpm) | (psig) | (gpm) | (gfd) | (psig) | (psig) | (mg/L) |
| 1 | SW30-380 | 1 | 8 | 45.00 | 795.00 | 0.00 | 23.00 | 765.56 | 22.00 | 10.42 | 0.00 | 800.00 | 451.98 |

| (mg/L, excent pH) | Raw Water | Adj Feed | Permeate | Concentrate |
|---|---|---|---|---|
| NH4 | 0.00 | 0.00 | 0.00 | 0.00 |
| K | 0.00 | 0.00 | 0.00 | 0.00 |
| Na | 10k-15k | 10k-15k | 100-2500 | 15k-30k |
| Mg | 800-1500 | 800-1500 | 3-8 | 2000-4000 |
| Ca | 200-500 | 300-6000 | 0.8-2.5 | 600-1000 |
| Sr | .05-.4 | .05-.4 | 0.00 | .05-.40 |
| Ba | .05-.40 | .05-.4 | 0.00 | 0.1-.8 |
| CO3 | 0.00 | 0.00 | 0.00 | 0.00 |
| HCO3 | 0.00 | 0.00 | 0.00 | 0.00 |
| NO3 | 0.00 | 0.00 | 0.00 | 0.00 |
| Cl | 15k-25k | 15k-25k | 150-400 | 5k-10k |
| F | 8-15 | 8-15 | 0.05-.5 | 15-35 |
| SO4 | 1500-3500 | 1500-3500 | 1.5-6 | 2500-7500 |
| Boron | 0.00 | 0.00 | 0.00 | 0.00 |
| SiO2 | 1-5 | 1-5 | .05-1.1 | 3-7 |
| CO2 | 0.00 | 0.00 | 0.00 | 0.00 |
| TDS | 25k-45k | 25-45K | 250-700 | 45k-80k |
| pH | 7.1-8.5 | 7.1-8.5 | 7.1-8.5 | 7.1-8.5 |

Solubility Warnings: BaSO4 (% Saturation) > 100%; CaF2 (% Saturation) > 100%;

| Scaling Calculations: | Raw Water | Adj Feed | Concentrate |
|---|---|---|---|
| pH | 7.1-8.5 | 7.1-8.5 | 7.1-8.5 |
| Langelier Saturation Index | −3 to −6 | −3 to −6 | −3 to −6 |
| Stiff & Davis Stability Index | −6.5 to −6.9 | −6.5 to −6.9 | −6.2 to 6/6 |
| Ionic Strength (Molal) | 0.5 to 0.8 | 0.5 to 0.8 | 1.2 to 1.5 |
| TDS (mg/L) | 25k to 50k | 25k to 50k | 50k to 75k |
| HCO3 | 0.00 | 0.00 | 0.00 |
| CO2 | 0.00 | 0.00 | 0.00 |
| CO3 | 0.00 | 0.00 | 0.00 |
| CaSO4 (% Saturation) | 10-20 | 10-20 | 25-50 |
| BaSO4 (% Saturation) | 65-80 | 65-80 | 140-180 |
| SrSO4 (% Saturation) | .15-.25 | .15-.25 | .35-.60 |
| CaF2 (% Saturation) | 8k-12k | 8k-12k | 50k-75k |
| SiO2 (% Saturation) | 5 | 2-3.5 | 4-6 |

To balance: 0.01 mg/L Na added to feed.

Array Details:

| | | | Perm | Perm | Feed | Feed | Feed |
|---|---|---|---|---|---|---|---|
| Stage | Ele- | | Flow | TDS | Flow | TDS | Press |
| 1 | ment | Recov. | (gpm) | (mg/L) | (gpm) | (mg/L) | (psig) |
| | 1 | 0.1-.4 | 4-6 | 100-300 | 30-60 | 25k-50k | 600-900 |
| | 2 | 0.1-.4 | 3-6 | 150-350 | 25-50 | 30k-60k | 600-900 |
| | 3 | 0.1-.4 | 2-5 | 200-500 | 35-60 | 44002.44 | 600-900 |
| | 4 | 0.0.7-1.0 | 1-4 | 250-600 | 20-50 | 48926.88 | 600-900 |
| | 5 | 0.05-.09 | 1-4 | 450-700 | 15-45 | 53644.99 | 600-900 |
| | 6 | 0.04-.08 | .5-3 | 600-950 | 15-50 | 57922.11 | 600-900 |
| | 7 | 0.03-.06 | .5-3 | 900-1300 | 15-45 | 61611.17 | 600-900 |
| | 8 | 0.03-.06 | .7-1.5 | 1400-1800 | 15-45 | 64745.41 | 600-900 |

### EXAMPLE 3

This example sets forth the ROSA results obtained under case (3) noted above.

System Summary (non-limiting example of expected values):

| Feed flow to stage 1 | 30-60 | gpm |
|---|---|---|
| Permeate flow | 20-30 | gpm |
| Raw water flow to system | 30-60 | gpm |
| Recovery | 40-60% | |
| Feed pressure | 400-1000 | psig |
| Feed temperature | 15-30 | C. |
| Fouling factor | 0.8-1.2 | |
| Feed TDS | 20k-50k | mg/L |
| Chem. Dose | none | |
| Number of elements | 3-10 | |
| Total active area | 2000-5000 | ft² |
| Average system flux | 5-25 | gfd |

| | |
|---|---|
| Water classification | liquid, water, or seawater |
| | (open intake) SD1 < 2-10 |

(non-limiting example of expected values)

| | Feed | Recirc | Conc | Cone | Perm | Avg | Perm | Boost | Perm | | | | |
|---|---|---|---|---|---|---|---|---|---|---|---|---|---|
| Feed | Flow | Press | Flow | Flow | Press | Flow | Flux | Press | Press | TDS | | | |
| Stage | Element | #PV | #Ele | (gpm) | (psig) | (gpm) | (gpm) | (psig) | (gpm) | (gfd) | (psig) | (psig) | (mg/L) |
| 1 | SW30-380 | 1 | 8 | 45.00 | 795.00 | 0.00 | 23.00 | 765.56 | 22.00 | 10.42 | 0.00 | 800.00 | 451.98 |

| (mg/L, except pH) | Raw Water | Adj Feed | Permeate | Concentrate |
|---|---|---|---|---|
| NH4 | 0.00 | 0.00 | 0.00 | 0.00 |
| K | 0.00 | 0.00 | 0.00 | 0.00 |
| Na | 10k-15k | 10k-15k | 100-2500 | 15k-30k |
| Mg | 800-1500 | 800-1500 | 3-8 | 2000-4000 |
| Ca | 200-500 | 300-6000 | 0.8-2.5 | 600-1000 |
| Sr | .05-.4 | .05-.4 | 0.00 | .05-.40 |
| Ba | .05-.40 | .05-.4 | 0.00 | 0.1-.8 |
| COS | 0.00 | 0.00 | 0.00 | 0.00 |
| HCO3 | 0.00 | 0.00 | 0.00 | 0.00 |
| NO3 | 0.00 | 0.00 | 0.00 | 0.00 |
| Cl | 15k-25k | 15k-25k | 150-400 | 5k-10k |
| F | 8-15 | 8-15 | 0.05-.5 | 15-35 |
| SO4 | 1500-3500 | 1500-3500 | 1.5-6 | 2500-7500 |
| Boron | 0.00 | 0.00 | 0.00 | 0.00 |
| SiO2 | 1-5 | 1-5 | .05-1.1 | 3-7 |
| CO2 | 0.00 | 0.00 | 0.00 | 0.00 |
| TDS | 25k-45k | 25-45K | 250-700 | 45k-80k |
| pH | 7.1-8.5 | 7.1-8.5 | 7.1-8.5 | 7.1-8.5 |

Solubility Warnings: BaSO4 (% Saturation) > 100%; CaF2 (% Saturation) > 100%;

| Scaling Calculations: | Raw Water | Adj Feed | Concentrate |
|---|---|---|---|
| pH | 7.1-8.5 | 7.1-8.5 | 7.1-8.5 |
| Langelier Saturation Index | −3 to −6 | −3 to −6 | −3 to −6 |
| Stiff & Davis Stability Index | −6.5 to −6.9 | −6.5 to −6.9 | −6.2 to 6/6 |
| Ionic Strength (Molal) | 0.5 to 0.8 | 0.5 to 0.8 | 1.2 to 1.5 |
| TDS (mg/L) | 25k to 50k | 25k to 50k | 50k to 75k |
| HCO3 | 0.00 | 0.00 | 0.00 |
| CO2 | 0.00 | 0.00 | 0.00 |
| CO3 | 0.00 | 0.00 | 0.00 |
| CaSO4 (% Saturation) | 10-20 | 10-20 | 25-50 |
| BaSO4 (% Saturation) | 65-80 | 65-80 | 140-180 |
| SrSO4 (% Saturation) | .15-.25 | .15-25 | .35-.60 |
| CaF2 (% Saturation) | 8k-12k | 8k-12k | 50k-75k |
| SiO2 (% Saturation) | 2-3.5 | 2-3.5 | 4-6 |

To balance: 0.01 mg/L Na added to feed.

Array Details:

| | | | Perm | Perm | Feed | Feed | Feed |
|---|---|---|---|---|---|---|---|
| Stage | Ele- | | Flow | TDS | Flow | TDS | Press |
| 1 | ment | Recov. | (gpm) | (mg/L) | (gpm) | (mg/L) | (psig) |
| | 1 | 0.1-.4 | 4-6 | 100-300 | 30-60 | 25k-50k | 600-900 |
| | 2 | 0.1-.4 | 3-6 | 150-350 | 25-50 | 30k-60k | 600-900 |
| | 3 | 0.1-.4 | 2-5 | 200-500 | 35-60 | 44002.44 | 600-900 |
| | 4 | 0.0.7-1.0 | 1-4 | 250-600 | 20-50 | 48926.88 | 600-900 |
| | 5 | 0.05-.09 | 1-4 | 450-700 | 15-45 | 53644.99 | 600-900 |
| | 6 | 0.04-.08 | .5-3 | 600-950 | 15-50 | 57922.11 | 600-900 |
| | 7 | 0.03-.06 | .5-3 | 900-1300 | 15-45 | 61611.17 | 600-900 |
| | 8 | 0.03-.06 | .7-1.5 | 1400-1800 | 15-45 | 64745.41 | 600-900 |

Forward-Osmosis Modeling (non limiting examples of expected results):

Liquid, water, or seawater-WW Effluent System

| | P_{OS}^{SW} | C_{SW} | Q_{SW} | Q_{WW} | C_{WW} | P_{OS}^{WW} |
|---|---|---|---|---|---|---|
| | psi | g/l | l/min | l/min | g/l | psi |
| 1 | 200-400 | 20-35 | 60-80 | 15-25 | 0.3-0.4 | 3-4 |
| 2 | 200-400 | 20-35 | 60-80 | 15-25 | 0.3-0.4 | 3-4 |
| 3 | 200-400 | 20-35 | 60-80 | 15-25 | 0.3-0.4 | 3-4 |
| 4 | 200-400 | 20-35 | 60-80 | 15-25 | 0.3-0.4 | 3-4 |
| 5 | 200-400 | 20-35 | 60-80 | 15-25 | 0.3-0.4 | 3-4 |
| 6 | 200-400 | 20-35 | 60-80 | 15-25 | 0.3-0.4 | 3-4 |
| 7 | 200-400 | 20-35 | 60-80 | 15-25 | 0.3-0.4 | 3-4 |
| 8 | 200-400 | 20-35 | 60-80 | 15-25 | 0.3-0.4 | 3-4 |
| 9 | 200-400 | 20-35 | 60-80 | 15-25 | 0.3-0.4 | 3-4 |
| 10 | 200-400 | 20-35 | 60-80 | 15-25 | 0.3-0.4 | 3-4 |
| 11 | 200-400 | 20-35 | 60-80 | 15-25 | 0.3-0.4 | 3-4 |
| 12 | 200-400 | 20-35 | 60-80 | 15-25 | 0.3-0.4 | 3-4 |
| 13 | 200-400 | 20-35 | 60-80 | 15-25 | 0.3-0.4 | 3-4 |
| 14 | 200-400 | 20-35 | 60-80 | 15-25 | 0.3-0.4 | 3-4 |
| 15 | 200-400 | 20-35 | 60-80 | 15-25 | 0.3-0.4 | 3-4 |
| 16 | 200-400 | 20-35 | 60-80 | 15-25 | 0.3-0.4 | 3-4 |
| 17 | 200-400 | 20-35 | 60-80 | 15-25 | 0.3-0.4 | 3-4 |
| 18 | 200-400 | 20-35 | 60-80 | 15-25 | 0.3-0.4 | 3-4 |
| 19 | 200-400 | 20-35 | 60-80 | 15-25 | 0.3-0.4 | 3-4 |
| 20 | 200-400 | 20-35 | 60-80 | 15-25 | 0.3-0.4 | 3-4 |

Module Recovery 15-30%
Water Recovered 1-100 L/min
Flux 3-50 L/m2/hr

Liquid, water, or seawater: plipsit-CF* 400-450 Effluent: p[psi]=CF*2-5 K membrane=5-100 L/hr/psi

| K | 0.0001 to 0.001 | l/min/m²/psi |
|---|---|---|
| ΔA | 1.75 | m² |
| Total A | 35 | m² |

| CS | m² | |
|---|---|---|
| CS_{SWin}⁼ | 10-50 | g/l TDS |
| C_{WWin}⁼ | 0.1-0.5 | g/l TDS |
| C_{CONCin}⁼ | 30-70 | g/l TDS |
| Q_{SWin}⁼ | 50-75 | l/min |
| Q_{WWin}⁼ | 10-30 | l/min |
| Q_{CONCin}⁼ | 60-90 | l/min |

### EXAMPLE 4

Use of metal or alloy coils for generating

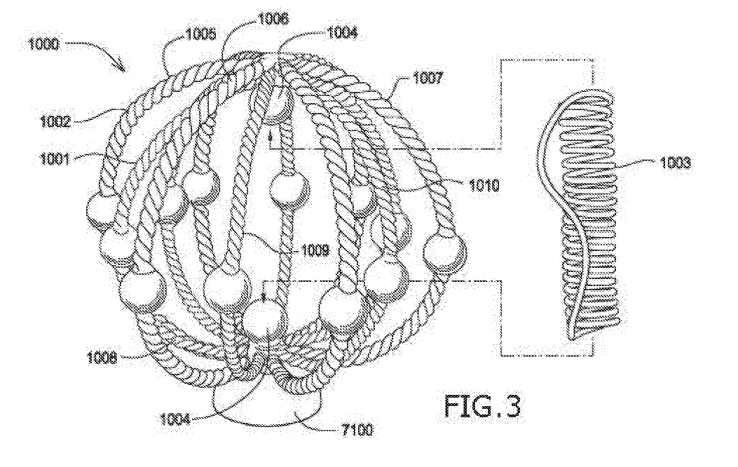

Referring next to FIG. 3, a harmonizer assembly 1000 includes two harmonizers nested one inside the other. The inner harmonizer 1001 is preferably a sacred cubit measurement (or fraction thereof). The outer harmonizer 1002 is preferably a lost cubit. They share a removable central coil 1003 which is supported by beads 1004. Beads 1004 are soldered to the confluence of rings 1005, 1006, 1007 and 1008, 1009, 1010. Base 7100 is large enough to support the chosen size of the harmonizer assembly 1000.

Preferable, non-limiting, sizes for the harmonizer assembly 1000 are ⅛, ¼, ½ and full cubits. In all embodiments, the lengths of employed cubits/neters are significant. Multiples and sub-multiples, pi and phi ratios are employed to maintain the appropriate frequencies for physical compatibilities with living tissue.

In forming the harmonizer assembly 1000, preferably copper components are first molded and soldered into the final structure. Then a silver coating is applied via electroplating. In making a ½ cubit hamionizer assembly 1000, the inner rings are 12 gauge copper, and the outer rings are 10 gauge copper. The beads are 12 mm diameter.

It is to be understood that the above discussion provides a detailed description of various embodiments. The above descriptions will enable those skilled in the art to make many departures from the particular examples described above to provide apparatus constructed in accordance with the present subject matter. The embodiments are illustrative, and not intended to limit the scope of the present inventions. Changes may be made in the construction and operation of the various components, elements and assemblies described herein and changes may be made in the steps or sequence of steps of the methods described herein. The scope of the present inventions are rather to be determined by the scope of the claims as issued and equivalents thereto.

POTENTIAL ASPECTS OR ELEMENTS OF THE CLAIMED INVENTIONS THAT CAN BE OPTIONALLY EXCLUDED OR NEGATIVELY CLAIMED.

The present inventions can also in particular claimed embodiments exclude or negatively claim one or more aspects, e.g., to more particularly recite or exclude embodiments or elements that might occur in cited or other published art, as presented herein. Accordingly, the present inventions can optionally exclude, not include, or not provide, one of more, or any combination of any element, feature, component or step disclosed herein.

A number of implementations have been described. Nevertheless, it can be understood that various modifications may be made. For example, elements of one or more implementations may be combined, deleted, modified, or supplemented to form further implementations. As yet another example, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

What is claimed is:

1. A method for liquid treat rEe t comprising one or more of disinfection, filtration_and/or purification, the method comprising:
(a) treating the liquid with one or more electromagnetic fields (EMFs) to provide EMF treated wherein the one or more EMFs comprise two or more EMF frequencies selected from, but not limited to, 20, 63, 70,. 72, 99, 100, 101, 112, 120, 144, 146, 147, 153, 164, 174, 205, 234. 258, 282, 285, 289, 317, 330, 327, 330, 333, 327, 358, 369, 378, 396, 413, 417, 453, 465, 471, 512, 522, 526, 528, 539, 542, 548, 556, 582, 612, 618, 623, 624, 632, 634, 635, 639, 642, 662, 693, 726, 728, 741, 773, 774, 776, 787, 798, 799, 800, 802, 804, 822, 825, 826, 827, 832, 835, 847, 852, 852.44, 855, 856, 867, 934, 936, 951, 957, 963, 974.15, 991, 1000, 1130, 1054, 1055, 1074, 1185, 1242, 1244, 1260, 1296, 1317, 1320, 1333, 1372, 1428, 1522, 1529, 1530, 1550, 1552, 1584, 1604, 1630, 1703, 1712, 1722, 1730, 1741, 1746, 1823, 1833, 1852, 1867, 1902, 1993, 2664, 3330, 3142, 3152, 3996, 4152, 5412, 7847, 7849, 9990, 9999, or other frequency and pulses, or one or more harmonics thereof;
(b) applying a counter rotating magnetic field (CRMF) or an oscillating electrical field (OEF) to the EMF treated liquid to provide EMF and CRMF/OEF treated liquid;
collecting the EMF and CRMF/OEF treated liquid;
wherein the treating step (a) and/or the applying step (b) removes or inactivates one or more impurities, contaminants, chemicals, pharmaceuticals, toxins, pathogens, pollutants, carcinogens, heavy metals, or radioactive materials.

2. A method of claim 1, wherein the one or more impurities, contaminants, chemicals, pharmaceuticals, toxins, pathogens, pollutants, carcinogens, heavy metals, or radioactive materials islare selected from. the group of a pharmaceutical undesirable impurities or contaminations active or inactive ingredient or compound, a toxic or contaminant compound, chemical, or molecule, a pollutant, an impurity, a bacteria, parasites, a pathogen, a yin's, microbes, E coli, organic material, a fluoride containing compound, chlorine or by-products, carbon monoxide, arsenic, aluminum, disinfectant by-product (DBPs), a prescription drug, an over the counter drug (OTC), a non-prescription drug, antibiotic, a pain reliever, a pain medication, a heart drug, a mind drug, a sex drug, antidepressant, contraceptive, other pharmaceutical or drug, a veterinary drug, animal by-product, animal feces, human waste, a heavy metal, metal ion contamination, a toxic metal, a personal care product chemical, other medication, caffeine, a nicotine chemical, a radioactive compound, a cancer-causing compound composition or by-product, a hormone, disinfectant by-product (DBPs), a fertilizer, pesticide, feed additive, or herbicide component, by-product, or decomposition product, a metal salt, or a water contaminant or other pollutant.

3. A method of claim 1. wherein the method further comprises treating the liquid, the EMF liquid or the EMF and CRMF/OEF treated liquid with one or more of activated carbon filtration, ozonation, granular media treatment, microfiltration, ultrafiltration, ultraviolet exposure, nanofiltration, reverse osmosis, and desalination,

4. A method of claim 1, wherein the treating step (a) and/or the applying step (b) comprises the use of a generator or system of generators of high frequency currents using copper or metal rings, electrodes or frequency generators to generate the two or more EMF frequencies and/or the counter rotating magnetic field (CRMF) or the oscillating electrical field (OEF).

5. A method of claim 4, wherein the copper or metal rings, electrodes or frequency generators are provided as two or more copper or metal rings, electrodes or frequency generators with substantially the same radius, wherein the two copper or metal rings, electrodes or frequency generators intersect with each other such that the center of each disk is adjacent to a perimeter portion of the other copper or metal rings, electrodes or frequency generators.

6. A method of claim 4, wherein the copper or metal rings, electrodes or frequency generators vibrate at said at least two electromagnetic frequencies corresponding to the length, or a fraction or multiple of the length, of at least a portion of the copper or metal rings, electrodes or frequency generators.

7. A method of claim 4, wherein a primary coil of the copper or metal rings, electrodes or frequency generators creates at least one of the counter rotating magnetic field (CRMF) and oscillating electrical field (OEF) alternating in polarity, that vibrate at said two or more EMF frequencies that are resonant with a secondary frequency at which a secondary coil of the copper or metal rings, electrodes or frequency generators vibrate that balances the force of gravity within a magnetic field produced by the copper or metal rings, electrodes or frequency generators.

8. A method of claim 1, wherein the liquid comprises water; and wherein the method provides:
one or more of contaminant removal and impurity removal; and
one or more of disinfection, filtration, and purification.

9. A method of claim 1, wherein the EMIF and CRMF/OEF treated liquid substantially comprises at least two of disinfected, filtered and treated water; and wherein the liquid for treatment is selected from: water for drinking water uses, water for water supply uses, sewage or human waste, water for wastewater uses, water for recycling uses, water for groundwater uses, water for lead compound contaminated water or wastewater uses, water for pharmaceutical manufacturing wastewater uses, water for purified water uses, water for medical treatment wastewater uses, water for industrial manufacturing and processing wastewater uses, water for marine wastewater uses, water for commercial manufacturing and processing wastewater uses, water for agricultural irrigation and processing uses, water for ionization uses, water for drinking water, bottled water, alcoholic beverages, non-alcoholic beverages or other beverage uses, water for pharmaceutical uses, water for medical uses, water for municipal water supply uses, water for manufacturing or processing of consumer packaging uses, water for food processing uses, water for packaged beverages uses, water for growing livestock uses, water for mining wastewater uses, water for electric power generation wastewater uses, cooling systems water uses, water for thermoelectric power generation and system uses, water for recreational uses, water for oil and gas mining and processing wastewater uses, water for ballast uses, water for desalination uses, water for aquaculture uses, water for plant growth or water for other water uses.

10. A method of claim 1, wherein the method further comprises treating the liquid. the EMF treated liquid, and/or the EMF and CRMF/OEF treated liquid, with ultraviolet (UV) light to provide UV, EMF and CRMF/OEF treated water.
